(19) United States
(12) Patent Application Publication
(10) Pub. No.: US 2022/0042639 A1
(43) Pub. Date: Feb. 10, 2022

(54) FLUID CONDUIT ASSEMBLIES AND FLUID TRANSPORT SYSTEMS

(71) Applicant: Micropen Technologies Corporation, Honeoye Falls, NY (US)

(72) Inventor: William J. Grande, Piffsford, NY (US)

(21) Appl. No.: 17/393,632

(22) Filed: Aug. 4, 2021

Related U.S. Application Data
(60) Provisional application No. 63/060,963, filed on Aug. 4, 2020.

(51) Int. Cl. F16L 53/38; F16L 59/065; F16L 59/08; H05B 3/06; H05B 3/18; H05B 1/02

(52) U.S. Cl. CPC F16L 53/38; F16L 59/065; F16L 59/08; H05B 3/06; H05B 3/18; H05B 2203/037; H05B 2203/016; H05B 2203/013; H05B 2203/007; H05B 2203/003; H05B 1/0244

(57) ABSTRACT

A fluid conduit assembly that includes a fluid conduit comprising a tubular member extending between at least a first end and a second end is disclosed. The tubular member has an inner surface configured to convey a fluid and an outer surface. A heater trace is deposited on the outer surface of the fluid conduit and configured, in use, to heat the fluid within the inner surface of the fluid conduit. An insulation shell is located over the heater trace and configured to suppress heat losses from the fluid conduit. An interconnect device is located proximate to each of the first end and the second end on the fluid conduit. A portion of the interconnect device extends through the insulation shell to electrically connect the heater trace to one or more external devices. Fluid transport systems including the fluid conduit assembly are also disclosed.

This application claims the benefit of Provisional Patent Application Ser. No. 63/060,963, filed Aug. 4, 2020, which is hereby incorporated by reference in its entirety.

### FIELD

The present technology relates to fluidic components configured to be assembled into heated fluid transport systems, devices for energizing and controlling such systems, and methods of manufacturing the same.

### BACKGROUND

Modern civilization could not exist without extensive systems to control the transport of fluids. Some fraction of all the fluid-bearing systems in the world must be heated for them to fulfill their function. Several well-known needs that necessitate the heating of fluid-bearing systems are described below.

Many fluids solidify at some range of ambient temperatures to which they are exposed. Some examples include: crude oil, distillates, waxes, and residues in the petroleum industry; molasses, butter, food syrups, oils and fats, and chocolate in the food and beverage industries; strong acid solutions and many chemical feedstocks in the industrial and chemical sectors; molten polymers in the plastics industry; and water and aqueous solutions in virtually all industries. Even when freezing or solidification is not a problem, these materials will often be heated to lower the viscosity, which reduces the size and cost of the pumping installation and decreases operational expenses.

In some applications fluids must be heated to prevent one or more constituents in the fluid stream from condensing. For example, in the chemical industry gaseous hydrochloric acid in the presence of water vapor or air can be safely pumped through steel pipes if it is prevented from condensing on the walls in concentrated acidic form. This necessitates keeping all interior plumbing surfaces above at least 100° C. In the chemical analysis and trace elemental detection equipment used in the instrumentation, health science, military, and security industries, heated transport lines are used to prevent condensation of analytes on conduit walls. In the semiconductor industry many critical reactants are delivered to process tools in gaseous form even though the native compounds are liquids or solids at room temperature. For example, in the case of liquid organometallic precursors, the source vessel is heated while an inert carrier gas is bubbled through the liquid. The vaporized organometallic must be carried to the process chamber through heated gas lines to prevent condensation back into liquid form.

In yet other applications, fluids are heated to prevent a constituent of the fluid stream from depositing as a solid onto the interior walls of the fluid conduits. The semiconductor industry encounters this problem routinely in the vacuum exhaust lines (known as forelines) of many unit processes. To cite just one example, the etching of aluminum conductor patterns on wafers is often accomplished using chlorine chemistry. The reaction product is aluminum chloride which leaves the etch tool as a gas. If the foreline is not properly and uniformly heated the aluminum chloride can deposit as a solid coating on the interior walls. As the foreline gets progressively clogged, the etch process deteriorates. If left unchecked, the foreline can become completely occluded and the pumping system damaged. These depositions are also well known to produce particles that can backstream into the etch tool and cause defects and yield loss. Aluminum chloride deposition can be prevented by holding the interior surfaces of the foreline to around 150° C.

Clearly, the need for heated fluid transport systems permeates a wide range of industries and for many varied reasons.

All heated fluidic systems have several elements in common. There must be a member through which fluid flows, that is, the fluid conduit. There must be a heater and some way of supplying power to it. There is some method of insulating the hot sections from the environment. Often, there is some method of controlling the temperature and this usually involves a temperature sensor. When all these components are integrated together, they form a fluid conduit assembly. Finally, there must be a way of joining individual fluid conduit assemblies with each other to form a complete fluid transport system. A more detailed elucidation of these components is now provided.

The basic elements of a prior art fluid conduit assembly 1 are shown schematically in cross-section in FIG. 1. The central component of the fluid conduit assembly 1 is a fluid conduit 16. For ease of description only, the fluid conduit 16 shown in the figures is a straight cylindrical tube. A heating means 2 and, optionally, a temperature sensing means 3 are disposed in thermal communication with the fluid conduit 16. Note that the locations of the heating means 2 and temperature sensing means 3 are purely representational. An outer shield 5, comprising an outer shell 6 and end faces 7, is affixed to the fluid conduit 12. The void space between the outer surface of the fluid conduit 16 and the inner surface of the outer shield 5 is filled with insulative means 4. The outer shield 5 primarily serves to protect the enclosed elements and may form a hermetic seal in applications where environmental agents (for example, ground water or airborne chemicals) are present that can seep in and cause deteriorate. The outer shield 5 may also serve an insulative function. The heating means 2 is energized using heating wires 8; and sensor leads 9 convey signals from temperature sensing means 3. How leads 8 and 9 are carried outside of the outer shield 5 is not shown in the figures but will be discussed further below. Some interconnection scheme must be provided so that power can be applied to the heating means and signals from the temperature sensing means can be routed to a control means. The left terminal end of fluid conduit 16 is illustrated as being cut flush and true, as would be appropriate for a welded joint. The right terminal end of fluid conduit 16 is illustrated with a flange 11 and is ready to be joined by a flanged method. For illustrative purposes, the flange 11 in the figures has a shape that generally conforms to the ISO-KF standard. The fluid conduit 16 projects beyond the end faces 7 by a distance labelled “L”. This provides space to join fluid conduit assemblies together as shown in FIG. 2, whether via a welded or a flanged connection.

Two joined fluid conduit assemblies 1 are partially shown in FIG. 2. For illustrative purposes only the fluid conduit assemblies 1 are shown connected by a flanged joint. The space labeled “J” represents the region around the joint between the two end faces 7. This region, if left alone, would create a large heat loss because it is uninsulated. This is an issue that must be addressed either during the joining process or afterwards. In addition, an interconnection means needs to be employed to resolve the disposition of leads 8 and 9. Both matters will be further described below in the prior art and in the present technology.

### Heating Means

Various devices for the heating means 2 have been employed in the art. One of the oldest and most widely practiced heating means is the electrical heater trace consisting of an electrical resistance wire, cable, tape, mat, or other geometry that is wrapped around, strung along, or otherwise placed in thermal communication with a fluid conduit and affixed at appropriate intervals with straps or other attachment means. Representative examples of this technique include U.S. Pat. No. 3,331,946 to Bilbro, U.S. Pat. Nos. 3,351,738, and 3,548,158 to McCaskill. After application of the heater traces, the fluid-bearing elements must be surrounded by an insulative means to confine the generated heat. Thus, the creation of a fluid transport system using this method requires three distinct steps: joining of the fluid conduits, installation of the heater traces, and application of insulation.

Heating jacket (also known as heating mantle) technology uses resistive heaters embedded in a structure that is configured to surround the fluid conduit. In the broadest sense this category includes heaters made of metal and capable of high temperature operation such as band heaters and clamshell heaters. However, the most frequently encountered product type for gas line and foreline heaters is silicone heating jackets, so the remaining discussion will focus on this class.

Silicone heating jackets have an inner mat containing resistive wires or foils and an outer insulative casing. In U.S. Pat. No. 5,714,738 to Hauschulz et al. the use of silicone rubber materials for the mat and casing provides enough flexibility to slip the heating jacket over a fluidic component and then fasten the jacket in place using laces or snaps or other fastener schemes. Further improvements to this approach are disclosed in U.S. Pat. No. 6,894,254 to Hauschulz, U.S. Pat. No. 7,626,146 to Steinhauser et al., U.S. Pat. No. 7,919,733 to Ellis et al., U.S. Pat. No. 9,578,689 to Smith et al., and U.S. Pat. No. 10,021,739 to Kiernan et al. While the silicone heating jacket combines the heater trace and the insulative means into one body, construction of a fluid transport system still requires two distinct steps: joining of the fluid conduits and installation of the heating jackets.

Thick film heaters are well known in the art to possess multiple advantages over discrete heaters such as resistive heater wires, cables, tapes, and mats, or heating jackets incorporating the same. Thick film heaters possess a low physical profile and low mass, generate high heat fluxes, and provide high heat transfer rates to the substrate. U.S. Pat. No. 809,917 to Gardner describes a heater on a fluid conduit with a dielectric/resistor/conductor/dielectric structure formed from vulcanizable rubber layers formulated with appropriate fillers. Although the materials are outdated—the dielectric is 20 parts rubber and 80 parts pulverized asbestos—the construction is monolithic and appears to be a forerunner of contemporary thick film technology, despite being over a century old. Other examples of thick film heaters applied to fluid conduits are disclosed by U.S. Pat. No. 5,973,296 to Juliano et al. and U.S. Pat. No. 7,164,104 to Lin.

The “skin effect” is a well-known mechanism whereby AC current is electromagnetically confined near the surface of a conductor. The “depth” of the effect is a function of frequency, electrical conductivity, and magnetic permeability. For highly conductive, non-magnetic materials like copper, current confinement is often not appreciable below the MHz frequency range. In ferromagnetic materials like iron and many steels, a skin effect depth in the millimeter regime can be realized at common power frequencies of 50 to a few hundred Hz. Given that the wall thickness of many steel pipes is also in the millimeter range, the skin effect can be exploited to confine current flow when heating ferromagnetic fluid conduits.

U.S. Pat. No. 3,293,407 to Ando appears to be the first application of the skin effect to heated fluid conduits. Current from a power source is carried to the far end of a steel pipe in a standard (e.g., copper) wire where it is attached to the pipe surface. Electrical current then flows back through the pipe, creating Joule heating along the way. Because of the skin effect the current and associated voltage drop are confined to a very narrow region, outside of which there is little hazard due to electricity. The technique has been improved upon by subsequent inventors, for example, U.S. Pat. No. 3,706,872 to Trabilcy.

### Insulation Means

Fluid conduit assembly 1 includes insulation means 4 within the outer shield 5. The insulation means in a fluid conduit assembly determines two critical performance characteristics: the external surface temperature and the power consumption. Low external surface temperatures prevent burn hazards to people and excessive heating of the workspace. Low power consumption is a desirable operating performance characteristic and leads to lower cost-of-ownership for the customer.

Three notable insulation methods are well known in the prior art: expanding polymer foams that can be sprayed or poured, thermal barriers containing layers of reflective sheets and low-density insulators, and vacuum cavities. The vacuum cavity (e.g., modified Dewar flask or “thermos”) is a particularly simple and attractive approach, especially when the internal surfaces are made highly reflective.

U.S. Pat. No. 1,140,633 to Trucano is probably the earliest vacuum insulated fluid conduit assembly. The geometry is a pipe within a pipe where the interstitial space is evacuated. Trucano also discloses an “insulation coupling” that is positioned over the joint between two fluid conduit assemblies (i.e., the J region of FIG. 2) and evacuated to preserve the insulative qualities of the coupling region. The Trucano patent represents almost a complete solution for vacuum insulating fluid transport systems, even though it is over a century old. The one engineering problem that Trucano left unaddressed was the thermal stress between the fluid conduit and the outer shield that can arise due to a large temperature difference.

Subsequent inventors solved the thermal stress problem by incorporating corrugated members. U.S. Pat. No. 3,453,716 to Cook used a thin-walled corrugated fluid conduit. U.S. Pat. No. 3,534,985 to Kuypers et al. utilized helically corrugated pipes for both the fluid conduit and the outer shield. U.S. Pat. No. 6,216,745 to Augustynowicz et al. employed a bellows at each end of the outer shield.

A general performance concern about insulation is that the outer shield could be breached either during installation or over time, which would degrade the effectiveness of the insulation. For example, a single crack in the outer shield of a long monolithic pipeline would allow groundwater to infiltrate and destroy the insulation over a considerable length.

The idea to “modularize” sections of insulation so that a failure of one section could not spread to adjacent sections appears in U.S. Pat. No. 2,894,538 to Wilson. Wilson teaches the use of “formation disks” which are the equivalent of the end faces 7 in FIG. 1. U.S. Pat. No. 3,685,546 to Sigmund achieves the same effect by periodically and smoothly necking the outer shield down to the fluid conduit, eliminating the end faces altogether. Any advancement in the art of heated fluid-bearing systems would do well to preserve this modular feature.

### Interconnection Means and Topology

There are two technological issues that are critical to the ability of a set of fluidic components to be constructed into a complete, useful, real-world fluid transport system. The first issue is that the power wires for the heater, the signal wires for the temperature sensor (if present), and any other wires involved in system communication or control must transition from the interior of the outer shield to the outside world. The method by which this is accomplished is referred to as the interconnection means. The other issue is that fluid transport systems generally require multiple fluidic components including straight sections, branching sections, active components such as valves, and connection joints, all of which create a complexity due to topology. By this it is meant that the heating means must accommodate changes in size and shape of the fluidic components along with terminuses created when one fluidic component transitions into another.

U.S. Pat. Nos. 3,351,738, 3,354,292, 3,364,337, and 3,398,262, all to Kahn, disclose one of the earliest fluid transport systems incorporating interconnection and control means applied to multiple fluidic components. The elements of branching networks and multiple diameter conduits are also present. Each fluidic section has its own heater trace and connecting wires. The collection of wires makes the application of insulation a laborious task. In Kahn's solution, the heating, interconnect, and insulation means are separate considerations, not integrated into a coherent solution.

In contrast, U.S. Pat. No. 3,377,464 to Rolfes offers the first truly integrated system solution. Rolfes provides “prefabricated insulating sections” that closely follow the fluid conduit assembly configuration of FIGS. 1 and 2 and can be joined by welding or by flanged connectors. The heating means is a heater trace in the form of a resistance wire wrapped around the fluid conduit. The insulation is a foamed material such as polyurethane protected by a waterproof outer shell constructed from, for example, extruded PVC. Rolfes integrates the electrical circuitry with the insulative means through the use of a duct (preferably polymeric) arranged within the body of the insulation to contain the power wires. Terminal blocks in the uninsulated “L” portions of the “prefabricated insulating sections” are used to complete the circuits between adjacent sections, i.e., across the “J” region. Once the various sections are joined, jumper leads are applied to the terminal blocks. The “J” region is protected with a “split coupling sleeve” which serves as an extension of the outer shield. Filling ports are provided in the “split coupling sleeve” through which insulation is poured or injected. Electrical power is fed into the fluid transport system through a series of “nipples” that penetrate the outer shield at appropriately spaced intervals. Circuit wires pass through the nipples and are connected, depending on circumstances, to the terminal blocks or directly to the resistive heater wires.

In U.S. Pat. No. 3,971,416 to Johnson fluid transport systems are also constructed from prefabricated insulated assemblies. Johnson uses a “heater housing extension means” to create a channel that connects the end faces of two joined fluid conduit assemblies. Wires are passed through this channel, allowing adjacent sections to communicate. More specifically, Johnson uses the channels to electrically connect the heater traces in successive sections together in series.

In U.S. Pat. No. 5,632,919 to MacCracken et al. wires for the heater, temperature sensor, and fuse element traverse the insulation space and exit the outer shield through a “connector” much like the nipple employed by '464 Rolfes.

The prior art that employs a heater trace fixed to the fluid conduit or resistive wires embedded in a heater jacket suffer from poor thermal conduction between the heating means and the fluid conduit. Poor thermal conduction gives rise to excessive power consumption and increased insulation requirements to maintain safe temperatures of the outer surfaces. All these factors contribute to cost.

Many approaches in the prior art require a sequential assembly process: the piping components are first joined into a complete system, then the heater means is affixed, and then the insulation means is applied. The heater jacket approach represents an improvement in that the jacket contains both the heater and the insulation. But heater jackets must still be laboriously assembled and fastened onto the various fluidic components. All these approaches give rise to high labor costs for the assembly work and increased probability of human error resulting in degraded system performance and/or potential additional costs for remediation.

Nowhere in the prior art is there described a method of joining fluidic components that simply, reliably, and inexpensively provides for completing all the wiring interconnections, insulating the region of the joint, and interfacing the fluid transport system with control and communication means.

No single piece of prior art combines the efficient thermal conduction of thick film heaters with the superior insulating characteristics of a vacuum space.

Nothing in the prior art combines the modularity and versatility of flanged fluid conduits with a simplified wiring and interconnection scheme.

The present technology is directed to overcoming these and other deficiencies in the art.

### SUMMARY

The present technology relates to fluid transport systems that are composed of one or more fluidic conduit assemblies. More specifically, the present technology relates to improved methods of constructing fluid transport systems where all the internal wetted surfaces are maintained within a prescribed temperature range in order to accomplish a desired effect, for example, preventing low-volatility components in the fluid stream from condensing on the walls of the fluid transport system. Additionally, the present technology relates to improved methods of fabricating fluidic conduit assemblies to minimize labor and cost associated with their construction into fluid transport systems.

One aspect of the present technology relates to a fluid conduit assembly that includes a fluid conduit comprising a tubular member extending between at least a first end and a second end. The tubular member has an inner surface configured to convey a fluid and an outer surface. A heater trace is deposited on the outer surface of the fluid conduit and configured, in use, to heat the fluid within the inner surface of the fluid conduit. An insulation shell is located over the heater trace and configured to suppress heat losses from the fluid conduit. An interconnect device is located proximate to each of the first end and the second end on the fluid conduit. A portion of the interconnect device extends through the insulation shell to electrically connect the heater trace to one or more external devices.

In one aspect of the present technology the heater is a thick film heater trace.

In one aspect of the present technology the fluid conduit is one of a cylindrical fluid component, a u-shaped fluid component, a tee-shaped fluid component, or an elbow shaped fluid component.

In one aspect of the present technology the fluid conduit assembly further includes a flange located at the first end and the second end configured to couple each of the first end and the second end of the fluid conduit to another fluid conduit.

In another aspect of the present technology the flange comprises a ceramic insert configured to reduce heat flow in at least one area of the flange.

In one aspect of the present technology the insulation shell includes a first radiation shield located along the outer surface of the heater conduit and substantially over the heater trace. A second radiation shield is located along the length of the first radiation shield. A vacuum space extends between the fluid conduit and the second radiation shield.

In another aspect of the present technology the second radiation shield includes an expansion element configured to expand based on stress on the second radiation shield from thermal expansion between the fluid conduit and the second radiation shield, during use.

In yet another aspect of the present technology the expansion element comprises one or more corrugations in the second radiation shield configured to elongate in response to the stress on the second radiation shield.

In a further aspect of the present technology the second radiation shield comprises a vacuum sealing element for generating the vacuum space between the fluid conduit and the second radiation shield.

In another aspect of the present technology the vacuum sealing element includes an expanded portion of the second radiation shield having a shield dimple located therein. A vacuum port is located within the shield dimple.

In another aspect of the present technology the first radiation shield is located entirely within the vacuum space.

In another aspect of the present technology the first radiation shield has highly reflective surfaces.

In another aspect of the present technology the first radiation shield is not rigidly fixed.

In another aspect of the present technology the first radiation shield is configured to allow regions located adjacent to an inner surface and an outer surface of the inner radiation shield to communicate fluidly with one another.

In another aspect of the present technology the interconnect device includes one or more contact pins configured to be in electrical communication with the heater trace and extending through the first radiation shield and the second radiation shield. The contact pins are configured to be electrically coupled to the one or more external devices.

In a further aspect of the present technology the one or more contact pins extend through holes in the first radiation shield and the second radiation shield.

In yet another aspect of present technology the interconnect device further comprises an insulator sealed to the one or more contact pins and the second radiation shield.

In another aspect of the present technology the insulator is hermetically sealed to the contact pins and the second radiation shield.

In another aspect of the present technology the insulator is a ceramic donut-shaped insulator.

In another aspect of the present technology the insulator is a plug insulator or a socket insulator.

In another aspect of the present technology the interconnect device further includes a first power bus and a second power bus deposited on the fluid conduit and configured to be electrically coupled to the one or more contact pins. The first power bus and the second power bus extend longitudinally along the tubular member of the fluid conduit.

In another aspect of the present technology the first power bus and the second power bus are located approximately 180 degrees apart from one another on the heater conduit.

In another aspect of the present technology the heater trace has a helical configuration.

In another aspect of the present technology the heater trace is a continuous helical heater trace such that the heater trace contacts the first power bus and the second power bus at a plurality of locations to form a plurality of resistive heater elements that form an array of electrically parallel circuits.

In another aspect of the present technology the helical configuration has at least one non-uniform area with reduced pitch to increase heat flux at an area of the fluid conduit.

In another aspect of the present technology the heater trace has a serpentine configuration.

In another aspect of the present technology the heater trace comprises first and second serpentine traces extending between the first power bus the second power bus. The first serpentine trace and the second serpentine trace are formed on separate hemi-cylinders of the fluid conduit to form electrically parallel circuits.

In another aspect of the present technology the heater trace comprises first, second, third, and fourth serpentine traces extending between the first power bus the second power bus. The first and second serpentine traces and the third and fourth serpentine traces are formed on separate hemi-cylinders of the fluid conduit, respectively, to form electrically parallel circuits.

In another aspect of the present technology the heater trace has a substantially longitudinal configuration along the tubular member.

In another aspect of the present technology the substantially longitudinal trace forms a separate trace in each hemi-cylinder of the fluid conduit.

In another aspect of the present technology the first power bus and the second power bus are spaced in close proximity to one another on the fluid conduit.

In another aspect of the present technology the heater trace is not located in a section of the tubular member between the first power bus and the second power bus.

In another aspect of the present technology the first power bus and the second power bus are formed between a first ring electrode and a second ring electrode, respectively that encircle the fluid conduit.

In one aspect of the present technology the heater trace includes a dielectric layer deposited on the tubular member of the fluid conduit. A patterned conductive layer is deposited over the dielectric layer. The conductive layer forms contact pads that communicate electrically with the one or more external devices and the first and second power buses. A patterned resistive layer is deposited partially over the dielectric layer and partially over the conductive layer to provide heat generation during use. The patterned resistive layer contacts the conductive layer in at least two locations.

In another aspect of the present technology the heater trace further comprises an overcoat layer completely covering the resistive layer and partially covering the patterned conductive layer to expose the contact pads.

In another aspect of the present technology the dielectric layer comprises multiple dielectric layers.

In one aspect of the present technology the fluid conduit assembly further includes one or more thermal switches located along the heater trace.

In one aspect of the present technology the fluid conduit assembly further includes a temperature sensor located along the heater trace.

Another aspect of the present technology relates to a fluid transport system including at least two of the fluid conduit assemblies.

In one aspect of the present technology the at least two fluid conduit assemblies are welded together.

In one aspect of the present technology the fluid transport system further includes a clamping device. The at least two fluid conduit assemblies are coupled together by the clamping device, during use. The clamping device includes a clamping member configured to contact the at least two fluid conduit assemblies to provide a sealing force between the at least two fluid conduit assemblies. An outer member is configured to extend between the at least two fluid conduit assemblies and to provide a space between the clamping member and the outer member. One or more wires are located in the space between the clamping member and the outer member to connect the interconnect devices of the at least two fluid conduit assemblies.

In another aspect of the present technology the clamping device further comprises a heater located in the space between the clamping member and the outer member.

In one aspect of the present technology the clamping device further comprises a control module configured to electrically communicate with the at least two fluid conduit assemblies.

### BRIEF DESCRIPTION OF THE DRAWINGS

The accompanying drawings, which are incorporated herein and form part of the specification, illustrate some, but not the only or exclusive, example embodiments and/or features. It is intended that the embodiments and figures disclosed herein are to be considered illustrative rather than limiting. In the drawings:

FIG. 1 is a schematic cross-sectional view of a prior art fluid conduit assembly.

FIG. 2 is another schematic cross-sectional view of a prior art interconnection between two fluid conduit assemblies.

FIG. 3 is a perspective view of one embodiment of a fluid conduit of the present technology.

FIG. 4a is a cross-sectional view of one embodiment of a thick film layer stack of the heater trace illustrated in FIG. 3

FIGS. 4b-4d are cross-sectional views of other embodiments of thick film layer stacks that can be utilized with the heater conduit of the present technology.

FIG. 5 is a perspective view of one embodiment of a fluid conduit assembly of the present technology with the partial removal of the exterior surface.

FIG. 6 is a cross-sectional view of the fluid conduit assembly shown in FIG. 5.

FIG. 7 is a cross-sectional view of the interconnection zone of the fluid conduit assembly shown in FIG. 5.

FIG. 8 is a cross-sectional view of an alternative configuration for the interconnection zone for use with the fluid conduit assembly shown in FIG. 5.

FIG. 9 is a cross-sectional view of the vacuum sealing zone of the fluid conduit assembly shown in FIG. 5.

FIG. 10 is another cross-sectional view of the vacuum sealing zone of the fluid conduit assembly shown in FIG. 5.

FIG. 11 is a cross-sectional view of another embodiment of a fluid conduit assembly of the present technology.

FIG. 12 is a cross-sectional view of one embodiment of a composite flange for use with the fluid conduit assemblies of the present technology.

FIG. 13 a cross-sectional view of another embodiment of a composite flange for use with the fluid conduit assemblies of the present technology.

FIG. 14 a cross-sectional view of yet another embodiment of a composite flange for use with the fluid conduit assemblies of the present technology.

FIG. 15 is a cross-sectional view of one embodiment of a multi-function clamp for use with the fluid conduit assemblies that includes an inset with an enhanced view of one embodiment of a contacting method of the present technology.

FIG. 16 is another cross-sectional view of an embodiment of a multi-function clamp for use with the fluid conduit assemblies of the present technology.

FIGS. 17a and 17b are cross-sectional views of additional embodiments of fluid conduit assemblies of the present technology.

FIGS. 18a and 18b are cross-sectional views of embodiments of collar seals for use with the fluid conduit assemblies of the present technology.

FIG. 19 is a cross-sectional view of one embodiment of a multi-function clamp for use with the fluid conduit assemblies that includes an inset with an enhanced view of another embodiment of a contacting method of the present technology.

FIG. 20 is a cross-sectional view of another embodiment of a multi-function clamp for use with the fluid conduit assemblies of the present technology.

FIG. 21 is a cross-sectional view of another embodiment of a fluid conduit assembly of the present technology.

FIG. 22 is a cross-sectional view of yet another embodiment of a fluid conduit assembly of the present technology.

FIG. 23 is a cross-sectional view of a further embodiment of a fluid conduit assembly of the present technology.

FIGS. 24-34 are examples of thick film construction for embodiments of the heater conduit of the present technology.

FIG. 35 is a schematic circuit diagram of two fluid conduit assemblies with a multi-function clamp according to one embodiment of the present technology.

FIG. 36 is a cross-sectional view of one embodiment of a fluid conduit assembly of the present technology and block diagram of a testing set-up.

FIG. 37 is cross-sectional view of one embodiment of a fluid conduit assembly of the present technology with a U-shaped configuration.

FIG. 38 is cross-sectional view of one embodiment of a fluid conduit assembly of the present technology with an elbow configuration.

FIG. 39 is cross-sectional view of one embodiment of a fluid conduit assembly of the present technology with a tee-shaped configuration.

FIG. 40 is a cross-sectional view of a fluid conduit assembly according to one embodiment of the present technology that provides a heated valve.

FIG. 41 is a cross-sectional view of one embodiment of a fluid conduit assembly of the present technology that provides a blank flange.

FIG. 42a is a cross-sectional view of one embodiment of a fluid conduit assembly of the present technology that provides a power/data flange.

FIG. 42b is a cross-sectional view of one embodiment of a fluid conduit assembly of the present technology that provides an inductive power flange.

FIG. 43 is a fluid transport system including several fluid conduit assemblies according to one embodiment of the present technology.

FIG. 44 is a fluid transport system including several fluid conduit assemblies according to one embodiment of the present technology with a power/data flange.

FIG. 45 is one embodiment of a fluid transport system including several fluid conduit assemblies of the present technology having power in at least two separate distribution locations

FIG. 46 is one embodiment of an interrupter fluid conduit assembly of the present technology.

FIG. 47 is perspective view of another example of an embodiment of a fluid transport system of the present technology.

FIG. 48 is a flattened view of an embodiment of a first angular adaptor employed in the fluid transport system of FIG. 47.

FIG. 49 is another embodiment of a heater conduit of the present technology.

FIGS. 50a-50f are perspective views of various embodiments of contacting surfaces of the present technology.

FIG. 51 is a cross-sectional view of one embodiment of a heating manifold employing the present technology.

FIGS. 52a-52b are isometric views of one embodiment of a control console of the present technology.

FIG. 53 is an isometric view of one embodiment of the present technology wherein heat is produced by a heater wire.

FIG. 54 is an isometric view of one embodiment of the present technology wherein heat is produced by a skin effect conductor.

FIG. 55 is a cross-sectional view of an oven according to one embodiment of the present technology.

FIG. 56 is a cross-sectional view of a conveyor oven according to one embodiment of the present technology.

FIG. 57 is a cross-sectional view of a vacuum system according to one embodiment of the present technology.

FIG. 58 is a cross-sectional view of a blind sensor assembly according to one embodiment of the present technology.

FIG. 59 is a cross-sectional view of an in-line sensor assembly according to one embodiment of the present technology.

FIG. 60 is a partial cross-sectional view of a fluid conduit assembly with a non-vacuum insulation means according to one embodiment of the present technology.

FIG. 61 is a partial cross-sectional view of a fluid conduit assembly with a non-vacuum insulation means and a stress relief means according to one embodiment of the present technology.

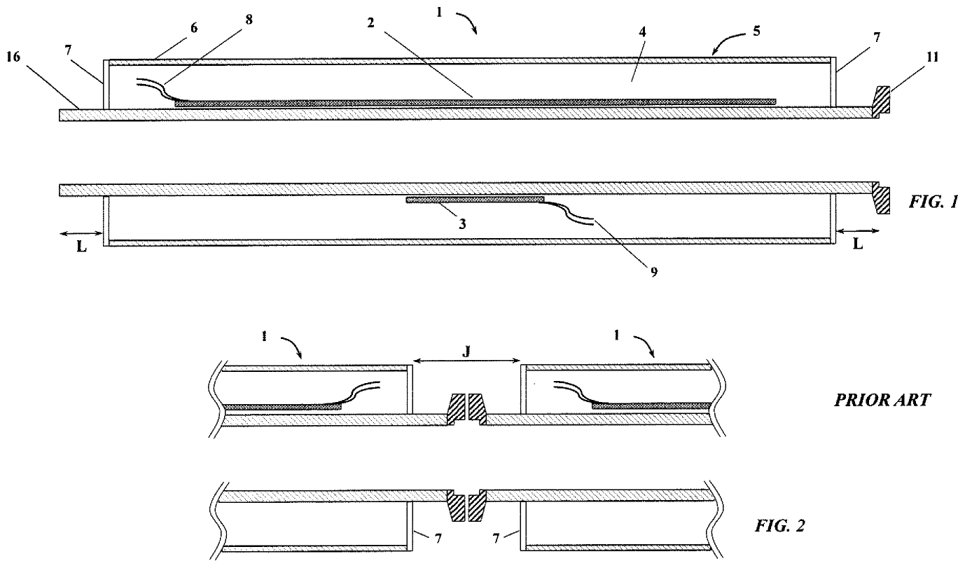

### DETAILED DESCRIPTION

As used herein the following terms are defined:

A “heater trace” is an industry term denoting the means used to heat a fluid conduit (defined below). In the early industrial age, the heater trace was a pipe attached to the fluid conduit through which a hot medium such as water, oil, or steam was passed. At the beginning of the 20th Century, electrical heating in the form of deposited resistive layers or resistive heater wires and cables began to appear. Many variants of the term have evolved over time and the following equivalents can be found in various sources: heat trace, heat tracer, trace, tracer, heat runner, and runner. The terms heater trace and heating means are herein used interchangeably. The present technology is directed only to heating means that are powered electrically.

A “fluid” can be a liquid, gas, plasma, flowable solid (such as particulate matter), region of low pressure (such as a vacuum environment) where there may be little or virtually no movement of matter, or state of matter combining two or more of these phases such as, for example, but without limitation, a paste, slurry, ink, colloidal suspension, or foam.

A “fluid conduit” is a basic unit of plumbing. In more colloquial terms it may be called a pipe, a pipeline, a tube, tubing, a duct, a plumbing fitting, or an active fluidic device. A fluid conduit has an inner and outer surface, at least one near end and at least one far end, and at least one passageway connecting the near and far ends. It may have any arbitrarily shaped cross-section including, but not limited to, circular, square, rectangular, or polygonal, and the cross-section may change with position. The fluid conduit “conducts” the fluid from the at least one near end to the at least one far end under an impetus such as a pressure gradient (as due to, for example, a pump or a blower), a concentration gradient, gravity, diffusion, convection, or other means. Examples of fluid conduits include but are not limited to: straight, bent, or branching sections of pipe or tubing; plumbing fittings such as elbows, tees, wyes, crosses, reducers, adaptors, unions, and couplings; and active fluidic devices such as pumps, valves, pressure regulators, filters, and sensors. A fluid conduit may contain one or more smaller fluid conduits that each individually convey a fluid. This is a commercially important configuration that may be embodied in but not limited to, for example, a gas delivery system wherein a set of small diameter process gas lines are heated by running them through a larger heated fluid conduit acting as a plenum.

A “heater conduit” is a combination of a fluid conduit and a heating means. In the present application one embodiment is the combination of a fluid conduit with a thick film heater.

A “fluid conduit assembly” is a building block from which a larger system (a “fluid transport system,” defined below) can be created. A fluid conduit assembly minimally contains a fluid conduit, a heating means, and an insulating means (or equivalently a heater conduit and an insulating means). A fluid conduit assembly can be formed by bringing these three elements together sequentially; for example, a brass valve may be soldered into a network of copper tubing, then a heater trace in the form of a resistive heater cable may be wrapped around the valve and secured, then an insulative layer in the form of foamed urethane sheet applied around the valve and secured in place. Alternatively, fluid conduit assemblies can be pre-formed as integrated sections and the various sections assembled at the point of use into a complete system. Fluid conduit assemblies may optionally contain other elements to perform functions including, but not limited to, sensing and controlling system variables (e.g., temperature, pressure, fluid flowrate) or ensuring safe operation, as appropriate for the intended application.

A “fluid transport system” is a complete heated fluid-bearing installation that satisfies a specific customer need. The simplest fluid transport system is a single fluid conduit assembly that connects two points. Real world fluid transport systems, however, typically require many types of individual fluid conduit assemblies. The fluid transport system also includes all the devices required to power, regulate, sense, control, monitor, and assure the safety of the entire installation. Such devices include but are not limited to power sources, sensors, thermal fuses, temperature controllers, data collectors, and cabled or wireless communications equipment.

The process of joining fluid conduit assemblies into a fluid transport system is a critical aspect of system design and construction. Joining methods are well known in the art and are herein defined as either “welded” or “flanged.”

A “welded” joint is any joint that is formed between two fluid conduit assemblies by metal welding, brazing, soldering, swaging, plastic welding, adhesive sealing, or similar techniques that produce a permanent connection. The advantage of a welded joint is that, if properly performed and verified, leak integrity is assured, and the system can have a long working life. The disadvantage is that it is difficult, costly, and time consuming to repair or modify a welded installation should that become necessary.

A “flanged” joint is any joint between two fluid conduit assemblies that utilizes a mating means, herein referred to generically as a “flange,” which allows the components to be connected, separated, and re-connected at least once, and in some cases a virtually unlimited number of times. Flanged methods of joining generally involve a sealing surface provided on each fluidic conduit assembly, a seal positioned between the sealing surfaces, and a mechanical means such as clamps, threaded fittings, mating threads, or nuts and bolts to force the sealing surfaces together, thus creating an intimate union between the seal and each sealing surface. The seal may be reusable, or it may need to be replaced during every connection event. The advantage of flanged components is that they allow complex systems to be quickly assembled, modified, or repaired using a stock set of parts. Flanged joining methods may use unique, custom, application-specific designs or may conform to a known standard. By way of example, but not of limitation, many flange systems are described by international or industry standards such as: the ISO-KF standard used in industrial and moderate vacuum applications, the ISO-K standard used in industrial and high vacuum applications, the ISO-CF standard used in industrial and ultra-high vacuum applications, the DIN 11853 standard found in the food preparation and chemical industries, the DIN 11864 standard used in the aseptic, chemical, and pharmaceutical industries, and the VCR® standard developed by the Swagelok Company which is commonly used in the semiconductor and allied industries to construct high quality gas lines.

### Visualization of Thick Film Layers

Many of the embodiments of the present technology utilize printed thick film layers. Because the typical dimensions of printed thick films (particularly the thickness as measured along the normal to the printed surface) may be several orders of magnitude smaller than the dimensions of other elements of the disclosure, it may be impossible to present all details in a drawing with clarity. Representations of thick film layer structures will often be shown in simplified form, emphasizing only those portions such as contact pads, conductive traces, and resistive heat-generating layers that are relevant to a given description. In general, it will be understood by one skilled in the art that other layers such as dielectric isolation and protective overcoats are implied.

One aspect of the present technology relates to a fluid conduit assembly that includes a fluid conduit comprising a tubular member extending between at least a first end and a second end. The tubular member has an inner surface configured to convey a fluid and an outer surface. A heater trace is deposited on the outer surface of the fluid conduit and configured, in use, to heat the fluid within the inner surface of the fluid conduit. An insulation shell is located over the heater trace and configured to suppress heat losses from the fluid conduit. An interconnect device is located proximate to each of the first end and the second end on the fluid conduit. A portion of the interconnect device extends through the insulation shell to electrically connect the heater trace to one or more external devices.

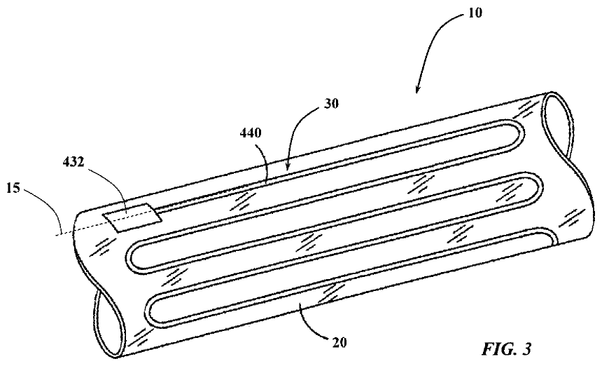

FIG. 3 is a perspective view of a heater conduit 10 according to the present technology. The heater conduit 10 comprises a fluid conduit 20 and a thick film layer stack 30 formed on a surface of the fluid conduit 20 that provides a heater trace configured to generate heat when powered electrically, as described in further detail below. Two components of the thick film layer stack 30 are shown: a resistor layer 440 that generates heat and a contact pad 432 that communicates electrically with resistor layer 440 and cooperates with other elements (not shown) to provide external electrical communication to one or more external devices as described in further detail below. For purposes of visualization, some components of thick film layer stack 30 are not shown in FIG. 3, but will be described in detail below. For ease of illustration the fluid conduit 20 is depicted as a section of straight tubing, although the fluid conduit 20 may have other configurations as known in the art and as described herein.

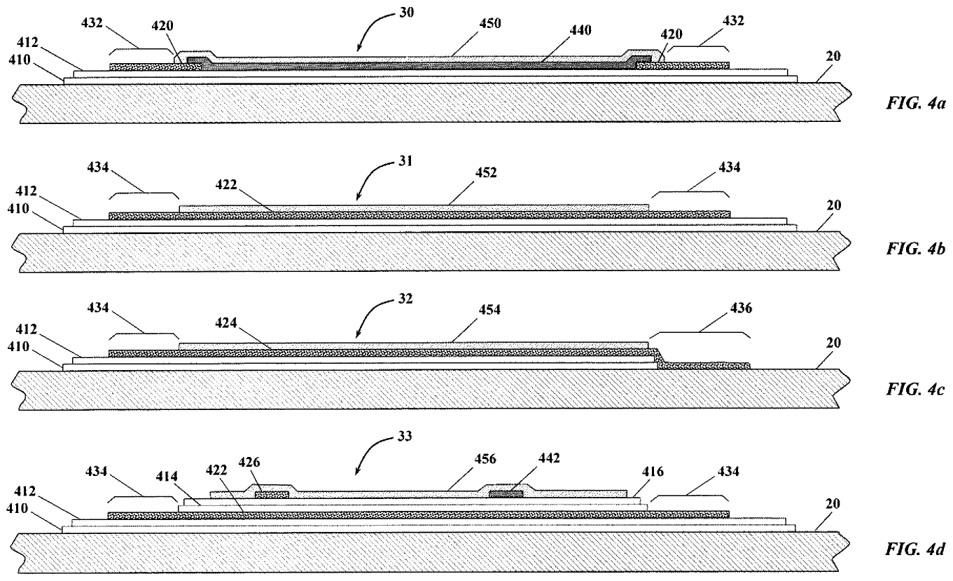

Those skilled in the art of designing thick film layer stacks such as thick film layer stack 30 will appreciate the wide latitude that the technology affords with respect to geometry, device dimensions, number of layers, and functionality. Several exemplary thick film layer stack configurations of relevance that may be employed for thick film layer stack 30 are shown in FIGS. 4a through 4d without intending to limit the configurations of thick film layer stacks that fall within the scope of the present technology and that may be employed for thick film layer stack 30.

The thick film layer stack 30 that forms the heater trace depicted in FIG. 3 is shown in cross-section in FIG. 4a. Note that all the cross-sectional representations of FIGS. 4a through 4d are taken along a long narrow trace indicated by line 15 in FIG. 3, although other configurations may be employed. In FIGS. 4a through 4d, a first dielectric layer 410 is disposed on fluid conduit 20. First dielectric layer 410 may be formed of any known dielectric materials used in the art. In some material systems, a single layer of dielectric, such as first dielectric layer 410, will be sufficient to isolate the fluid conduit 20 from subsequent layers. When this is the case, a single dielectric layer may be preferred for simplicity and cost. However, many commercial material systems will require at least a second dielectric layer to provide dielectric isolation over any pinholes, microcracks, or other defects that might have developed in the first layer. This scenario is sufficiently common that for purposes of explanation it is adopted here. Thus, as shown in FIGS. 4a through 4d, a second dielectric layer 412 is disposed on the first dielectric layer 410. The second dielectric layer 412 is often prepared from the same material and using the same processing conditions as dielectric layer 410, although combinations of dielectric materials may be employed. Referring now more specifically to FIG. 4a, next, a conductor layer 420 is disposed on the second dielectric layer 412 in two separate regions, although other configurations may be employed as described below. Any suitable conductive materials may be employed for conductor layer 420. At the end of the thick film layer stack formation process for forming thick film layer stack 30, those portions of conductor layer 420 that remain exposed will form a contact pad 432. Resistor layer 440, which forms a heater trace, is disposed such that each terminal end of the resistor layer 440 contacts a portion of each of the two regions of conductor layer 420 with the balance of resistor layer 440 disposed upon the second dielectric layer 412. Finally, an overcoat layer 450 is disposed such that it completely covers the resistor layer 440 and partially covers each region of conductor layer 420. In many materials systems the overcoat layer 450 can be formed from the same dielectric material as the first dielectric layer 410 and the second dielectric layer 412. However, FIG. 4a depicts the more general case where overcoat layer 450 is a distinct material. Note that it is the boundaries of overcoat layer 450 that define part of the extent of contact pads 432, as shown in FIG. 4a.

Referring now to FIG. 4b, another exemplary thick film layer stack 31 that forms a conductive trace that may be employed on fluid conduit 20 is shown. The first dielectric layer 410 and the second dielectric layer 412 provide the same structure and function as in FIG. 4a. In this example, a conductor layer 422 is disposed on dielectric layer 412 as a continuous trace. Then an overcoat layer 452 is disposed on conductor layer 422, covering all portions of conductor layer 422 except those intended to function as contact pads 434, which are formed by the exposed portions of conductor layer 422.

Referring now to FIG. 4c, another exemplary thick film layer stack 32 that forms a conductive path to the fluid conduit 20 (in cases where fluid conduit 20 is composed of an electrically conductive material) is shown. The first dielectric layer 410 and the second dielectric layer 412 provide the same structure and function as in FIG. 4a. In this example, a conductor layer 424 is disposed as a continuous trace, but unlike conductor layer 422 in FIG. 4b, at least a portion of conductor layer 424 extends beyond the boundaries of the first dielectric layer 410 and the second dielectric layer 412 and continues onto fluid conduit 20. An overcoat layer 454 is then disposed on conductor layer 424, covering all portions of conductor layer 424 except those intended to function as contact pad 434 and contact site 436. In this example, conductor layer 424 is chosen from those materials that will form an ohmic contact to fluid conduit 20. The purpose of thick film layer stack 32 is to form a conductive path to the fluid conduit 20 that can be accessed at contact pad 434.

As will be discussed in further detail below, it is advantageous to design thick film layer stacks as a single level of metallization, that is, the conductive and resistive layers are each deposited only once. This results in less processing time and reduced costs. However, when the required circuitry becomes sufficiently complicated or dense, it may be necessary to use a multi-level metallization scheme where distinct conductive and resistive layers pass over each other with interposed dielectric layers providing electrical isolation. An exemplary thick film layer stack 33 for multilevel metallization is shown in FIG. 4d. The dielectric layers 410 and 412 as well as the conductor layer 422 provide the same structure and function as in FIG. 4b. In this example, a third dielectric layer 414 is disposed upon conductor layer 422. Third dielectric layer 414 may be formed of the same material as first dielectric layer 410 and second dielectric layer 410. The boundaries of third dielectric layer 414 define the exposed portions of conductor layer 422 and form contact pads 434. A fourth dielectric layer 416, which may be formed of the same material as third dielectric layer 414, is disposed upon the third dielectric layer 414. Fourth dielectric layer 416 is employed for the same reasons that second dielectric layer 412 was used in cooperation with first dielectric layer 410, as described. The surface of fourth dielectric layer 416 is electrically isolated from conductor layer 422 and may serve as the location for additional conductive and resistive layers, for example. By way of example but not limitation, a transverse conductive layer 426 and a transverse resistive layer 442 are shown disposed on fourth dielectric layer 416. As depicted in FIG. 4d, transverse conductive layer 426 and transverse resistive layer 442 may, for example, extend into and out of the page, and be oriented parallel to one another and perpendicular to conductive layer 422. An overcoat layer 456 is provided to completely encapsulate transverse resistive layer 442 and protect the portions of transverse conductive layer 426 not intended to serve as contact pads (not shown in FIG. 4d). As described below, the examples illustrated in FIGS. 4a through 4d may be used alone or in combination with one another.

### Heater Trace

In the present technology, there are several ink systems (or types of materials) suitable for forming the heater trace provided by, for example, thick film layer stack 30, that is deposited on the outer surface of the fluid conduit, such as fluid conduit 20, to maintain the fluid conduit at a desired temperature. These include, without limitation, thick film cermet pastes, resistive polymeric pastes, and nanoparticle ink systems.

According to one embodiment, the heater trace is formed from a thick film cermet paste. Thick film cermet pastes typically include, in their initial compositional form, a filler, a binder (often two types of binders), and a solvent. Thick film cermet pastes are particularly suited to being applied to (i.e., bound to) substrates of, e.g., alumina, ceramic, glass, quartz, semiconductors, and metals (e.g., stainless steel). Particularly suitable substrates are those capable of surviving (e.g., maintaining form and composition) curing conditions of about 850° C., or higher.

Suitable fillers for thick film cermet pastes include, without limitation, metal and metalloid materials, as classified on the periodic table. In particular, suitable examples of fillers include oxide powders, particles and/or powders of ruthenium, glass, magnesium, calcium, zinc, titanium, zirconium, niobium, tantalum, lithium, sodium, potassium, manganese, iron, tungsten, silicon, gold, platinum, iridium, copper, palladium, chromel, alumel, rhenium, nickel-chromium-silicon, constantan, cadmium, aluminum, rhodium, molybdenum, beryllium, tin, chromium, nickel, nickel-chromium, nickel-aluminum, nickel-silicon, lead, silver, ruthenium, and mixtures thereof.

Typically, two types of binders are suitable for thick film cermet pastes. The first type includes organic and inorganic binders used as carrying agents. These binders help the material flow and wet to the surface of the substrate. These binders flow when mixed with the solvent. These first type of binders are burned off during the high temperature firing process used to cure the materials onto the substrate and are not present in the final heater trace. A second type of binder includes glass or oxide powders. During the highest peak of the firing process, the glass flows, and acts like the “mortar” between the filler particles. The glass also fuses the printed material to the surface of the substrate and its ratio to the filler defines the system's resistivity. The higher the glass to filler ratio, the higher the resistivity (ohms/square). These binders typically are present in the final heater trace.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of thick film cermet pastes is typically higher than the viscosity of the other ink systems described herein.

According to another embodiment, the heater trace is formed from a resistive polymeric paste. Resistive polymeric pastes typically include, in their initial compositional form, a filler, a binder, and a solvent. Resistive polymeric pastes are particularly suited to being applied to (i.e., bound to) substrates of, e.g., plastics, silicones, flexible polymers, alumina, ceramic, glass, quartz, semiconductors, and metals (e.g., stainless steel). Suitable substrates can typically handle processing temperatures above about 150° C.

Suitable fillers for resistive polymeric pastes include, without limitation, metal and metalloid materials, as classified on the periodic table. In particular, suitable examples of fillers include oxide powders, particles and/or powders of ruthenium, glass, magnesium, calcium, zinc, titanium, zirconium, niobium, tantalum, lithium, sodium, potassium, manganese, iron, tungsten, silicon, gold, platinum, iridium, copper, palladium, chromel, alumel, rhenium, nickelchromium-silicon, constantan, cadmium, aluminum, rhodium, molybdenum, beryllium, tin, chromium, nickel, nickel-chromium, nickel-aluminum, nickel-silicon, lead, silver, ruthenium, and mixtures thereof.

Suitable binders for resistive polymeric pastes include, without limitation, polymeric materials such as epoxy, polyacrylate, silicone or natural rubber, polyester, polyethylene napthalate, polypropylene, polycarbonate, polystyrene, polyvinyl fluoride ethyl-vinyl acetate, ethylene acrylic acid, acetyl polymer, poly(vinyl chloride), silicone, polyurethane, polyisoprene, styrene-butadiene, acrylonitrile-butadiene-styrene, polyethylene, polyamide, polyether-amide, polyimide, polyetherimide, polyetheretherketone, polyvinylidene chloride, polyvinylidene fluoride, polycarbonate, polysulfone, polytetrafuoroethylene, polyethylene terephthalate, polyhydroxyalkanoate, poly(p-xylylene), liquid crystal polymer, polymethylmethacrylate, polyhydroxyethylmethacrylate, polylactic acid, polyhydroxyvalerate, polyvinyl chloride, polyphosphazene, poly(□-caprolactone). Copolymers or mixtures of polymers may also be used.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of resistive polymeric pastes varies from low to high depending on the particular composition.

According to a further embodiment, the heater trace is formed from nanoparticle ink system. Nanoparticle ink systems typically include, in their initial compositional form, a filler suspended in a solvent. Nanoparticle ink systems are particularly suited to being applied to (i.e., bound to) substrates of, e.g., plastics, silicones, flexible polymers, alumina, ceramic, glass, quartz, semiconductors, and metals (e.g., stainless steel).

Suitable fillers for nanoparticle ink systems include, without limitation, pure metals, metals, and metalloid materials, as classified on the periodic table.

Suitable solvents for this type of system include, without limitation, paraffinic hydrocarbons such as cyclohexane; aromatic hydrocarbons such as toluene or xylene; halohydrocarbons such as methylene dichloride; ethers such as anisole or tetrahydrofuran; ketones such as acetone, methyl ethyl ketone, or methyl isobutyl ketone; aldehydes; esters such as ethyl carbonate, 4-butyrolactone, 2-ethoxyethy acetate or ethyl cinnamate; nitrogen-containing compounds such as n-methyl-2-pyrrolidone or dimethylformamide; sulfur-containing compounds such as dimethyl sulfoxide; acid halides and anhydrides; alcohols such as ethylene glycol monobutyl ether, a-terpineol, ethanol, or isopropanol; polyhydric alcohols such as glycerol or ethylene glycol; phenols; or water or mixtures thereof.

The viscosity of nanoparticle ink systems is typically very low.

### Deposition of Heater Trace on the Surface of the Fluid Conduit

When thick film cermet pastes are used to form the heater trace onto the surface of the fluid conduit, such as fluid conduit 20 shown in FIG. 3, processing of the heater trace typically requires subjecting a deposited heater trace to a high temperature furnace at a temperature of about 850° C., or higher. When resistive polymeric pastes are used to form the heater trace, processing of the heater trace typically requires subjecting a deposited resistive polymeric paste to a lower temperature for cure, e.g., baking at a temperature generally below about 500° C. During processing of the nanoparticle ink system, low temperature bake (generally around 100° C. to about 150° C.), and subsequently a higher temperature bake (generally around 200° C. to about 350° C.) sinters the nanoparticle fillers together making the trace conductive to some degree.

In one embodiment, depositing the heater trace onto the surface of the fluid conduit is carried out by material deposition. There are many ways to achieve material deposition onto a substrate including, without limitation, screen printing, jetting, laser ablation, pressure driven syringe delivery, inkjet or aerosol jet droplet-based deposition, laser or ion-beam material transfer, tip-based deposition techniques such as dip pen lithography, electro-spraying, or flow-based micro-dispensing.

One particularly suitable type of flow-based micro-dispensing employs a pen device, for example, using Micropen™ (Micropen Technologies Corp., Honeoye Falls, N.Y.) or nScrypt® (nScrypt Inc., Orlando, Fla.) direct printing technologies. Such techniques are well described in Pique et al., Direct-Write Technologies for Rapid Prototyping Applications: Sensors, Electronics, and Integrated Power Sources, Academic Press (2002), which is hereby incorporated by reference in its entirety.

According to one embodiment, depositing the heater trace onto the surface of the fluid conduit involves flow-based micro-dispensing using an ink composition. By this means, one can control and manipulate the substrate to apply a uniform and precise trace on the surface of the fluid conduit to heat the fluid conduit as desired.

In one embodiment, depositing a heater trace onto the surface of a fluid conduit is carried out using a Micropen™ direct writing device to dispense a heater trace ink from the pen device through a nozzle to create the deposited heater trace on the surface of the fluid conduit in a desired pattern. Using a Micropen™ direct writing device allows deposition of a heater trace onto the fluid conduit in a pattern to create an uninterrupted trace or coating as desired. According to one embodiment of using a Micropen™ direct writing device, the pen device does not come into contact with the surface of the fluid conduit as the heater trace is being deposited onto the fluid conduit.

Micro-dispensing (e.g., Micropen™ direct writing) is particularly suitable for binding a heater trace onto the surface of a fluid conduit due to the ability to accommodate inks having an extremely wide range of rheological properties and very high solids levels, as well as excellent three-dimensional substrate manipulation capabilities. As a result, any material which can be successfully dissolved or dispersed in liquid, and forms a continuous layer when dry, can be used to adhere to the fluid conduit to form the heater trace. Particularly suitable materials, inks, and compositions are described supra.

Additives may be present in the ink, paste, or material composition forming the heater trace. Thickeners, viscosifiers, or salts may be added to adjust the rheology, resistance, and/or conductive properties of the heater trace to any particular suitable application. Surfactants, defoamers, or dispersants may be present to facilitate or inhibit spreading on the substrate, improve handling of the ink, improve the quality of the dispersion, or change the coefficient of friction of the dried ink. The composition can also comprise one or more surface active agents, rheology modifiers, lubricants, matting agents, spacers, pressure sensors, temperature sensors, chemical sensors, magnetic materials, radiopaque materials, conducting materials, or combinations thereof.

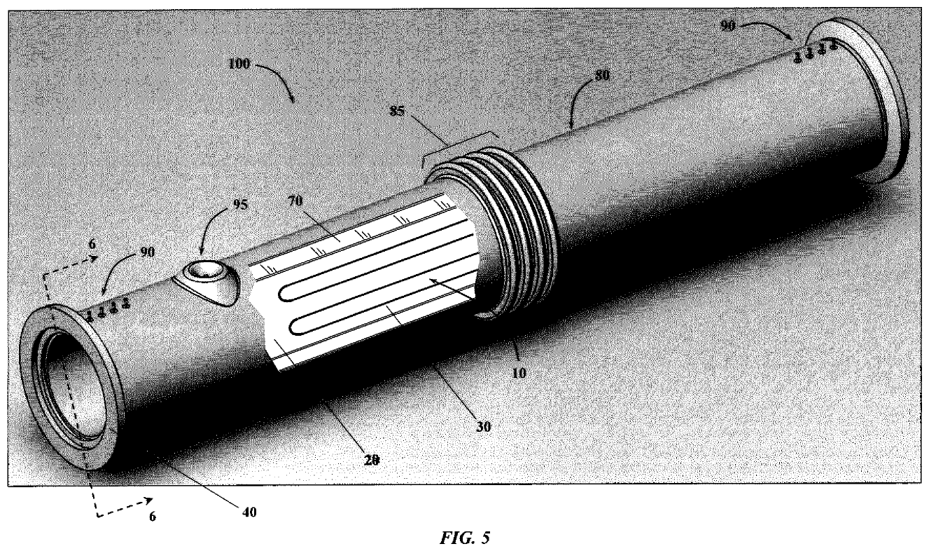

One aspect of the present technology is a fluid conduit assembly 100 that may include, for example, heater conduit 10, is illustrated and explained with reference to FIGS. 5-14, 17, 18, and 20-23. Fluid conduit assemblies can be configured to be joined by both welded and flanged techniques, as described below. For purposes of illustration but not of limitation, fluid conduit assembly 100 is shown to conform to a flanged joining method, and to correspond generally to the ISO-KF standard. Those skilled in the art will appreciate that fluid conduit assembly 100 could also be configured to cooperate with welded connections, other international and industry flange standards, and custom flange designs.

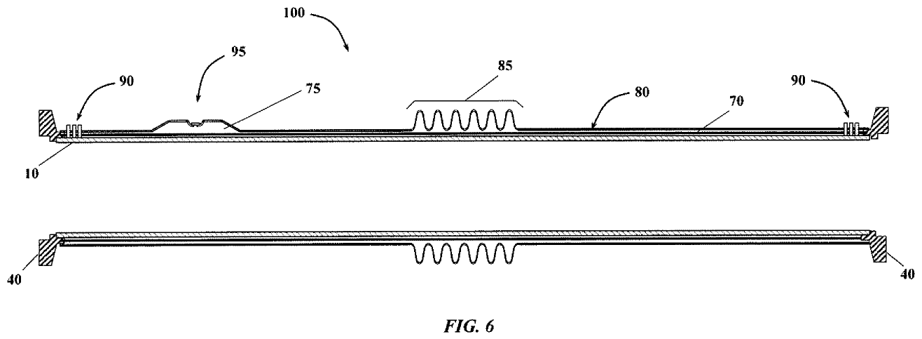

FIG. 5 is an isometric view of fluid conduit assembly 100 with the partial removal of the exterior surface for illustration. A cross-section of fluid conduit assembly 100 along 6-6 is shown in FIG. 6. The fluid conduit assembly 100 is comprised of heater conduit 10 welded at each end to a flange 40, an inner radiation shield 70, an outer radiation shield 80, and an interconnect zone 90 located near each flange 40. The length of heater conduit 10 can be selected such that the total length of fluid conduit assembly 100 conforms to an international, industry, or custom-designed standard. Further, as described below, heater conduit 10 may employ a fluid conduit 20 having other configurations known in the art.

The outer radiation shield 80 includes an expansion zone 85 and a vacuum sealing zone 95. In operation, the thick film layer stack 30 (only the resistive layer 440 is shown in FIG. 5) on heater conduit 10 heats up the fluid conduit assembly 100. As shown in FIG. 6, a vacuum space 75 is formed between the outer surface of heater conduit 10 and the inner surface of the outer radiation shield 80. Note that the inner radiation shield 70 resides wholly within vacuum space 75. The presence of inner radiation shield 70, vacuum space 75, and outer radiation shield 80 suppresses heat transfer to the external environment.

In one embodiment, the inner radiation shield 70 has highly reflective surfaces (i.e., a low emissivity ε at or near 0), is not rigidly fixed, and allows the regions adjacent to its outer and inner surfaces to communicate fluidly with one another. In another embodiment, the outer radiation shield 80 has highly reflective surfaces (i.e., a low emissivity ε at or near 0). In yet another embodiment, the outer radiation shield 80 has a highly reflective inside surface (i.e., a low emissivity ε at or near 0) but the outer surface has a surface finish modified to achieve a desired characteristic such as an aesthetic appearance or identification information. In another embodiment, the exterior surfaces of heater conduit 10 that are exposed (i.e., not covered by a thick film layer stack) are highly reflective (i.e., possess a low emissivity ε at or near 0). In another embodiment, the interior surface of heater conduit 10 has a very low degree of reflectivity (i.e., its emissivity c is at or near 1).

Manipulation of surface reflectivity can be accomplished using applied coatings, surface treatments, anodization, electropolishing or any other technique known in the art. In yet another embodiment, inner radiation shield 70 is eliminated to reduce costs. Because heat losses are suppressed, the heater conduit 10 will rise to a steady state temperature that is higher than that of the outer radiation shield 80, thus creating a thermal expansion stress between the two. The expansion zone 85 is provided to accommodate this stress in outer radiation shield 80. In one embodiment, the expansion zone 85 includes one or more formed corrugations that can readily elongate to relieve the stress, although other methods may be used to accommodate the applied stresses. The vacuum space 75 may optionally be partially or completely filled with any insulative material known in the art, such as layers of reflective sheeting interleaved with layers of low-density materials such as aerogels, by way of example only.

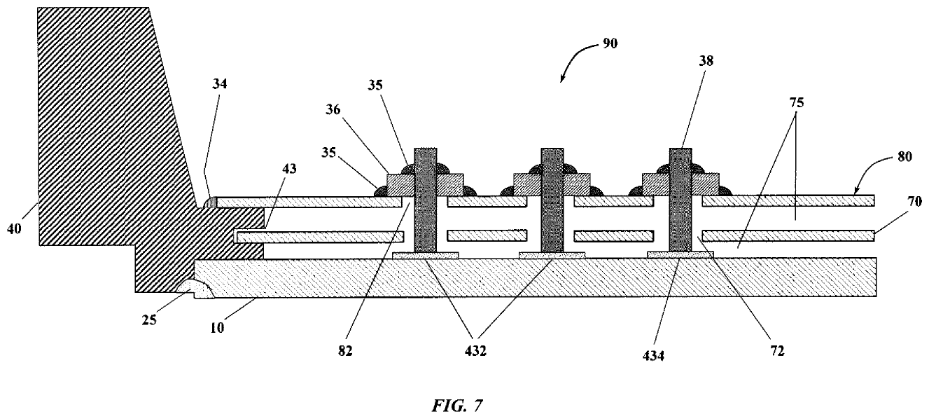

FIG. 7 illustrates the interconnection zone 90 shown in FIGS. 5 and 6 in in greater detail. The interconnection zone 90 allows the contact pads, such as contact pad 432 shown in FIG. 3, formed by the thick film layer stacks, such as thick film layer stack 30, to communicate electrically with the exterior environment. By way of example but not limitation, FIG. 7 shows two contact pads 432, associated with thick film layer stack 30 (a heater trace as shown in FIG. 4a), and one contact pad 434, associated with thick film layer stack 31 (a conductive trace as shown in FIG. 4b). For clarity, the dielectric, resistor, and overcoat layers are not shown.

Referring again to FIG. 7, a contact pin 38 is attached to and electrically communicates with each contact pad 432 and 434. In this example, three contact pins 38 are illustrated. Each contact pin 38 may be attached to the corresponding contact pad 432 or 434 by any suitable method known in the art, such as soldering, brazing, conductive adhesives, or any other appropriate technique. Each contact pin 38 passes through an inner via hole 72 in the inner radiation shield 70 and an outer via hole 82 in the outer radiation shield 80. A non-conductive plug insulator 36 slips over the contact pin 38 and, in this example, is hermetically sealed to the outer radiation shield 80 and the contact pin 38 by interconnect seals 35. The interconnect seals 35 may be formed by any suitable method known in the art, such as ceramic-metal junctions or metallized ceramics known in the ceramic feedthrough industry combined with joining techniques such as welding, soldering, brazing, conductive adhesives, or any other appropriate method.

Also shown in FIG. 7 is an outer radiation shield seal 34 that, in this example, hermetically seals the outer radiation shield 80 to the flange 40. The outer radiation shield seal 34 may be formed by any suitable method known in the art, such as welding, soldering, brazing, conductive adhesives, or any other appropriate technique, with laser welding (in the case of cooperating materials) being a preferred method. Also shown in FIG. 7 is, by way of example, a welded zone 25 formed by welding the heater conduit 10 to the flange 40. For those cases where the materials of heater conduit 10 and flange 40 cooperate (for example, both of stainless steel), a preferred method of forming welded zone 25 is laser welding. Other methods of connecting heater conduit 10 and flange 40 are well known in the art, and in all cases the requirement is to form a strong and hermetic joint. The flange 40 contains a flange groove 43 that receives a portion of the inner radiation shield 70 and assists in holding the inner radiation shield 70 in position without forming a fixed connection.

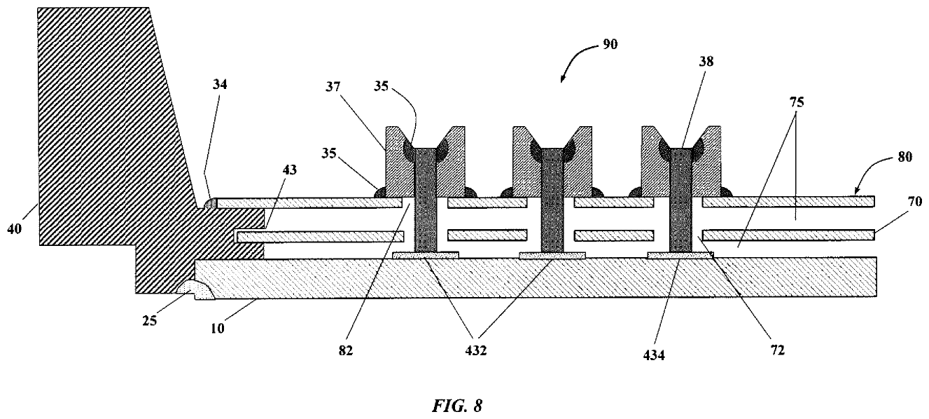

An alternative interconnect scheme is shown in FIG. 8. All elements are identical in structure and function as described with respect to FIG. 7, with the exception that plug insulator 36 is replaced by a socket insulator 37. In this example, socket insulator 37 is non-conductive and its shape, which surrounds contact pin 38, provides protection against inadvertent electrical communication with the contact pin 38.

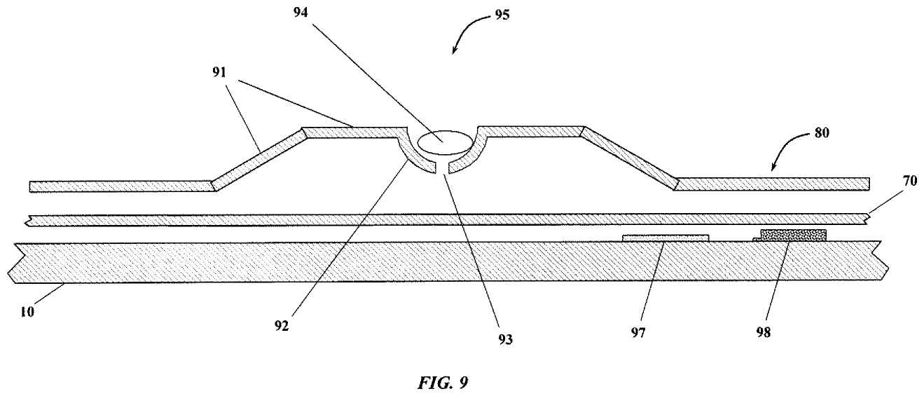

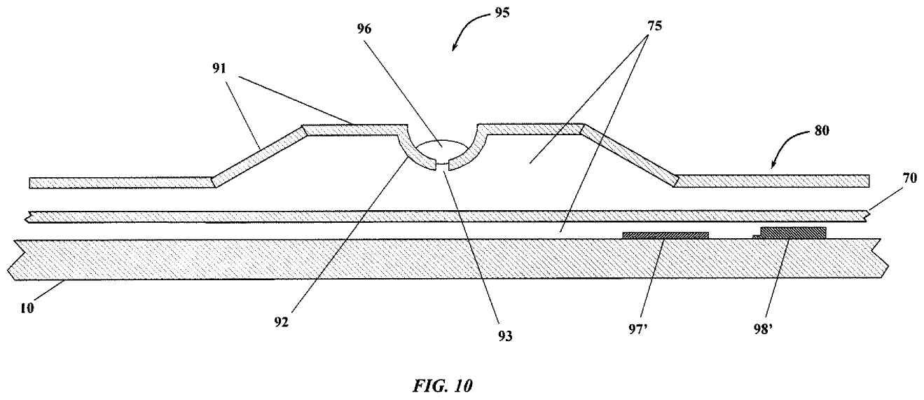

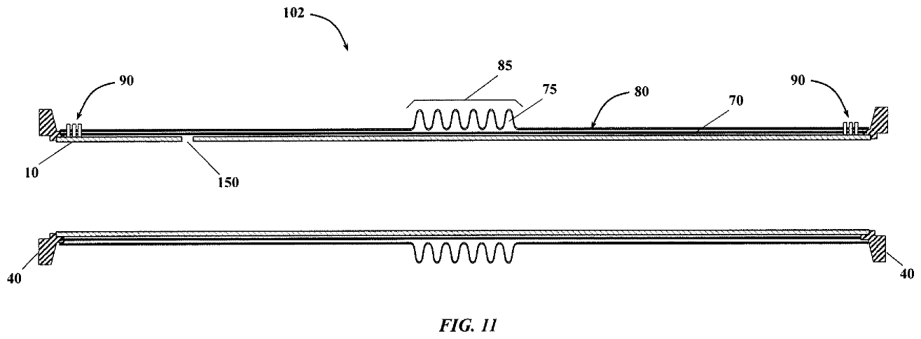

FIGS. 9 and 10 illustrate the vacuum sealing zone 95 shown in FIGS. 5 and 6 in greater detail. In this example, the outer radiation shield 80 includes an expanded shield portion 91 that provides space for the formation of a shield dimple 92 in the outer radiation shield 80. The shield dimple 92 provides a recessed portion in the outer radiation shield 80 and includes an evacuation port 93, which provides an opening in the outer radiation shield 80, at the bottom thereof.

In one embodiment of the present technology, a vacuum and heating cycle is performed to establish the vacuum space 75 within the outer radiation shield 80, as illustrated in FIG. 10. First, a nodule of virgin vacuum seal material 94 is placed within the shield dimple 92, as shown in FIG. 9. The shape and location of virgin vacuum seal material 94 are such that the evacuation port 93 is not completely occluded. The virgin vacuum seal material 94 can be any suitable vacuum sealing material known in the art such as, without limitation, a solder or brazing alloy, an elastomeric material, or a filled epoxy.

The fluid conduit assembly 100 is then placed in a vacuum oven. The volume between the heater conduit 10 and the outer radiation shield 80 is evacuated by drawing a vacuum through evacuation port 93. The fluid conduit assembly 100 is then heated which causes the virgin vacuum seal material 94 to flow and occlude evacuation port 93. Upon cooling, this flowed material forms processed vacuum seal material 96, as shown in FIG. 10, which permanently occludes and closes evacuation port 93. To maintain a suitable vacuum level in vacuum space 75 over extended periods of time, the heater conduit 10 may be provided with a getter material, such as a getter layer 97 printed on its exterior surface or a getter capsule 98 affixed by an appropriate attachment method such as spot welding. Although getter layer 97 and getter capsule 98 are both shown in FIG. 9, it is to be understood that either could be used, or the getter layer 97 and getter capsule 98 could both be employed. Gettering materials are well known in the art, widely used in the electronics industry, and available, for example, from Johnson Matthey Plc. (London, UK). The heat cycle triggers gettering action in these materials, transforming them into an activated getter layer 97′ or an activated getter capsule 98′, as shown in FIG. 10, allowing them to adsorb or react with trace gases over time (particularly H₂O, H₂, CO₂, and organic contaminants) and maintain the integrity of vacuum space 75 shown in FIG. 10.

FIG. 11 illustrates another embodiment of a fluid conduit assembly 102 of the present technology. In this example, fluid conduit assembly 102 achieves a vacuum in vacuum space 75 using a vacuum port 150. The vacuum port 150 has one or more holes (although only one hole is shown for vacuum port 150 in FIG. 11 a number of holes in other locations could be employed) in the heater conduit 10 that allows the interior of heater conduit 10 to communicate fluidly with vacuum space 75. The one or more holes that make up vacuum port 150 should be located where they do not affect or interfere with the operation of the thick film layer stacks, such as thick film layer stack 30 shown in FIG. 3, disposed on the exterior surface of heater conduit 10. This embodiment of the present technology allows for the vacuum sealing zone 95 shown in FIGS. 5 and 6 and the associated vacuum/heat cycle described above to be eliminated, resulting in lower costs. However, this embodiment is limited to implementations where the interior of the heater conduit 10 will be kept under sufficiently reduced pressure during substantially all the time that the heater conduit 10 is operated at elevated temperature, as would be understood in the art.

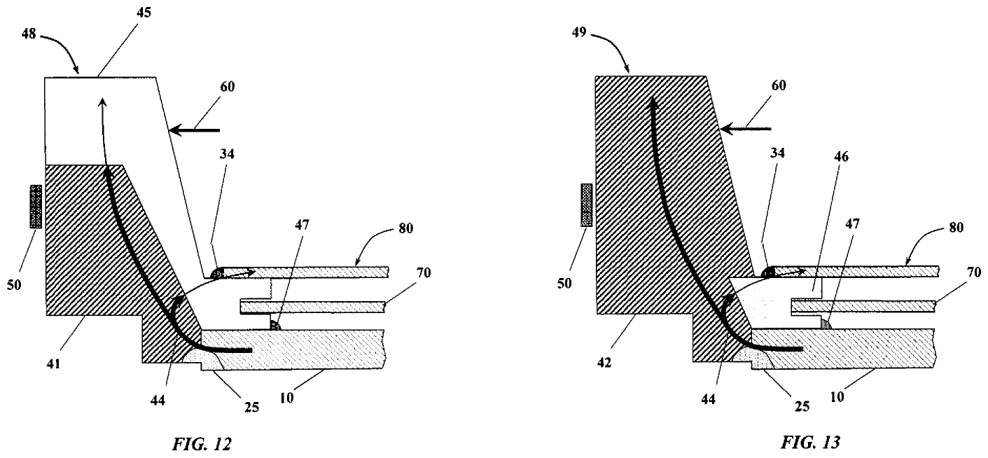

In another aspect of the present technology when the fluid conduit assembly, such as fluid conduit assembly 100 shown in FIG. 5, is constructed primarily of metals, modifications to the flanges 40 or the heater conduit 20 may be made to further reduce heat loss to the external environment. FIGS. 12 and 13 illustrate composite flanges that may be utilized to replace flange 40 shown in FIG. 5, by way of example.

FIG. 12 illustrates a compound flange 48 that is formed from a modified flange 41 and a ceramic insert 45. The material for ceramic insert 45 is selected to have a low thermal conductivity, such as Macor® (Corning Inc., Corning, N.Y.) or zirconia, by way of example only. Heat flow 44 (the magnitude of heat flow is qualitatively represented by the thickness of the flow lines) can readily conduct from heater conduit 10 into modified flange 41. However, because of the lower thermal conductivity of ceramic insert 45, heat flow 44 into the outer radiation shield 80 and the perimeter of the compound flange 48 is reduced. FIG. 13 illustrates an alternative compound flange 49 that is modified to a smaller degree to accept an alternative ceramic insert 46 (which is also selected to have a low thermal conductivity). In this embodiment, only the heat flow to the outer radiation shield 80 is reduced.

In both of the embodiments shown in FIGS. 12 and 13 a ceramic insert seal 47 is provided to create a vacuum tight seal between heater conduit 10 and the ceramic insert (45 or 46). While the compound flange 49 of FIG. 13 exhibits more heat loss than the compound flange 48 of FIG. 12, the alternative scheme of FIG. 13 may be preferred when the application of a sealing force 60 to a ceramic material, such as ceramic insert 45 shown in FIG. 12, is undesirable.

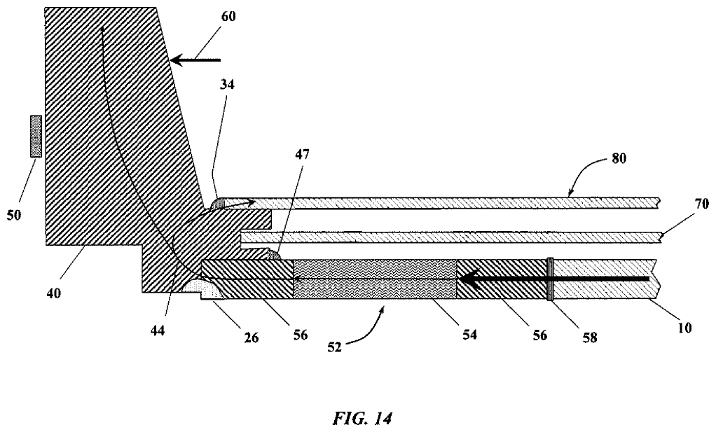

FIG. 14 illustrates a third embodiment to reduce heat loss, for example in the fluid conduit assembly 100 shown in FIG. 5, using a metal-ceramic-metal insulator 52. In this example, the metal-ceramic-metal insert 52 includes a ceramic insert 54 and metal end faces 56 and is interposed between flange 40 and heater conduit 10. The metal-ceramic-metal insulator 52 is affixed to flange 40 by a welded zone 26 and to the heater conduit 10 by a butt weld 58. The metal-ceramic-metal insulator 52 is formed using well known metal-ceramic bonding techniques found, for example, in the vacuum insulator industry. In this example, heat flow 44 from the heater conduit 10 into the outer radiation shield 80 and the perimeter of the flange 40 is reduced.

Another aspect of the present technology relates to a fluid transport system including at least two of the fluid conduit assemblies of the present technology.

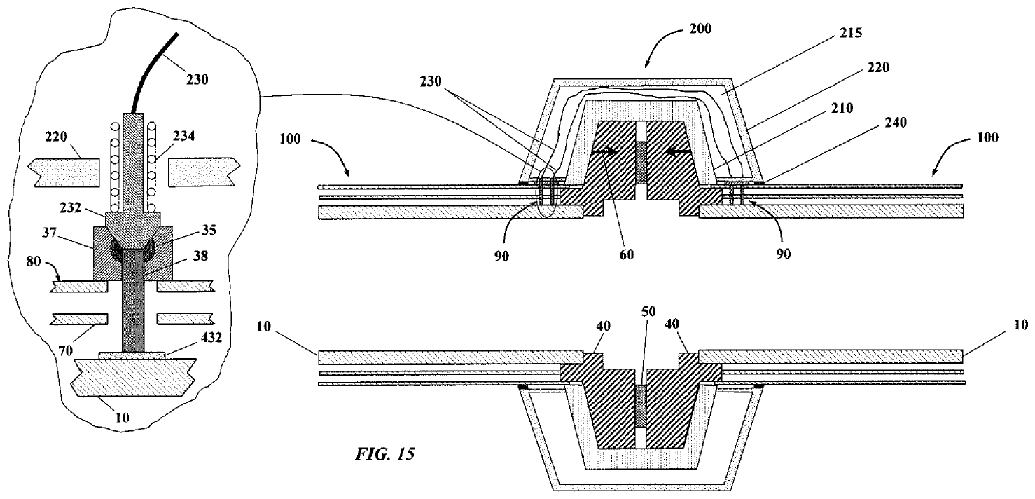

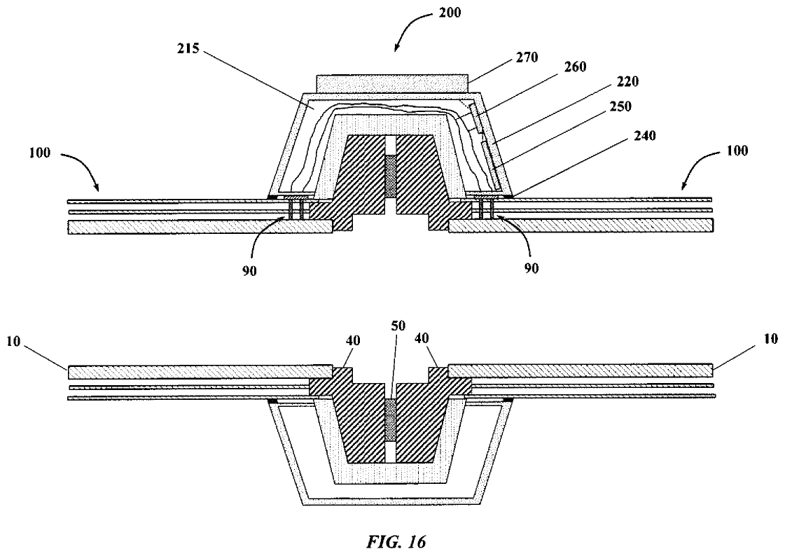

Another aspect of the present technology relates to a clamping device that may be used to couple two fluid conduit assemblies, such as fluid conduit assembly 100 shown in FIG. 5, by way of example only, of the present technology. FIGS. 15 and 16 illustrate cross-sectional views of a multi-function clamp 200 that provides a variety of functions including, but not limited to, mechanical clamping, power and signal distribution, temperature control, communication, creating seals, and system monitoring when combining two fluid conduit assemblies of the present technology, such as fluid conduit assembly 100 shown in FIG. 5. Although multi-function clamp 200 is described with respect to connecting two fluid conduit assemblies 100, it is to be understood that multi-function clamp 200 could be employed to connect other fluid assemblies have other configurations, including but not limited to the additional examples set forth herein. Further, although multi-function clamp 200 is shown in cross-section, it is to be understood that multi-function clamp 200 surrounds the circumference of the connected fluid conduit assemblies. In one example, multi-function claim 200 is a latchable, hinged, clamshell clamp, although other clamp configurations may be employed. Multi-function claim 200 advantageously allows for connection of the two fluid conduit assemblies 100 in a single step, as described in further detail below, which provides time and cost savings.

Referring now to FIG. 15, the multi-function clamp 200 comprises at least an inner member 210 and an outer member 220. Note that the outer member 220 may include insulative means (not shown) to reduce heat loss to the external environment. The inner member 210 engages a surface of the flange 40 and exerts sealing force 60 sufficient to obtain proper sealing action of sealing assembly 50. Inner member 210 may have various configurations with elements configured to engage the surface of the flange 40. Inner member 210 and outer member 220 create an interstitial space 215 that may also include insulative means. Within interstitial space 215 are wires 230 that communicate electrically with the interconnect zones 90 of both fluid conduit assemblies 100 joined by multi-function clamp 200, as described in further detail below.

In one embodiment, shown in the enlarged inset of FIG. 15, each wire 230 is connected to a contactor 232 which makes electrical contact with contact pin 38 of the interconnect zone 90. This configuration allows the wires 230 to be electrically connected in a plug and play manner during connection of the fluid conduit assemblies 100, without the need to hand wire the electrical connections between components. A spring 234 urges contactor 232 into intimate relationship with contact pin 38. The function of wires 230 includes, but is not limited to, communicating electrical power, monitoring signals, and transmitting data between fluid conduit assemblies 100. The number of wires 230 is not limited but will generally be at least two, although any number of wires may be employed. A clamp seal 240 is disposed at or near each outer perimeter of outer member 220 to create a seal between multi-function clamp 200 and each fluid conduit assembly 100. The clamp seals 240 may be composed of elastomeric materials. In addition, the sealing action may be aided or obtained using an auxiliary sealing collar (not shown).

In another embodiment, multi-function clamp 200 may include additional elements as illustrated and described with respect to FIG. 16. In this example, the multi-function clamp 200 also comprises an internal heater 250, a control module 260, and an external chassis 270. The control module 260 communicates electrically with the wires 230, the internal heater 250, and the external chassis 270. The external chassis 270 is configured to facilitate communication with the external world and may include by way of example, but not of limitation, I/O control modules, pinned receptacles and plugs, wireless transmitters and receivers, control panels, human interfaces such as keypads, touch screens, display screens, annunciator panels, and indicator lights, by way of example. The actions of the control module 260 include but are not limited to: drawing electrical power from wires 230, drawing electrical signals (e.g., temperature sensor signals or data bus signals) from wires 230, providing controlled power to the internal heater 250 in order to help maintain the required temperature range in the fluid transport system, controlling power to the heater conduits 10 of fluid conduit assemblies 100 based upon temperature measurement signals, communicating with other multi-function clamps 200 located throughout the fluid transport system (via cable or wirelessly through the external chassis 270), and communicating with the external environment (via cable or wirelessly through the external chassis 270). While shown in FIG. 16 within the interstitial space 215, the control module 260 could also be mounted exterior to the outer member 220, for example within the body of the external chassis 270.

In the embodiments of fluid conduit assemblies 100 and 102 shown in FIGS. 6 and 11, respectively, the flanges 40 cooperate (and may be referred to as “cooperative flanges”) with outer radiation shield 80 to form the outer radiation shield seals 34 which are hermetic seals that, in part, assure the integrity of vacuum space 75. Not all flange configurations will cooperate thusly, and welded fluid conduit assemblies do not offer the possibility of forming outer radiation shield seal 34. Therefore, an alternative method of sealing the ends of outer radiation shield 80 is required in such examples.

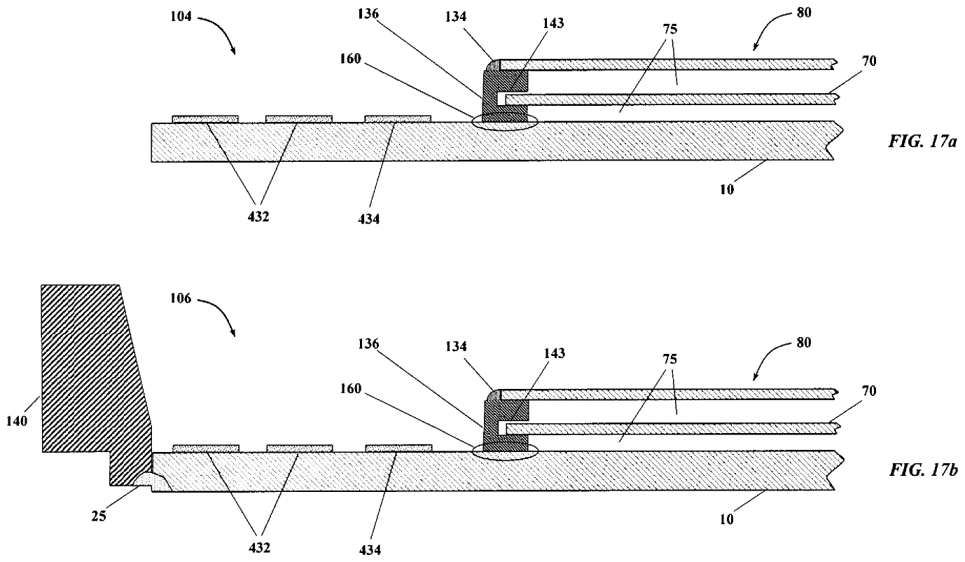

FIGS. 17a and 17b illustrate additional embodiments of fluid conduit assembly 104 and fluid conduit assembly 106, respectively, where a termination collar 136 cooperates with outer radiation shield 80 and heater conduit 10 to assure the integrity of vacuum space 75. The termination collar 136 is hermetically sealed to outer radiation shield 80 by a collar joint 134 and to heater conduit 10 by a collar seal 160. Termination collar 136 has a collar groove 143 to receive a portion of and engage inner radiation shield 70. In fluid conduit assembly 104, one terminal end of heater conduit 10 (shown on the left in FIG. 17a) is suitable for a welded connection to other fluid conduit assemblies. For example, fluid conduit assembly 106 is shown in FIG. 17b in which heater conduit 10 is welded to an alternative flange 140 (i.e., a “non-cooperative flange”).

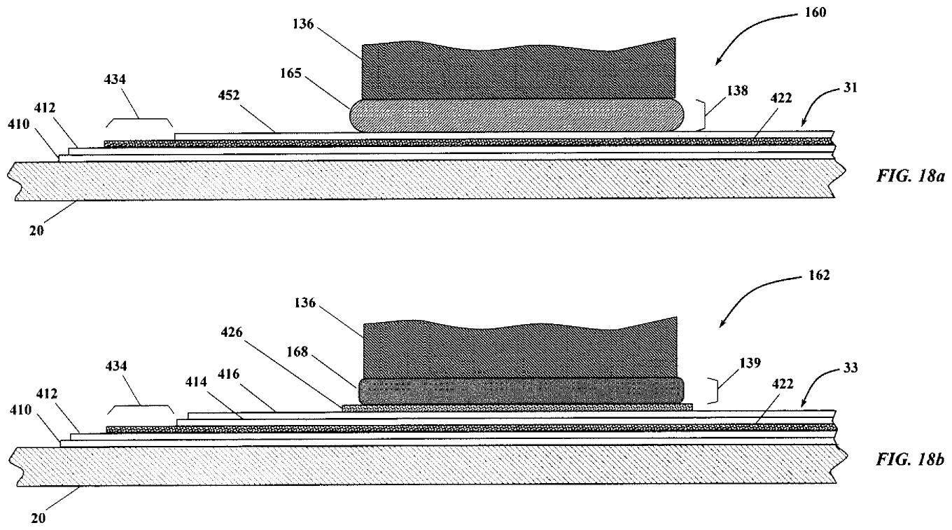

FIGS. 18a and 18b illustrate further details of the collar seal 160 shown in FIGS. 17a and 17b. For example, the details of construction of the thick film layer stack (omitted in FIG. 17a and FIG. 17b) are included. A first embodiment of collar seal 160 is shown in FIG. 18a. In this embodiment, the thick film layer stack 31 follows the description of FIG. 4b. A collar gap 138 is formed between the termination collar 136 and the overcoat layer 452 and filled with a collar gasket 165. The collar gasket 165 is preferably a flexible adhesive material such as a silicone sealing compound that exhibits excellent adhesion to metals, ceramics, and polymers. It has been found that the flexibility of collar gasket 165 can serve to relieve the thermal stresses that can form between outer radiation shield 80 and the fluid conduit 20. In this regard, collar seal 165 can obviate the need for the expansion zone 85 shown in FIGS. 5 and 6, which may result in lower costs of manufacture.

A second embodiment of a collar seal 162 is shown in FIG. 18b. In this embodiment, the thick film layer stack 33 follows the description of FIG. 4d. A collar gap 139 is formed between the termination collar 136 and transverse conductor layer 426. In this embodiment transverse conductor layer 426 is not employed for electrical conductivity but for its ability to cooperate with a soldering or brazing process. The collar gap 139 is filled with a collar fill material 168 which may be any suitable formulation amenable to soldering, brazing, or any other hermetic seal-forming process known in the art. In this embodiment, termination collar 136 is formed from a material that can cooperate with whatever process is used to form collar fill material 168.

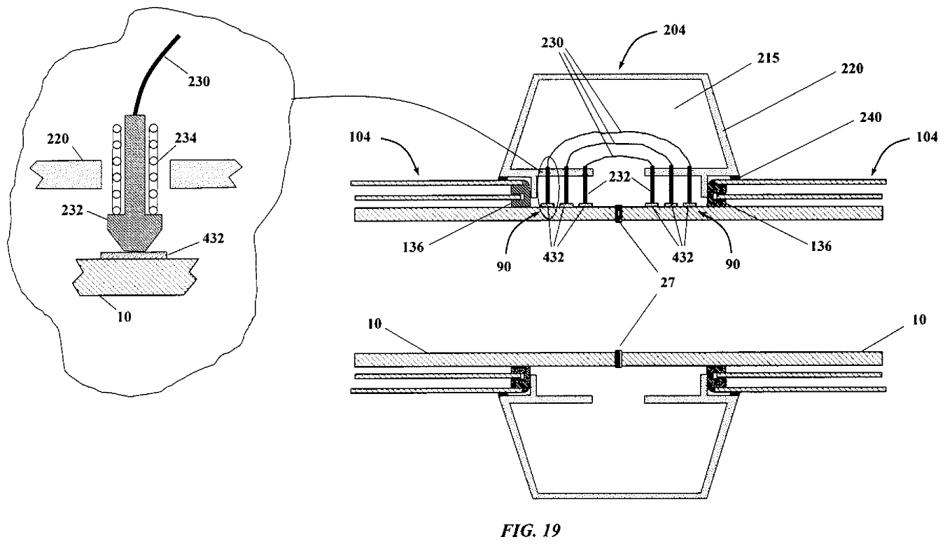

FIG. 19 is a cross-sectional view of another embodiment of a multi-function clamp 204 that is adapted for use with fluid conduit assemblies 104 that are joined by welding, forming a welded zone 27. The details of the internal workings of multi-function clamp 204 are the same in operation and follow the description of multi-function clamp 200 set forth above. In this example, contactor 232 extends through inner member 220 and directly contacts contact pad 432 as shown in the enlarged inset.

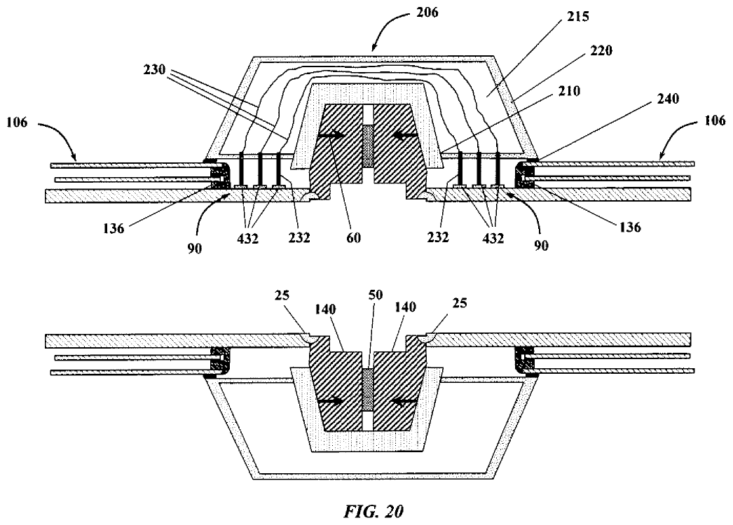

FIG. 20 illustrates yet another embodiment of a multi-function clamp 206 that is adapted for use with fluid conduit assemblies 106 that are joined by “non-cooperative” alternative flanges 140. The details of the internal workings of multi-function clamp 206 are the same in operation and follow the description of multi-function clamp 200 set forth above.

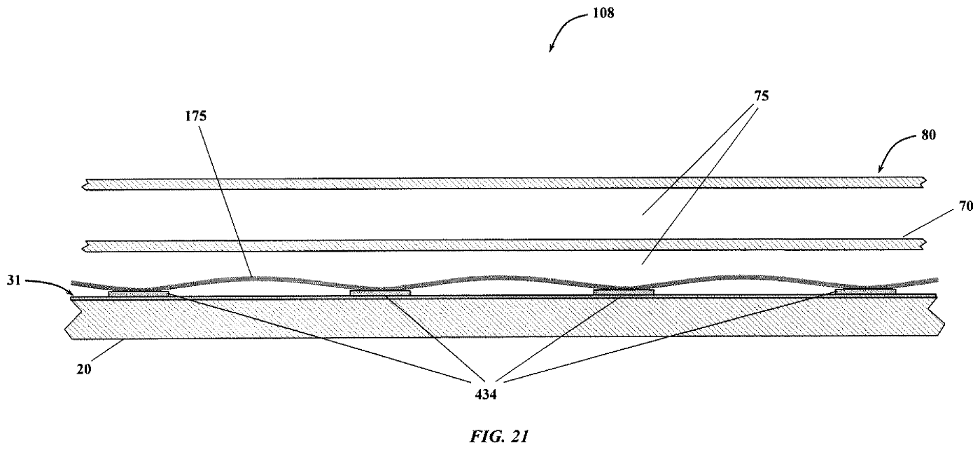

Another embodiment of a fluid conduit assembly 108, is shown in FIG. 21 and is adapted to provide conductor traces with reduced resistance. At least one of the thick film layer stacks on fluid conduit assembly 108 has the conductor trace geometry of thick film layer stack 31 (see FIG. 4b). In this embodiment, thick film layer stack 31 is formed with a series of contact pads 434. A conductive strap 175 is provided to serve as an additional electric current path. The conductive strap 175 is preferably formed from a highly conductive metal such as copper or silver, may have a conductive coating, may be partially clad in an insulative jacket, and may be drawn in the form of a flat ribbon, by way of example. The conductive strap 175 is affixed to the series of contact pads 434 via soldering, brazing, conductive adhesives, or any other joining method known in the art to produce highly conductive electrical connections.

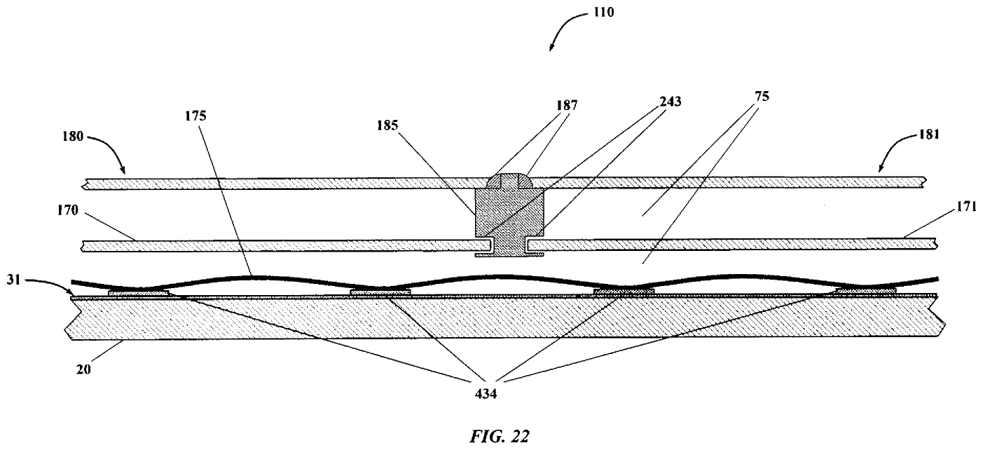

FIG. 22 shows yet another embodiment of a fluid conduit assembly that is adapted to be formed from multiple outer (180 and 181) and inner (170 and 171) radiation shields. In this example, fluid conduit assembly 110 uses the fluid conduit 20, thick film layer stack 31, and conductive strap 175 of fluid conduit assembly 108. However, in this embodiment, a first outer radiation shield 180, a second outer radiation shield 181, a first inner radiation shield 170, and a second inner radiation shield 171 are fixedly held in relation by a joining ring 185. Joining ring 185 has ring grooves 243 that receive and engage the ends of the first inner radiation shield 170 and the second inner radiation shield 171. The first outer radiation shield 180 and the second outer radiation shield 181 are hermetically sealed to the joining ring 185 by joining ring seals 187.

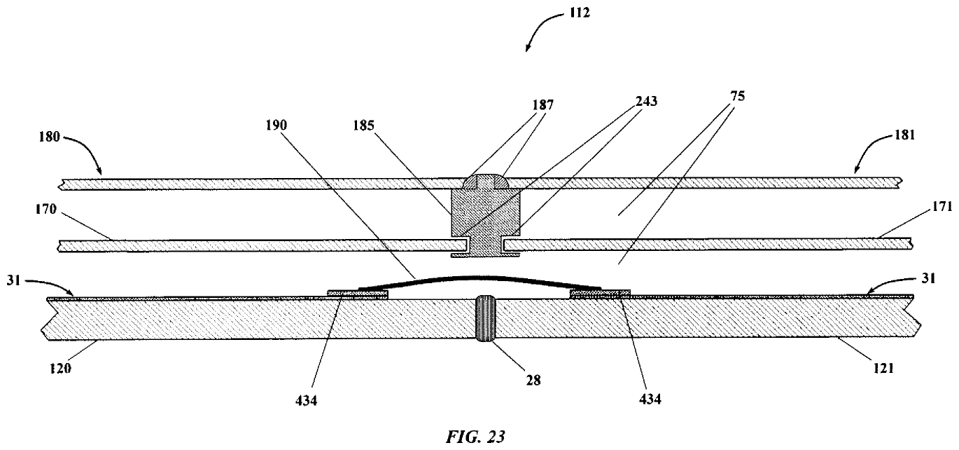

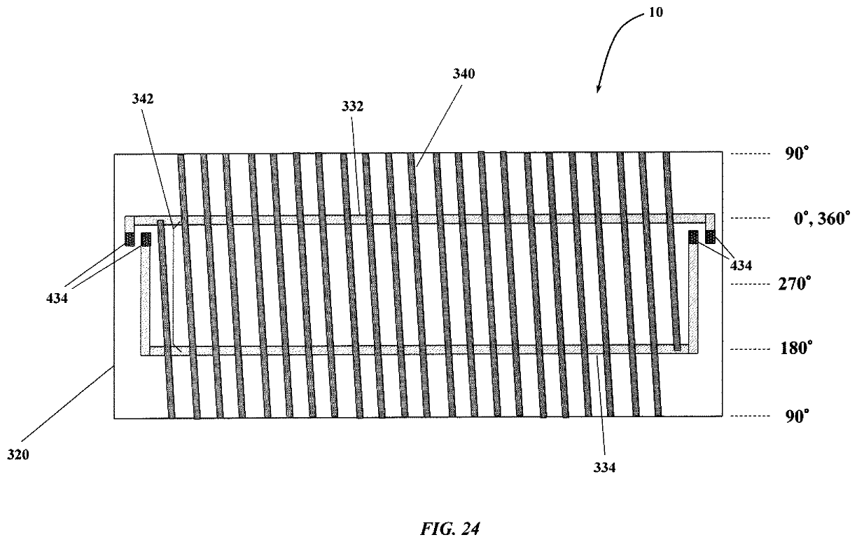

FIG. 23 illustrates a further embodiment of a fluid conduit assembly 112 that is adapted to be formed from multiple outer (180 and 181) and inner (170 and 171) radiation shields as well as multiple fluidic conduits (120 and 121). Fluid conduit assembly 112 uses the first outer radiation shield 180, the second outer radiation shield 181, the first inner radiation shield 170, the second inner radiation shield 171, the joining ring 185, and the joining ring seals 187 of fluid conduit assembly 110 as shown and described in FIG. 22. However, in this embodiment, a first fluid conduit 120 and a second fluid conduit 121 are joined by welding, resulting in a welded zone 28. The thick film layer stacks 31 on each of the first fluid conduit 120 and the second fluid conduit 121 are configured to provide contact pads 434 near the welded zone 28 on each side of the welded zone 28. A conductive bridge 190 extends between and electrically connects contact pads 434. The nature of and joining methods for conductive bridge 190 follow the details provided for conductive strap 175 as described above. In this embodiment, fluid conduit assembly 112 can be fabricated to an arbitrary length that is not constrained by length limitations on the manufacture of inner radiation shields 170 and 171, outer radiation shields 180 and 181, and fluid conduits 120 and 121, or the depositing of thick film layer stacks, such as thick film layer stacks 31 as shown in FIG. 23.

Details of the thick film construction of heater conduit 10 in various configurations are shown in FIGS. 24 through 34. These figures show the heater conduit 10 in a flat view where the exterior surface has been “unfurled” into a rectangle, shown as a heater conduit floor plan 320. To facilitate visualization, circumferential angular markers have been provided at 0° (and 360°), 90°, 180°, and 270°. These angular markers will correspond to meaningful physical landmarks as described below in the various embodiments. To further facilitate visualization, the dielectric and overcoat layers have been omitted. Only layers and landmarks that correspond to conductive traces, heater traces, and contact pads are depicted.

FIGS. 24 through 29, as described below, illustrate embodiments of the present technology using a “polar” design, wherein the main longitudinal runs of the power buses (described further below) are in the 0° and 180° alignment. Like elements in these embodiments are described using like numerals.

Referring now to FIG. 24, in this example the heater conduit 10 is provided with thick film layers that form a conductive first power bus 332 and a conductive second power bus 334, both of which end at contact pads 434. First power bus 332 has a main longitudinal run aligned to the 0° marker and short circumferential sections that jog in the negative angular direction to connect with contact pads 434. Second power bus 334 has a main longitudinal run aligned to the 180° marker and longer circumferential sections (approximately the length of half the circumference) that jog in the positive angular direction to connect with contact pads 434. A helical heater trace 340 is printed as one continuous trace that crosses the first power bus 332 and the second power bus 334 multiple times. In this configuration, each section of helical heater trace 340 that traverses the arc 0° to 180° or the arc 180° to 360° forms an individual resistive heater element 342. In this configuration, all of the individual resistive heater elements 342 act as electrically parallel circuits.

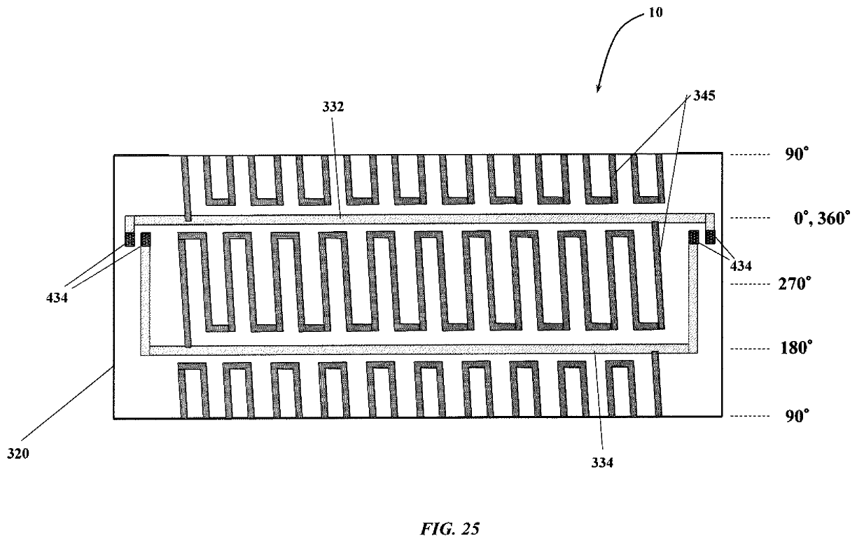

FIG. 25 illustrates two serpentine heater traces 345 that are printed such that one end of each of the serpentine heater traces 345 contacts the first power bus 332 and the other end contacts the second power bus 334. Serpentine heater traces 345 are illustrated in the hemi-cylinder defined between 0° and 180° and the hemi-cylinder defined between 180° and 360°. The serpentine heater traces 345 are the same in structure and function. Electrically, the two serpentine heater traces 345 act as a parallel circuit.

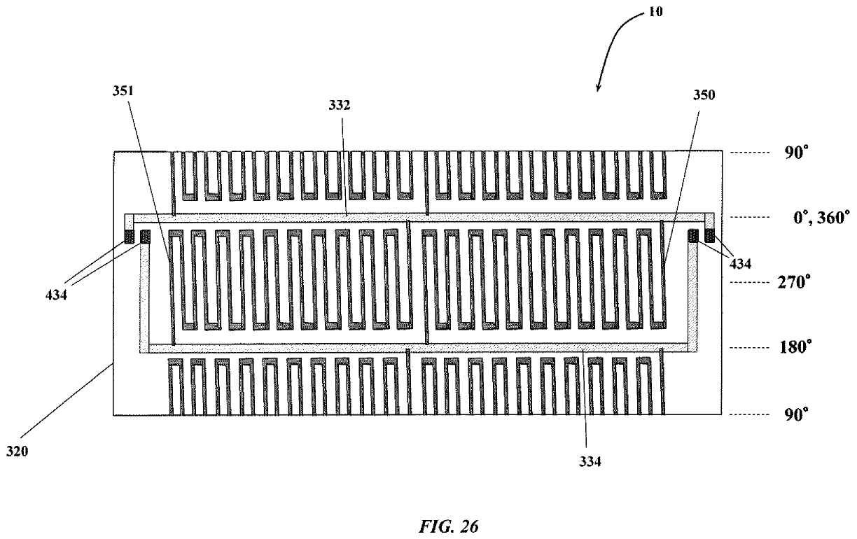

FIG. 26 illustrates a first half-serpentine heater trace 350 and a second half-serpentine heater trace 351 that are printed such that the first half-serpentine heater trace 350 and the second half-serpentine heater trace 351 both contact both the first power bus 332 and the second power bus 334 and are each contained within their defined hemi-cylinder (either 0° to 180° or 180° to 360°). In this embodiment, the combination of the first half-serpentine heater trace 350 and the second half-serpentine heater trace 351 can be formed in both hemi-cylinders, providing a total of four individual heater traces all of which act electrically as parallel circuits.

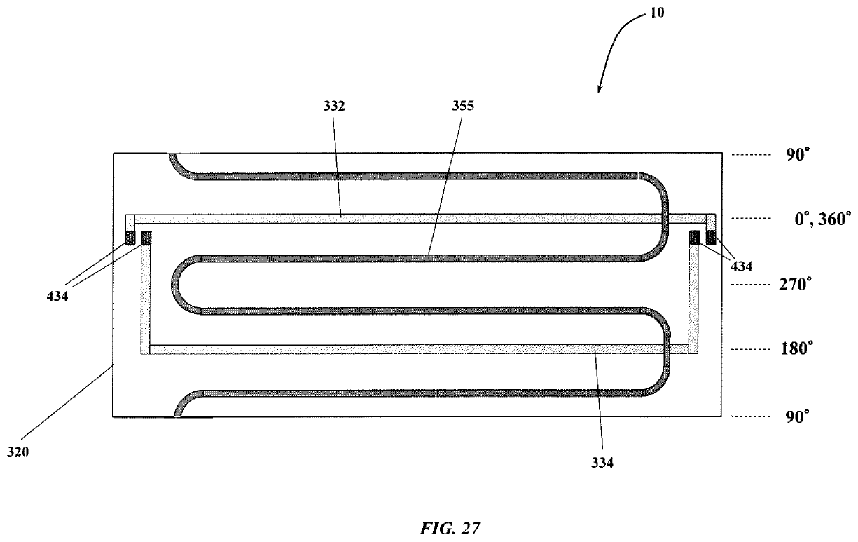

FIG. 27 illustrates a longitudinal heater trace 355 in the shape of a single loop that is formed in each defined hemi-cylinder (either 0° to 180° or 180° to) 360°, providing two individual heater traces that electrically act in parallel.

It will be appreciated by those skilled in the art that the selection of heater trace geometry is driven by multiple factors including physical dimensions, details of the power source, power ratings for the heaters, properties of the thick film materials, and application specific requirements. The examples described herein are representative of the wide design latitude afforded by thick film construction and not to be construed as limiting the present technology in any way.

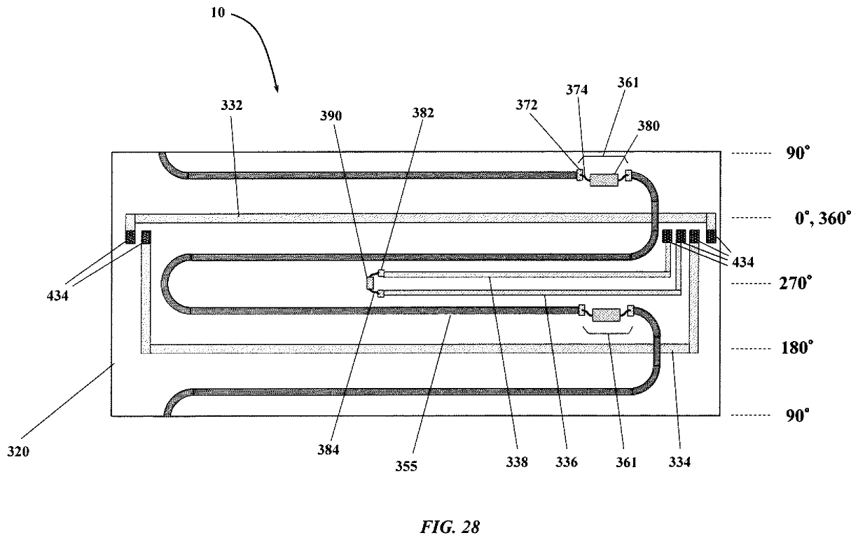

Another aspect of the present technology is the incorporation of thermal switches and temperature sensors, and one embodiment of the present application is herewith described. Following the general features of FIG. 27 as a starting point for illustrative simplicity, FIG. 28 illustrates the longitudinal heater trace 355 formed with a circuit interruption 361 in the heater trace 355. Note that the circuit interruption 361 can be formed at any convenient location along the heater trace 355. Each end of circuit interruption 361 is provided with a thermal switch connection pad 372 that is conductive and contains an electrical connection means such as a solderable surface. A thermal switch 380 is provided, each end of which is connected to one of the thermal switch connection pads 372 by a thermal switch wire lead 374. The thermal switch 380 can be of the bi-metallic type or any other type of switch known in the art that operates by thermo-mechanical means. Temperature sensing can be accomplished by providing a first temperature sensor bus 336 and a second temperature sensor bus 338 each of which is equipped with a temperature sensor connection pad 382 and contact pad 434. The connection pad 382 is conductive and contains an electrical connection means such as a solderable surface. A temperature sensor 390 is provided, each end of which is connected to one temperature sensor connection pad 382 by a temperature sensor wire lead 384. It will be appreciated by those skilled in the art that the thermal switch 380 and the temperature sensor 390 may be fixed to the exterior surface of the heater conduit 10 by known methods such as soldering, ultrasonic soldering, brazing, or the use of adhesives such as thermally conductive adhesive formulations. In addition, the thermal switch 380 and the temperature sensor 390 may be encapsulated with dielectric underfill and overfill materials routinely used in the high temperature electronics industry. The encapsulation material may also envelop the wire leads and connection pads. Although this embodiment is described with respect to interruptions in the longitudinal heater trace 355, it should be appreciated that thermal switches and temperature sensors can be incorporated onto any heater conduit without regard to the specific heater trace design that is utilized. Additionally, the location and number of thermal switches and temperature sensors are not limited by the specific heater trace design and are selected as appropriate for the application.

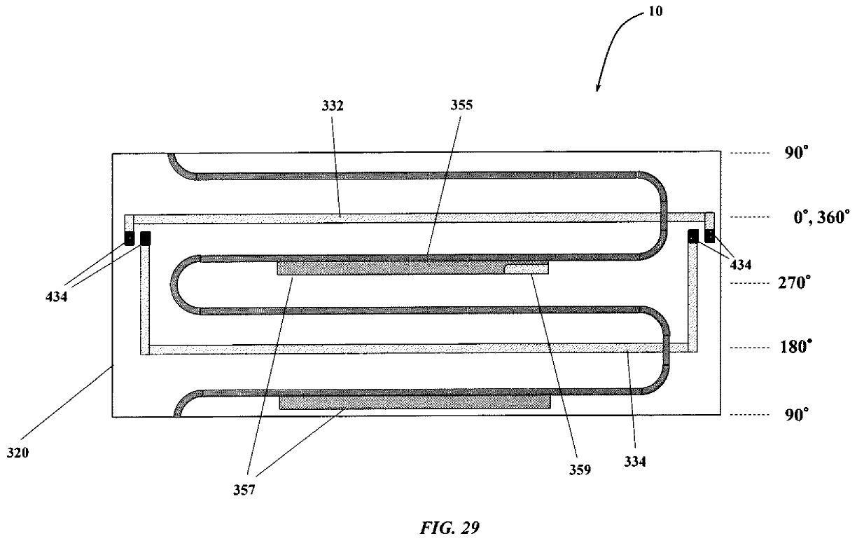

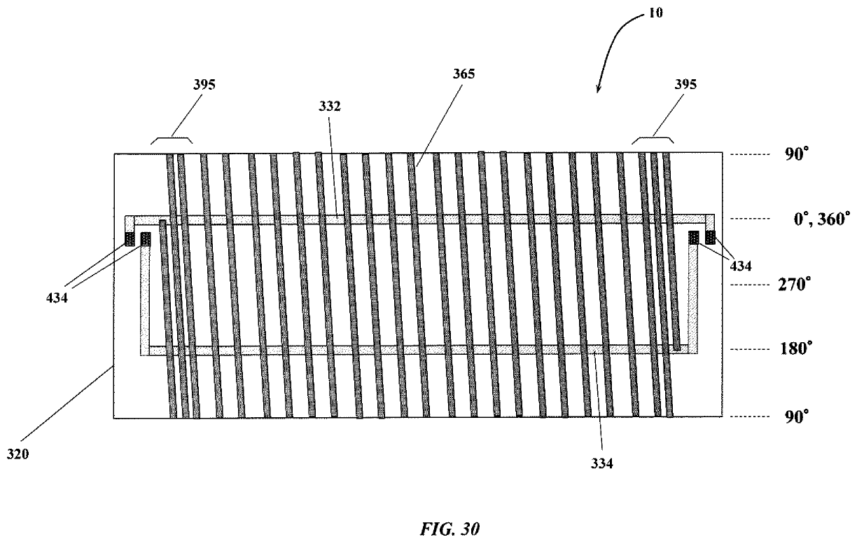

In another aspect of the present technology, the resistive heater traces, such as the heater trace 355 in FIG. 27, may be trimmed to achieve a specific desired resistance value as shown in FIG. 29. Again, following the general features of FIG. 27 as a starting point for illustrative simplicity, in the example shown in FIG. 29 a trimmer section 357 is added to each longitudinal heater trace 355 by, for example, appropriately varying the deposited width of the heater trace 355 in certain areas. Methods to trim the resistance value of thick film resistors are well known in the industry. While monitoring the resistance at contact pads 434, a trimming tool will utilize a technique such as laser machining or abrasive blasting to remove part of the trimmer section 357, creating a trim kerf 359 and increasing the measured resistance. Trimming is halted when the measured resistance equals the desired value.

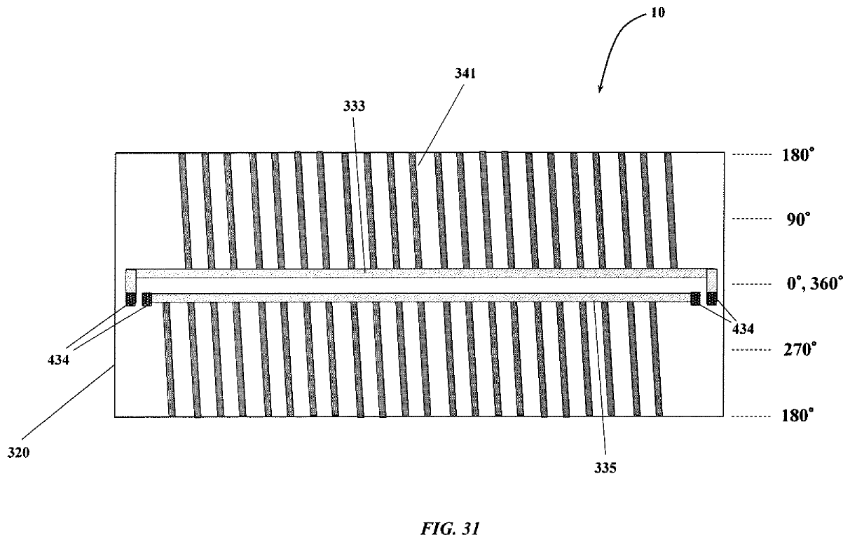

In yet another aspect of the present technology, FIG. 30 illustrates an example in which the inherently cooler flange ends of the heater conduit 10 may be overcome by adjusting the heat flux of the thick film heaters. FIG. 30 follows the general configuration of FIG. 24 but substitutes a non-uniform helical heater trace 365 for helical heater trace 340. The pitch of helical heater trace 365 is made smaller in a dense heater zone 395 at each end of the heater conduit 10. The greater heat flux in the dense heater zones 395 causes heat to flow toward the flanges 40 and multi-function clamps 200 (for example as shown in FIG. 15) and tends to eliminate cool spots in those locations. Those skilled in the art of thick film design will appreciate that the strategy of using variations of pitch to change heat flux can be used to generate arbitrary temperature profiles along the length of the heater conduit 10 as appropriate for a given application.

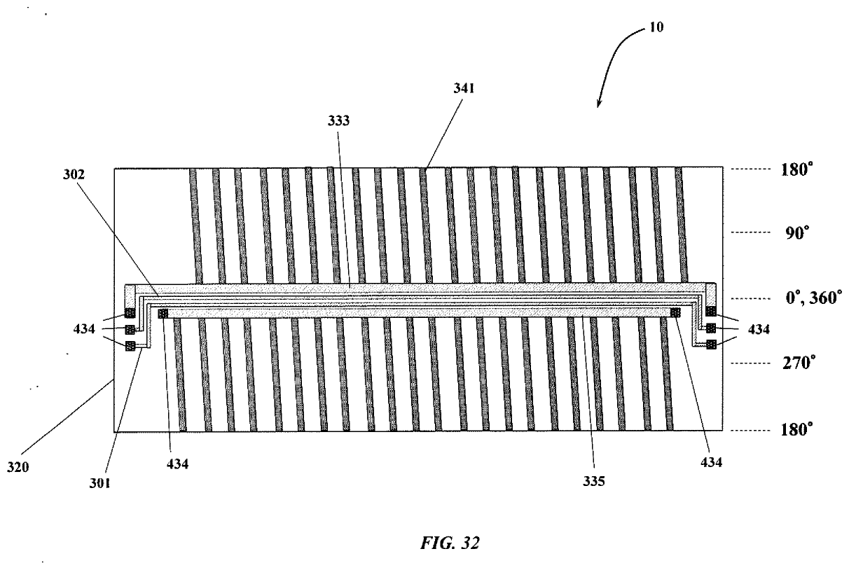

FIGS. 31-34 illustrate various embodiments using a “straddling” design, wherein the main longitudinal runs of the power buses (described further below) straddle the 0° alignment mark. Like elements in these embodiments are described and illustrated using like numerals.

FIG. 31 illustrates a first embodiment of the present technology using the “straddling” configuration. In this embodiment, the heater conduit 10 has a first power bus 333 and a second power bus 335 formed in a close spatial relation and oriented such that the 0° alignment mark approximately bisects the gap between the two. The resistive heaters are formed by an interrupted helical heater trace 341 wherein the portions of the resistive elements within the short gap between the first power bus 333 and the second power bus 335 are omitted.

FIG. 32 illustrates another embodiment in which additional conductive traces in the form of a first data line 301 and a second data line 302 are formed in the space between the first power bus 333 and the second power bus 335. While two additional conductive traces are shown in this exemplary embodiment, any number of conductive traces could be formed limited only by the physically available space on the heater conduit 10.

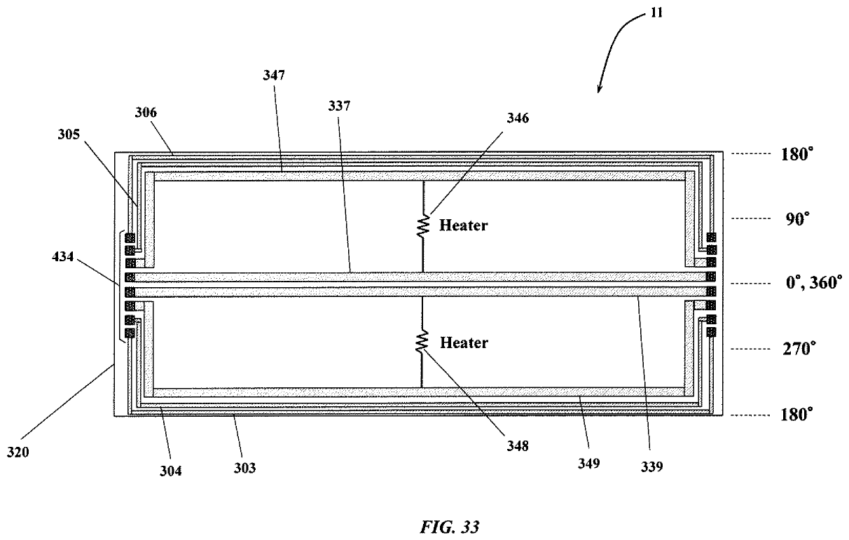

FIG. 33 illustrates another exemplary heater conduit 11. In this example, a first power bus 337 and a second power bus 339 convey electrical power down the length of heater conduit 11. A first heater 346 and a second heater 348 are disposed in their respective hemi-cylinders defined by the angular ranges 0° to 180° and 180° to 360°. The first heater 346 and the second heater 348 may have longitudinal or interrupted helical geometries as described in previous examples or they may have any other suitable geometry. Both are represented electrically as a resistor symbol to emphasize that their purpose is to produce heat. The first heater 346 is provided with a first heater return bus 347 that is used to close the circuit. The second heater 348 is provided with a second heater return bus 349 that is used to close the circuit. Note that both the first heater 346 and the second heater 348 may be actuated electrically by accessing the appropriate contact pads 434 at either end of heater conduit 11. Additionally, four conductive traces are disposed around the perimeter of heater conduit 11 in the form of a first data line 303, a second data line 304, a third data line 305, and a fourth data line 306. First data line 303, second data line 304, third data line 305, and fourth data line 306 serve to convey electrical signals from one end of heater conduit 11 to the other. While four data lines are depicted in this embodiment, any number of conductive traces forming data lines could be disposed on heater conduit 11, limited only by the physically available space.

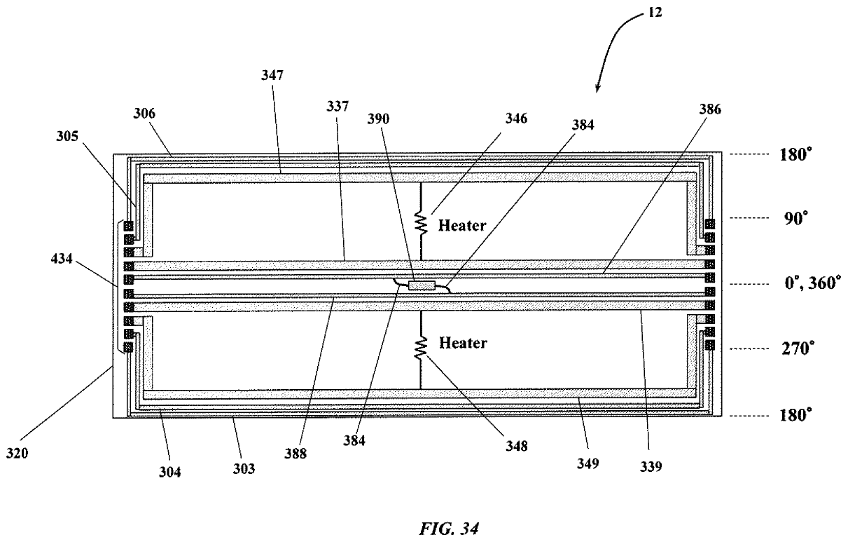

FIG. 34 illustrates another exemplary heater conduit 12 that shares many common elements with FIG. 28 and FIG. 33. In this embodiment, temperature sensor 390, temperature sensor wire leads 384, a first sensor bus 386, and a second sensor bus 388 are disposed in the gap between first power bus 337 and second power bus 339. The first sensor bus 386 and the second sensor bus 388 allow temperature sensor signals to be accessed, using the appropriate contact pads 434, from either end of heater conduit 12.

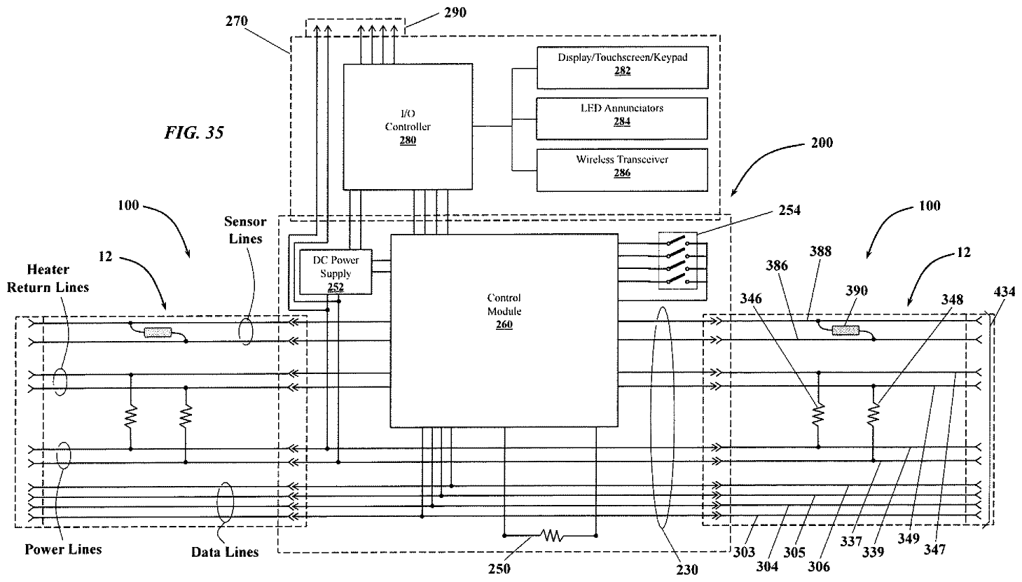

FIG. 35 illustrates a partial block diagram and partial schematic circuit diagram showing how two fluid conduit assemblies 100 cooperate electrically with multi-function clamp 200, as shown for example in FIG. 15. In this exemplary embodiment the fluid conduit assemblies 100 possess circuitry as given by heater conduit 12 (described in detail in FIG. 34). An array of contact pads 434 on each fluid conduit assembly 100 engage the wires 230 inside of multi-function clamp 200. Once again, connection of the wires 230 is facilitated by installation of the multi-function clamp and does not require a separate wiring step. A DC power supply 252 communicates electrically with and derives power from the first power bus 337 and the second power bus 339. The DC power supply 252 converts the incoming power into an appropriate DC output suitable for energizing the control module 260 and an I/O controller 280 located in the external chassis 270. The control module 260 may include a processor and a memory configured to store a set of programmed instructions that when executed by the processor perform a set of functions including but not limited to: receiving temperature signals from temperature sensor 390; supplying controlled power to first heater 346 and second heater 348 in response to the temperature signals from temperature sensor 390 to achieve a desired temperature in the fluid conduit assemblies 100; monitoring data signals on data lines 303, 304, 305, and 306; taking responsive actions depending on the data signals received from data lines 303, 304, 305, and 306 in accordance with pre-programmed instructions stored, for example, in the memory of the control module 260; outputting data signals to data lines 303, 304, 305, and 306 according to a predetermined information protocol; supplying power to internal heater 250 to achieve a desired temperature within the multi-function clamp 200; and directing the function of the I/O controller 280, by way of example only.

Although depicted in FIG. 35 as residing within the body of multi-function clamp 200, for thermal reasons the control module 260 may alternatively be located within the external chassis 270. The I/O controller 280 communicates with (and as depicted in FIG. 35 supplies power to) a variety of devices including but not limited to a display/touchscreen/keypad 282, a set of LED annunciators 284, a wireless transceiver 286, and a receptacle 290 that mates with an external multi-pin cable (not shown). The display/touchscreen/keypad 282 allows human operators to interact with multi-function clamp 200. The LED annunciators 284 provide visual indications of various states, as suitable for the given application. The wireless transceiver 286 may communicate with other multi-function clamps and other external devices. As depicted in the present embodiment, receptacle 290 contains contact points for the power lines and the data lines. The multi-function clamp 200 may be one of many such multi-function clamps in a fluid transport system. The multi-function clamp 200 may be given a unique identifier that can be recognized by all the multi-function clamps, as well as any other external devices that are contained within or communicate with the fluid transport system. In one embodiment, depicted in FIG. 35, the unique identifier is a binary number formed by opening or closing switches in an address array 254. The address array 254 may be a physical DIP switch mounted in such a way as to be accessible to human manipulation, or a set of memory addresses in the control module 260 that can be externally programmed, or any other method known in the art for giving electronic components unique electronic signal identifiers.

### Example of Fluid Conduit Assembly

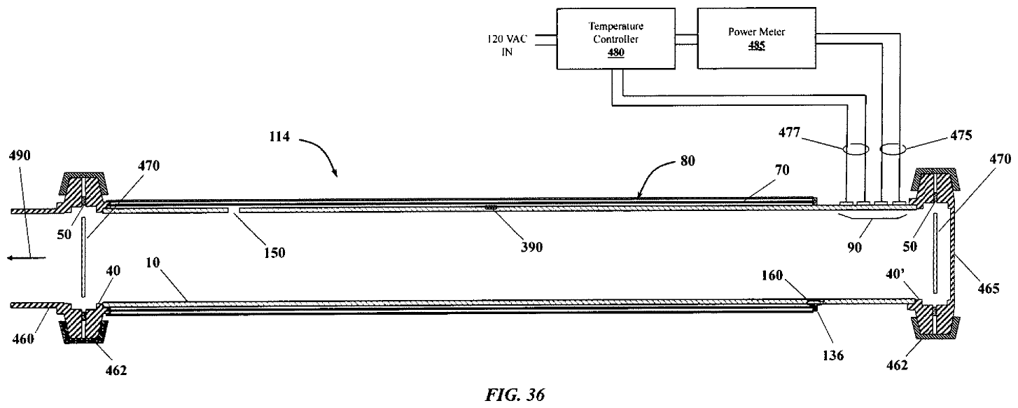

A fluid conduit assembly 114 according to the methods of the present technology was constructed and tested. The device and testing methodology are shown and described with respect to FIG. 36. In this example, the heater conduit 10 was formed from a 14″ long section of commercial 304 stainless steel tubing with an outer diameter of 1.5″ and a wall thickness of 0.065″. A thick film heater stack (not shown) was deposited using Micropen™ direct printing technology and had the layer structure shown in FIG. 4a. The dielectric, conductive, and resistive layers shown in FIG. 4a were formed by printing dielectric ink P/N 4916, conductor ink P/N 9695G, and heater ink P/N 29206, respectively, which are all cermet inks from Ferro Corporation, Mayfield Heights, Ohio. The pattern layout was equivalent to that shown in FIG. 28 except that the circuit interruptions 361 and thermal switches 380 were not present. The interconnect zone 90 contained four contact pads.

The temperature sensor 390 was a 100Ω Pt RTD (PTS0603M1B100RP100 from Vishay Beyschlag GmbH, Heide, Germany) located approximately at the centerline of the heater conduit 10 and soldered to contact pads 434 (not shown). Flanges 40 and 40′ were standard KF40 flanges (QF40-150-RF from Kurt J. Lesker Company, Jefferson Hills, Pa.) modified with flange grooves 43 (not visible). The heater conduit 10 was also provided with vacuum port 150 by drilling an approximately ⅛″ hole through the tubing wall. The inner radiation shield 70 and outer radiation shield 80 were both approximately 12″ long, formed from 26-gauge 304 stainless steel sheet having a #8 polish on one side, and rolled into a cylindrical geometry. The seam of inner radiation shield 70 was laser tack welded; while, the seam of outer radiation shield 80 was laser butt welded.

The order of steps to assemble fluid conduit assembly 114 were: (1) laser weld flange 40 to heater conduit 10, (2) slide inner radiation shield 70 over heater conduit 10, (3) slide outer radiation shield 80 over inner radiation shield 70, (4) slide a termination collar 136 over heater conduit 10 and engage both the inner radiation shield 70 and the outer radiation shield 80, (5) laser weld the outer radiation shield 80 to flange 40 and to termination collar 136, (6) form collar seal 160 by applying and curing a silicone RTV material in collar gap 138 (not visible), (7) laser weld flange 40′ to heater conduit 10.

To complete the vacuum circuit, a standard KF40 blank flange 465 (QF40-150-SB from Kurt J. Lesker Company) was sealed to flange 40′ using a sealing assembly 50 (QF40-150-SRV from Kurt J. Lesker Company) and a standard KF40 clamp 462 (QF40-150-C from Kurt J. Lesker Company). Flange 40 was similarly connected to a vacuum line 460, establishing a vacuum path 490 to a dry mechanical pump (not shown). A radiation reflector 470 was positioned in the plane of each sealing assembly 50. The radiation reflectors 470 were discs of 26-gauge #8 polish stainless steel sheet and were intended to emulate the effects of fluid conduit assembly 114 being connected at each end with identical units. The regions around flange 40 and 40′ were insulated (not shown) to prevent parasitic heat loss.

To complete the electrical circuit, two of the contact pads in interconnect zone 90 were connected to a pair of power lines 475; the other two contact pads were connected to a set of sensor lines 477. The power lines 475 and sensor lines 477 were connected to a temperature controller 480 (Micromega Model CN77353 from Omega Engineering, Inc., Norwalk, Conn.). Standard 120 VAC was supplied to the temperature controller 480 and power to fluid conduit 114 was directed through a power meter 485 (Model P3 from Kill A Watt® EZ) so that power consumption could be measured.

Fluid conduit assembly 114 was tested by first evacuating its internal passageway with the vacuum pump to a pressure of approximately 1 mT. Next, fluid conduit assembly 114 was energized by turning on the temperature controller 480 and allowing time for fluid conduit assembly 114 to equilibrate at the desired temperature. At this point the power meter 485 was initiated and a timed test started. When fluid conduit assembly 114 was operated at 120° C., the power consumption was 6.2 W and the exterior temperature of outer radiation shield 80 was approximately 24° C. When fluid conduit assembly 114 was operated at 210° C., the power consumption was 14.9 W and the exterior temperature of outer radiation shield 80 was approximately 34° C.

Using the methods of the present technology, the design principles embodied in fluid conduit assembly 100 can be extended to fluid conduit assemblies having a wide variety of different geometries and functions. Throughout the remainder of this Detailed Description it should be understood that all “heater conduits” or “bodies” include a fluid conduit and an appropriate set of thick film layers even if the thick film layers are not mentioned or depicted in an accompanying drawing.

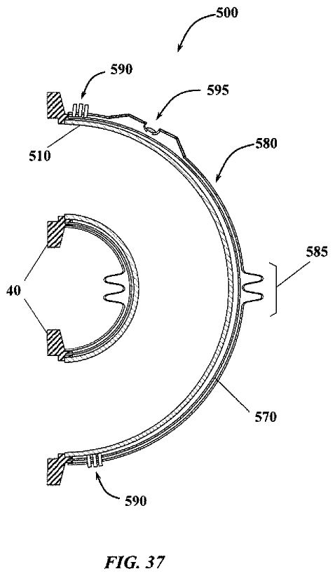

FIG. 37 illustrates a U-shaped fluid conduit assembly 500 that may employ the present technology. The U-shaped fluid conduit assembly 500 is constructed on a U-shaped heater conduit 510 comprising a U-shaped tube with an appropriate thick film layer stack (not shown). Flanges 40 are fixed to U-shaped heater conduit 510 and an expansion zone 585 for U-shaped conduit assembly 500 is provided near the midline. A U-shaped inner radiation shield 570 is provided in the form of a half-annulus. A U-shaped outer radiation shield 580 contains an interconnect zone for U-shaped conduit assembly 590 and a vacuum sealing zone 595 for U-shaped conduit assembly 500. The details of the interconnect zone 590 and vacuum sealing zone 595 follow from the discussion of the fluid conduit assembly 100 as described above with respect to FIG. 6 and are not repeated here.

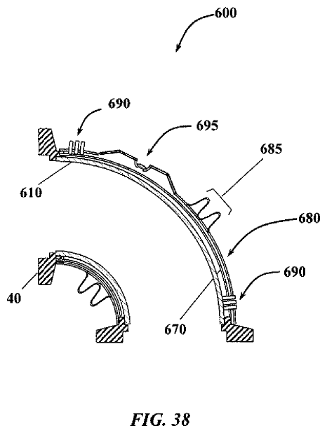

In a similar extension of the methods of the present technology, FIG. 38 shows a fluid conduit assembly in the form of an elbow assembly 600. Constructed on an elbow heater conduit 610, the elbow assembly 600 incorporates an elbow expansion zone 685, an elbow inner radiation shield 670 and an elbow outer radiation shield 680 that includes an interconnect zone 690 for elbow assembly 600 and a vacuum sealing 695 zone for elbow assembly 600. The elbow heater conduit 610 has an appropriate thick film layer stack (not shown) disposed on its external surface. The details of the interconnect zone 690 and vacuum sealing zone 695 follow from the discussion of the fluid conduit assembly 100 as described above with respect to FIG. 6 and are not repeated here.

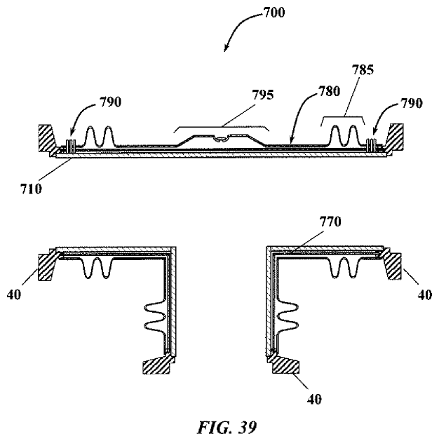

In yet another extension of the methods of the present technology, FIG. 39 illustrates a fluid conduit assembly in the form of a tee assembly 700. Constructed on a tee heater conduit 710, the tee assembly 700 incorporates a tee expansion zone 785 near each flange 40, a tee inner radiation shield 770, and a tee outer radiation shield 780 that includes a tee assembly interconnect zone 790 and a vacuum sealing zone 795 for tee assembly 700. The tee heater conduit 710 has an appropriate thick film layer stack (not shown) disposed on its external surface. The details of the interconnect zone 790 and vacuum sealing zone 795 follow from the discussion of the fluid conduit assembly 100 as described above with respect to FIG. 6 and are not repeated here.

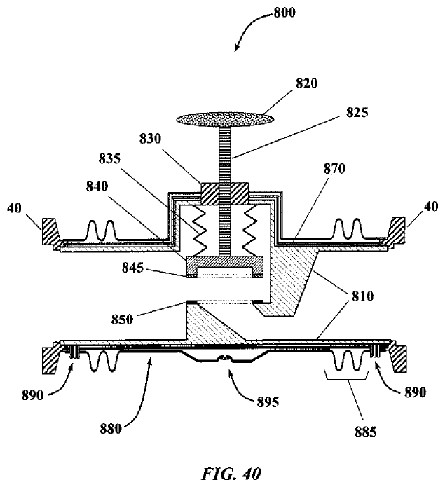

In yet another extension of the methods of the present technology, FIG. 40 illustrates a fluid conduit assembly in the form of a heated valve 800. As those skilled in the art will appreciate, fluidic valves come in a wide range of sizes, designs, construction principles, actuation methods, and geometries. By way of example but not limitation, heated valve 800 is shown as a manual, bellows-sealed, in-line valve suitable for vacuum applications. The equivalent of a heater conduit for heated valve 800 is a valve body 810 that is attached to flanges 40. A thick film layer stack (not shown) is disposed on the exterior surface of valve body 810. Heated valve 800 is further comprised of a valve handle 820, a valve stem 825, a valve bonnet 830, a bellows 835, a valve disc 840 that supports a valve seal 845, and a valve seat 850. The heated valve 800 incorporates a valve expansion zone 885 near each flange 40, a valve inner radiation shield 870, and a valve outer radiation shield 880 that includes a valve interconnect zone 890 and a valve vacuum sealing zone 895. To reduce heat losses, the valve stem 825 and the valve bonnet 830 may be constructed of a low thermal conductivity material such as ceramic.

In yet another extension of the methods of the present technology, FIG. 41 illustrates a fluid conduit assembly in the form of a blind flange 900. As those skilled in the art will appreciate, blind flanges are a critical fluidic component to prevent fluid flow through unused ports. Following the methods of the present technology, the equivalent of a heater conduit for blind flange 900 is a blind flange body 910 that is attached to flange 40. A thick film layer stack (not shown) is disposed on the exterior surface of blind flange body 910. The blind flange 900 incorporates a blind flange inner radiation shield 970, and a blind flange outer radiation shield 980 that includes a blind flange interconnect zone 990 and a blind flange vacuum sealing zone 995. Because of its compact form factor, the blind flange 900 is unlikely to require a thermal stress relief mechanism.

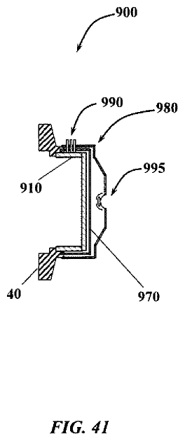

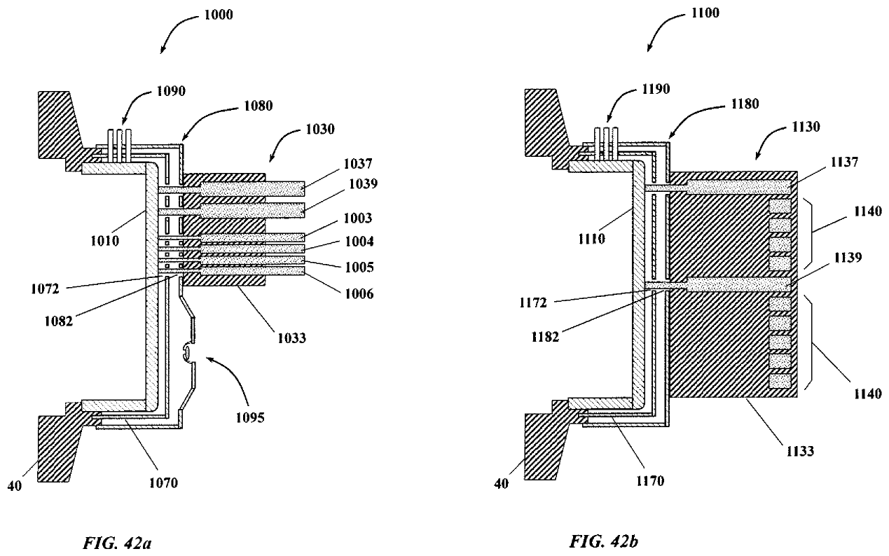

In another extension of the methods of the present technology, FIG. 42a illustrates a fluid conduit assembly in the form of a power/data flange 1000. The equivalent of a heater conduit for power/data flange 1000 is a power/data flange body 1010 that is cup-shaped and attached to flange 40. A thick film layer stack (not shown) is disposed on the exterior surface of power/data flange body 1010. The power/data flange 1000 incorporates a power/data flange inner radiation shield 1070, and a power/data flange outer radiation shield 1080 that includes a power/data flange interconnect zone 1090 and a power/data flange vacuum sealing zone 1095. Because of its compact form factor, the power/data flange 1000 is unlikely to require a thermal stress relief mechanism. The thick film layer stack (not shown) is configured to create conductive traces between the individual pins of the power/data flange interconnect zone 1090 and a set of corresponding pins in a power/data flange connector 1030. By way of example but not of limitation, the power/data flange connector 1030 depicted in FIG. 42a has six connector pins having a first power pin 1037, a second power pin 1039, a first data pin 1003, a second data pin 1004, a third date pin 1005, and a fourth data pin 1006. The power pins 1037 and 1039 may be of a heavier gauge than the data pins 1003-1006 because of the need to carry larger electrical currents. The power pins 1037 and 1039 and data pins 1003-1006 pass through a set of power/data flange inner via holes 1072 in the power/data flange inner radiation shield 1070 and a set of power/data flange outer via holes 1082 in the power/data flange outer radiation shield 1080 and are connected to the appropriate contact pads (not shown) in the thick film layer stack. The power/data flange connector 1030 mates with an external cable (not shown) that facilitates electrical communication between the individual circuits of power/data flange 1000 and one or more external devices. To continue the example without limitation, and with reference to both FIG. 34 and FIG. 35, in a fluid transport system that contains fluid conduit assembly 100 of FIG. 35 and power/data flange 1000, the following elements would be in electrical communication: first power bus 337 with first power pin 1037, second power bus 339 with second power pin 1039, first data line 303 with first data pin 1003, second data line 304 with second data pin 1004, third data line 305 with third data pin 1005, and fourth data line 306 with fourth data pin 1003.

In yet another extension of the methods of the present technology, FIG. 42b shows a fluid conduit assembly in the form of an inductive power flange 1100, which shares many common elements with the power/data flange 1000 of FIG. 42a (like numerals are used for like elements). Inductive power flange 1100 is constructed on an inductive power flange body 1110 that is joined to flange 40 and surrounded by an inductive power flange inner radiation shield 1170 and an inductive power flange outer radiation shield 1180. The inductive power flange outer radiation shield 1180 includes an inductive power flange interconnect zone 1190. An inductive power flange connector 1130 is mounted to the inductive power flange outer radiation shield 1180 and includes an inductive power flange connector body 1133, a first inductive power pin 1137, a second inductive power pin 1139, and a flat helical inductor coil 1140 whose multiple turns are seen in cross-section in FIG. 42b. The inductive power flange connector 1130 is configured to mate with a power cable (not shown).

In operation, the flat helical inductor coil 1140 inductively receives power from the power cable (not shown) which is then transferred through the first inductive power pin 1137 and the second inductive power pin 1139 to the thick film circuitry (not shown) disposed on the exterior surface of the inductive power flange body 1110 which communicates the power to the inductive power flange interconnect zone 1190. The power pins 1137 and 1139 pass through a set of inductive power flange inner via holes 1172 in the inductive power flange inner radiation shield 1170 and a set of inductive power flange outer via holes 1182 in the inductive power flange outer radiation shield 1080. The material for the inductive power flange connector 1130 is selected to be electrically insulating and durable, such as a moldable polymer such as polycarbonate. The first and second power pins 1137 and 1139 along with the flat helical inductor coil 1140 are, in one example, made of a high conductivity metal such as copper. Because of its compact form factor, the inductive power flange 1100 is unlikely to require a thermal stress relief mechanism. For clarity, neither a vacuum sealing zone nor means to transfer data signals are shown in FIG. 42b, although both could be included using methods previously described.

It will be appreciated by those skilled in the art that the methods of the present technology can be extended to other fluidic components including, but without limitation, plumbing fittings such as wyes, crosses, reducers, adaptors, unions, couplings, and transitions between standards or custom designs; and active fluidic devices such as pumps, pressure regulators, filters, and sensors. It will also be appreciated by those skilled in the art that the various fluid conduit assemblies taught and enabled by the methods of the present technology can be combined in an endless number of ways to create fluid transport systems useful to achieving a desired function.

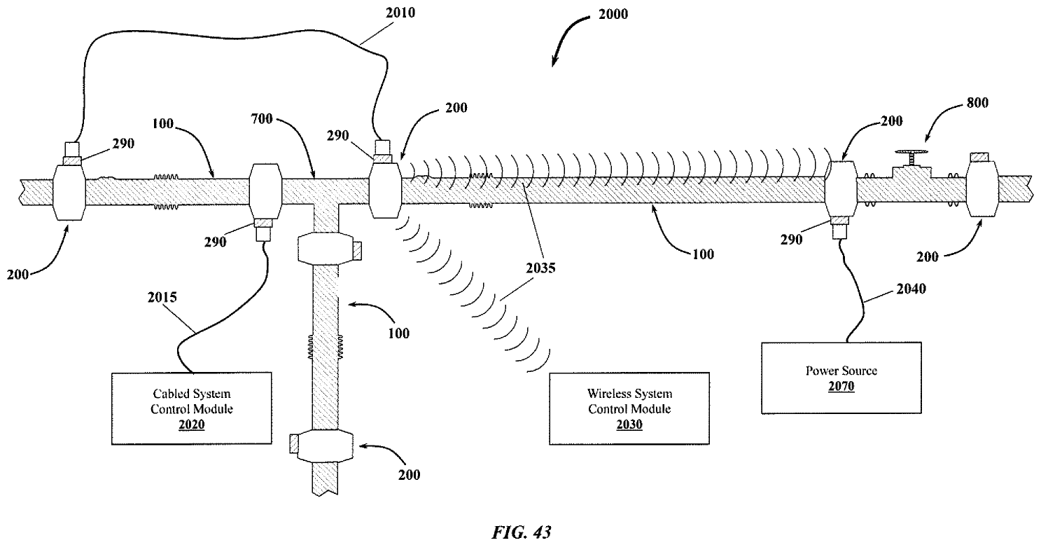

FIG. 43 illustrates an exemplary fluid transport system 2000 of the present technology. In this example, several fluid conduit assemblies 100 of varying lengths along with a tee assembly 700 and a heated valve 800 are connected into a fluidic circuit, each using multi-function clamps 200, although other fluidic components in other combinations could be used in fluid transport system 2000. The multi-function clamps 200 advantageously allow the components to be connected both physically and electrically in a single step. Temperature control and monitoring are achieved using one or more of the following: the multi-function clamps 200, a cabled system control module 2020, and/or a wireless system control module 2030. The multi-function clamps 200 communicate with the cabled system control module 2020 via a control cable 2015 through receptacle 290. The multi-function clamps 200 can also communicate with each other via an inter-clamp cable 2010 plugged into receptacles 290. In addition, the multi-function clamps 200 can communicate with each other or with a wireless system control module 2030 via a wireless signal 2035. Various wireless communication protocols may be employed. Power can be applied to fluid transport system 2000 by a power source 2070 connected to multi-function clamp 200 via a power cable 2040 mated to receptacle 290. The functions of controlling, monitoring, and powering the fluid transport system 2000 could also be provided by a single piece of equipment connected to any of the multi-function clamps 200 by a suitable cable (not shown).

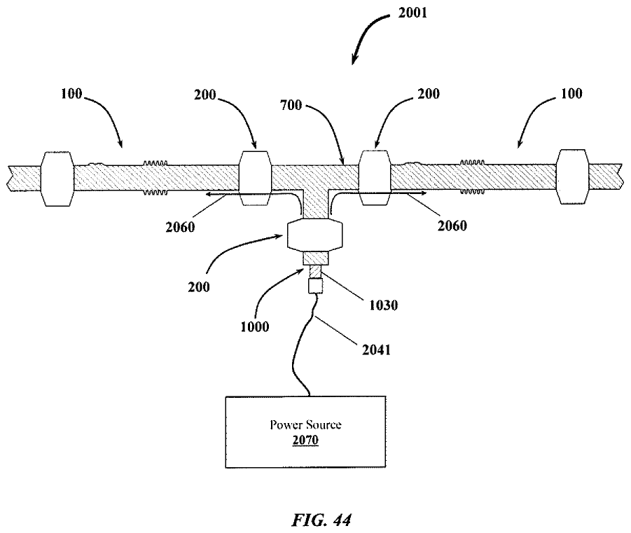

In one embodiment of the present technology, electrical power distribution in a fluid transport system 2001 is achieved via the power/data flange 1000, as shown in FIG. 44. The power/data flange 1000 mates to the multi-function clamp 200 attached to the central leg of a tee assembly 700, for example. The power buses contained within the fluidic components (for example, the first power bus 337 and the second power bus 339—not shown) create power propagation 2060 that flows through tee assembly 700 and into the fluidic circuits attached to the arms of the tee assembly 700. Electric power is provided by power source 2070 and conveyed to the power/data flange 1000 via a power cable 2014 plugged into power/data flange connector 1030. Note that the power cable 2041 could also contain additional wires to communicate with data lines (for example, first data line 303, second data line 304, third data line 305, and fourth data line 306—not shown). The advantage of the power distribution scheme of fluid transport system 2001 is that, for a given allowed voltage drop, power can be distributed over twice the distance as compared to an equivalent system where power is introduced at one of the terminal ends.

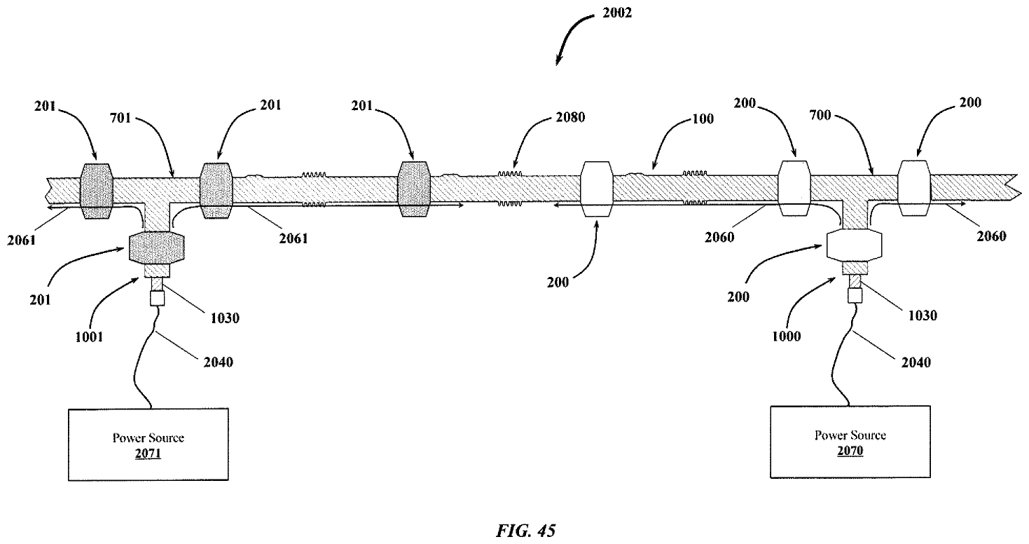

FIG. 45 illustrates a fluid transport system 2002 that can have such a long overall length that it is desirable to introduce power in at least two separate distribution locations. In fluid transport system 2002 power source 2070 supplies power via power cable 2040 to a section of the fluid transport system 2002 indicated by power propagation 2060. This section includes power/data flange 1000, tee assembly 700, fluid conduit assembly 100, multi-function clamps 200, and other components (not fully shown). A second power source 2071 supplies power via power cable 2040 to a different section of the fluid transport system 2002 indicated by power propagation 2061. This different section includes second power/data flange 1001, second tee assembly 701, second fluid conduit assembly 101, a set of marked multi-function clamps 201, and other components (not fully shown). An interrupter fluid conduit assembly 2080 is provided to prevent power source 2070 and power source 2071 from interacting. The interrupter fluid conduit assembly 2080 contains separate heaters, one energized by power source 2070 and the other by power source 2071, which are electrically isolated. The marked multi-function clamps 201 include one or more identification means that allow them to be readily distinguished (for example, from multi-function clamps 200) by human operators and electronic systems. Such identification means create a rapid understanding of which sections of fluid transport system 2002 are energized by which power sources and may include color coding, LED signals, electronic addresses, or any other method known in the art.

FIG. 46 illustrates additional detail of the construction of interrupter fluid conduit assembly 2080 shown in FIG. 45. In this exemplary embodiment, FIG. 46 shares common elements with FIG. 24. Interrupter fluid conduit assembly 2082 is provided with a heater conduit 13 where the thick film layer stack is modified with a first interrupter power bus 2082 and a second interrupter power bus 2084 that possess a break that prevents power from traveling from one end of heater conduit 13 to the other end. A first interrupter helical heater trace 2086 and a second interrupter helical heater trace 2088 are disposed such that they are addressable by contact pads 434 from opposite ends of heater conduit 13. It will be apparent to one skilled in the art that other heater trace layouts may also be employed.

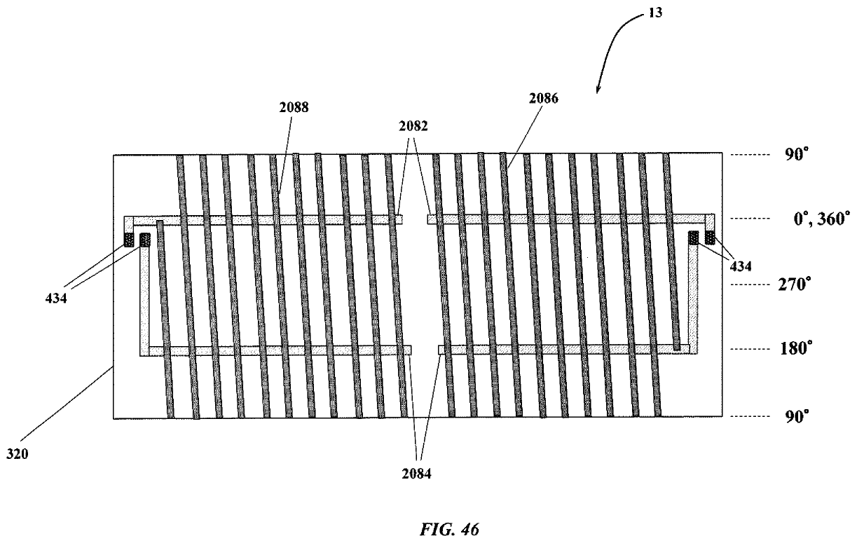

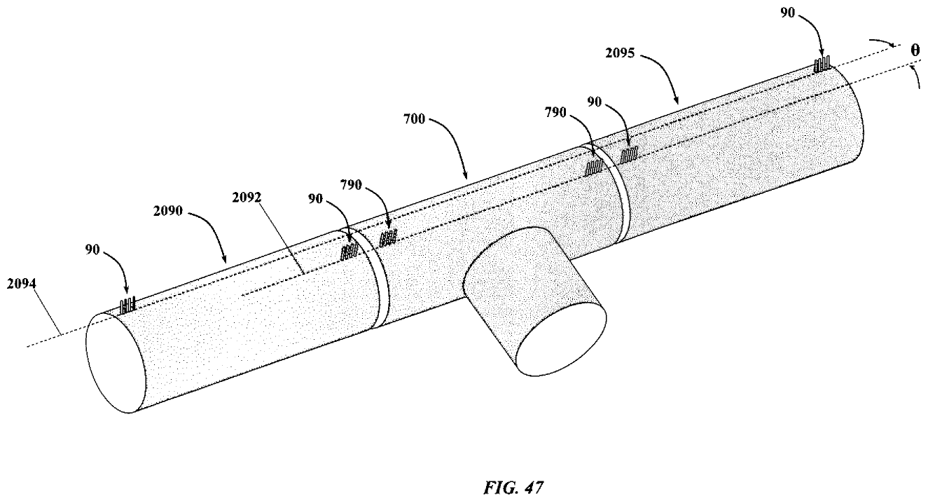

Yet another aspect of the present technology allows for fluid transport systems with complex orientations, as shown in FIG. 47. In this exemplary embodiment tee assembly 700 is oriented with its tee assembly interconnect zones 790 aligned parallel to a first axis 2092 in contrast to other components in the system which have a natural alignment of their interconnect zones to a second axis 2094. Note that for clarity all flanges, welds, and multi-function clamps have been omitted but may be employed as described in the examples herein. The angular displacement between first axis 2092 and second axis 2094 is designated as 0. Using the methods of the present technology a first angular adaptor 2090 and a second angular adaptor 2095 are provided to reconcile the angular deviation.

FIG. 48 illustrates the construction details of first angular adaptor 2090 according to one embodiment of the present technology, and shares common elements with FIG. 24 (like numerals are employed for like elements). First angular adaptor 2090 is provided with a heater conduit 14 where the angular displacement between the opposing contact pads 434, i.e., the same 0 as in FIG. 47, is accommodated using a first displaced power bus 2102 and a second displaced power bus 2104. Second angular adaptor 2095 is a mirror assembly to first angular adaptor 2090 and its construction details are omitted here. To facilitate the construction of complex systems, a variety of angular adaptors may be stocked with a set of standard angular offset values. By way of example but not limitation, one set of standard angular offset values could be 22.5°, 45°, 67.5°, 90°, 112.5°, 135°, 157.5°, and 180°.

FIG. 49 illustrates another embodiment of the present technology that shares common elements with FIG. 24, in which electrical power is conveyed across a heater conduit 15 by a first ring power bus 402 and a second ring power bus 406. First ring power bus 402 is terminated at each end by a first contact ring 404 that completely encircles the heater conduit 15. Second ring power bus 406 is terminated at each end by a second contact ring 408 that encircles the heater conduit 15 except for a gap to avoid shorting to the first ring power bus 402. The first and second contact rings 404 and 408 permit electrical communication with an alternative clamp design (not shown herein) that has a high degree of insensitivity to angular positioning.

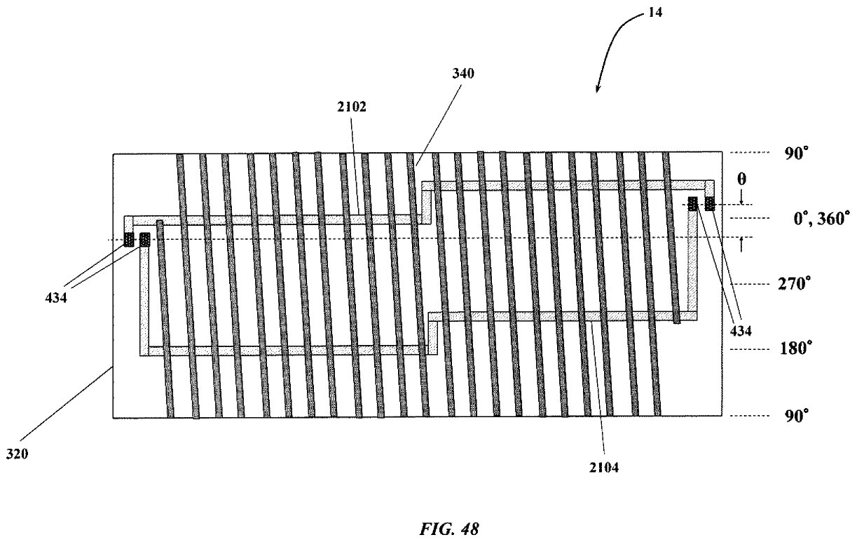

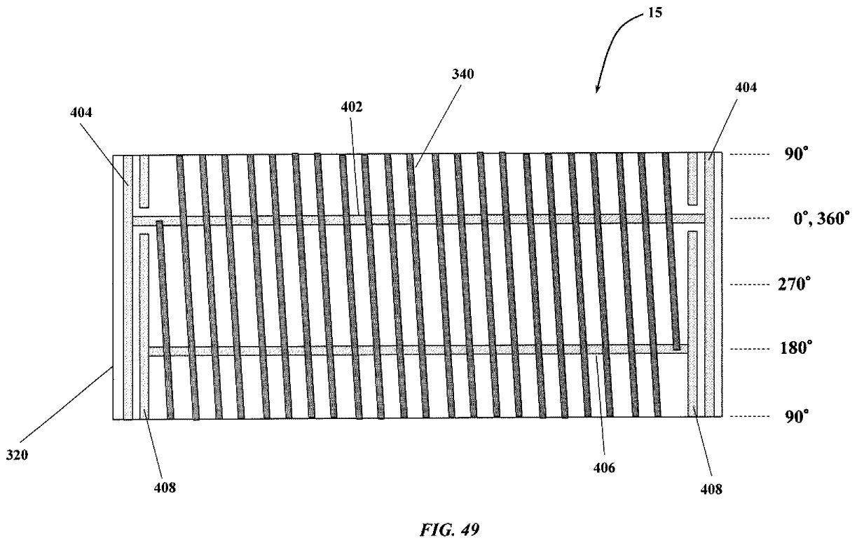

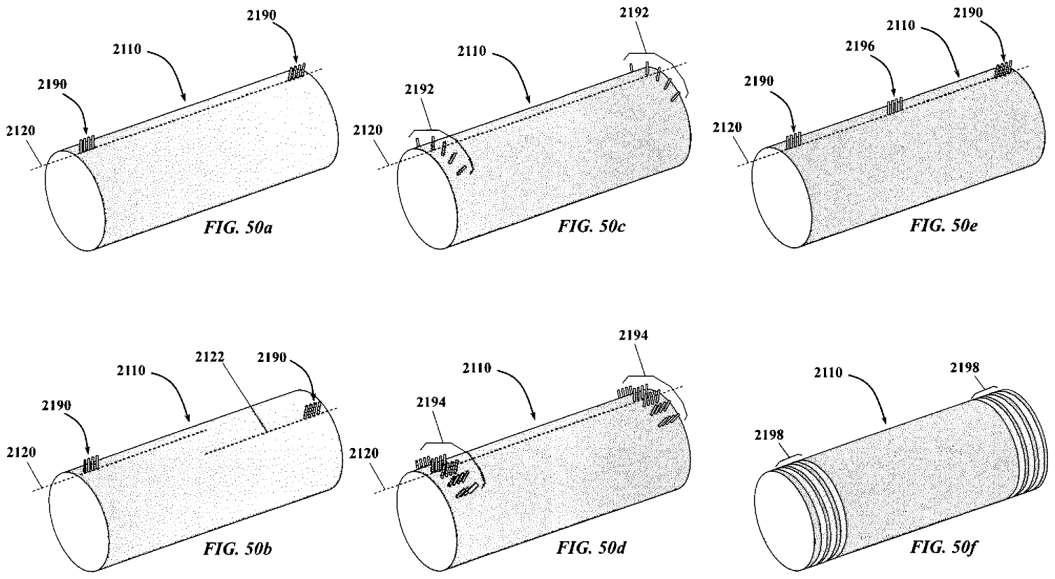

As has already been described in various exemplary embodiments of the present technology, the contacting surfaces of any of the fluid conduit assemblies of the present technology can take multiple forms including contact pins 38 (e.g., FIG. 7 and FIG. 8), contact pads for heater traces 432 and contact pads for conductive traces 434 (e.g., FIG. 17a), and first and second contact rings 404 and 408 (e.g., FIG. 49). The form and layout of the contacting surfaces of a fluid conduit assembly are important design factors since they must cooperate with whatever multi-function clamp is used to create consistent and reliable electrical connections. Further description of the arrangement of contacting surfaces is given with reference to FIGS. 50a through 50f.

In FIG. 50a a fluid conduit assembly 2110 is provided with a set of contacting surfaces 2190 near each end. Although schematically shown as pins in FIG. 50a, the contacting surfaces 2190 could also be in the form of contact pads or any other geometry that will facilitate electrical connections with the cooperating multi-function clamp, such as multi-function clamp 200 shown in FIG. 15. As depicted in FIG. 50a the two sets of contacting surfaces 2190 are substantially co-linear and arrayed along a line 2120, which is parallel to the longitudinal axis of the fluidic conduit assembly 2110. Alternatively, the two sets of contacting surfaces 2190 can be offset in the manner depicted in FIG. 50b, where the left set of contacting surfaces 2190 are disposed along line 2120 and the right set of contacting surfaces 2190 are arrayed along an offset line 2122. In another configuration, shown in FIG. 50c, a set of contacting surfaces 2192 is disposed circumferentially near each end of fluid conduit assembly 2110. In yet another configuration, shown in FIG. 50d, an array of contacting surfaces 2194 is disposed both longitudinally and circumferentially near each end of fluid conduit assembly 2110. As already described, the purpose of contacting surfaces near the ends of a fluid conduit assembly is generally to cooperate with multi-function clamps to facilitate electrical communication between the fluid conduit assembly and the multi-function clamps, and to allow connection of the fluid conduit assemblies using the multi-function clamps in a single connection step. However, the fluid conduit assembly is not limited to communicating electrically solely with multi-function clamps. In FIG. 50e fluid conduit assembly 2110 has an additional set of contacting surfaces 2196 located away from the ends of fluid conduit assembly 2110. The additional set of contacting surfaces 2196 may be located roughly along the midline of fluid conduit assembly 2110 and co-linear with contacting surfaces 2190, as depicted in FIG. 50e. However, the exact longitudinal and circumferential positioning of the additional set of contacting surfaces 2196 is limited only by physical dimensions and suitability for its purpose, which will be discussed further below. In yet another configuration the contacting surfaces may be a set of contacting bands 2198 disposed near each end of the fluid conduit assembly 2110, as shown in FIG. 50f. The set of contacting bands 2198 may contain any number of individual bands limited only by physical dimensions and required number of communicating electrical circuits. The set of contacting bands 2198 may include individual bands that fully or partially encircle the fluidic conduit assembly 2110.

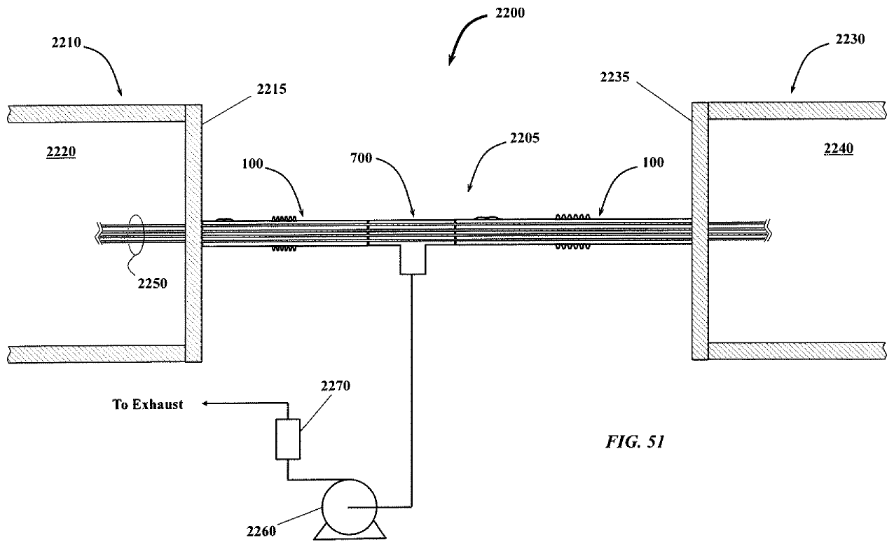

In another embodiment of the present technology, FIG. 51 illustrates a heated gas line manifold 2200 that is suitable for maintaining a set of one or more gas lines 2250 at a desired temperature as it exits a gas source enclosure 2210 and enters a gas distribution enclosure 2230. The gas source enclosure 2210 contains a source bulkhead 2215 and a gas source interior 2220 that houses the equipment (e.g., compressed gas bottles, pressure regulators, etc.—not shown) necessary to charge the gas lines 2250 with their desired materials. The gas distribution enclosure 2230 contains a distribution bulkhead 2235 and a gas distribution interior 2240 that houses the equipment (e.g., gas flow rate meters, process reactors, etc.—not shown) that consumes the material supplied by the gas lines 2250. The gas lines 2250 are contained within a fluid transport system 2205 as they pass from the gas source enclosure 2210 to the gas distribution enclosure 2230. The fluid transport system 2205 is set to operate at a temperature that will maintain the materials in the gas lines 2250 in a suitable state. The fluid transport system 2205 includes, in this exemplary embodiment, fluid conduit assemblies 100 and tee assembly 700, although other components could be included. In a typical installation, the fluid conduit assemblies 100 would be hermetically sealed at their respective bulkheads and the gas lines 2250 would also be hermetically sealed at the bulkheads. That is, the interior passageways of fluid transport system 2205 would be prevented from having any fluid communication with either the gas source interior 2220 or the gas distribution interior 2240. Additionally, the center leg of tee assembly 700 would be connected to a pump 2260 whose exhaust would pass through a gas sensor 2270 and thereafter to a suitable exhaust line. The pump 2260 maintains a sub-ambient pressure in the fluid transport system 2205. The gas sensor 2270 would be configured to detect any gas leakage occurring from the portion of the gas lines 2250 residing inside the fluid transport system 2205 and then to take appropriate actions such as issuing an alarm and initiating a shutdown of gas flow.

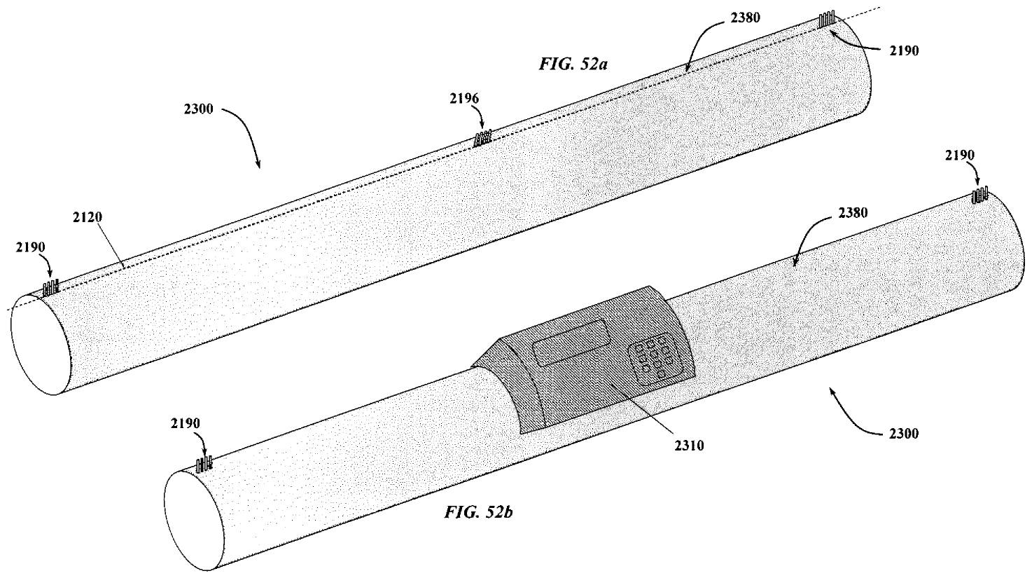

Returning to the additional set of contacting surfaces 2196, FIG. 50e is reproduced in FIG. 52a to facilitate the discussion. The additional set of contacting surfaces 2196 provides access to the power buses, the heater traces, the data lines, and the temperature sensor signals present on the heater conduit (not visible) of fluid conduit assembly 2300. This allows the construction of a control console 2310, shown in FIG. 52b, that communicates electrically with the additional set of contacting surfaces 2196. The control console 2310 is affixed to an outer radiation shield 2380 of the fluid conduit assembly 2300. The control console 2310 may at least contain and perform all the functions of a multi-function clamp as described herein.

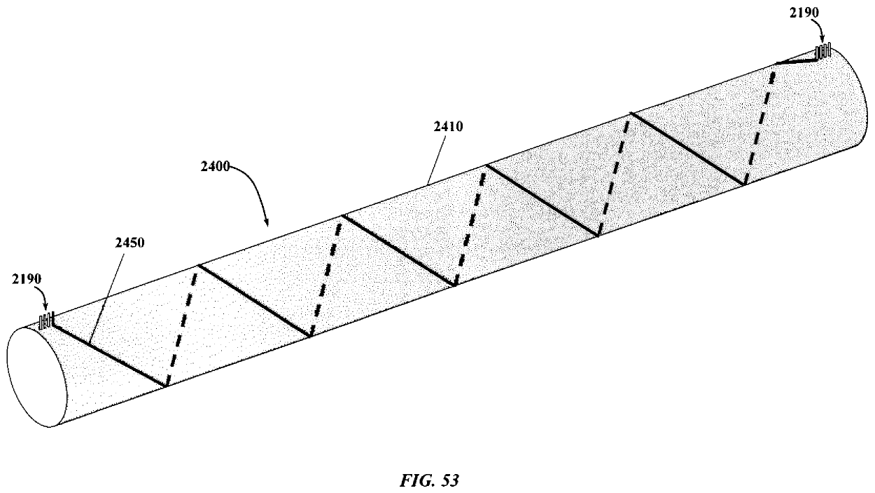

FIG. 53 shows a fluid conduit assembly 2400, wherein heating is provided by a heater wire 2450 wrapped around the heater conduit 2410. The heater wire 2450 is connected to and communicates electrically with the set of contacting surfaces 2190. The heater wire 2450 can be of any appropriate resistive construction well known in the art including but not limited to resistive wires, cables, foils, and mats. Any insulating components of heater wire 2450 should be constructed of materials appropriate for the intended temperature range of use.

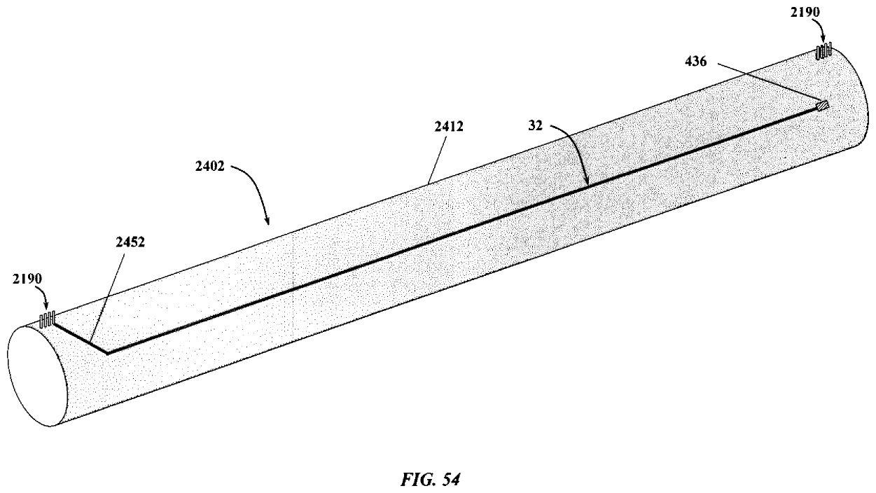

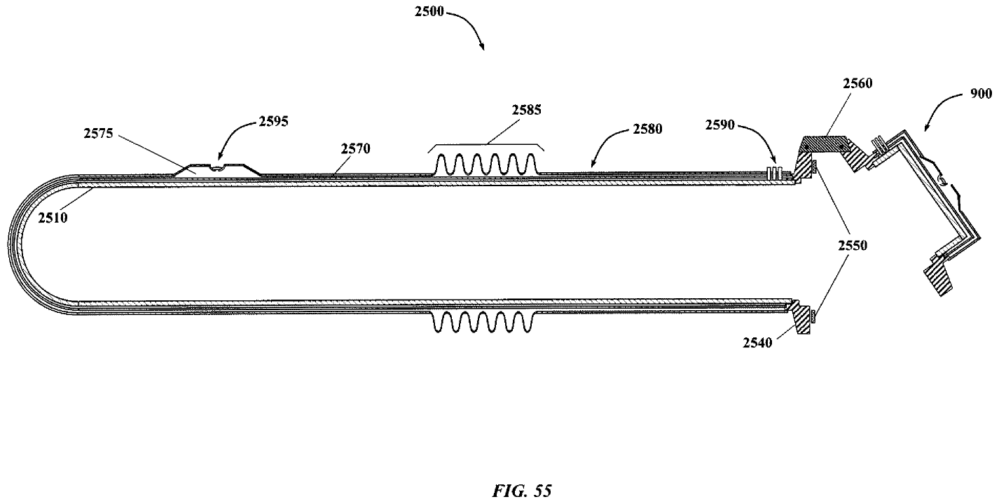

FIG. 54 illustrates a partial fluid conduit assembly 2402, wherein heating is provided by a skin effect conductor 2452 that is connected at one set of contacting surfaces 2190, extended along the exterior surface of heater conduit 2412, and placed in electrical communication with the heater conduit 2412 at the contact site 436. The skin effect conductor 2452 can be formed by the thick film layer stack 32 described in detail in FIG. 4c. Alternatively, skin effect conductor 2452 can be a single conductor wire with an insulating jacket constructed of materials appropriate for the intended temperature range of use. In this embodiment, the heater conduit 2412 must be constructed on a ferromagnetic material and the power source must provide an AC current of suitable frequency. While only one skin effect conductor 2452 is depicted in FIG. 54, more than one may be employed.

FIG. 55 illustrates an oven 2500 that employs the present technology. The oven 2500 is fabricated using an oven body 2510 having the form of a fluid conduit with one closed end. The oven 2500 is surrounded by an oven inner radiation shield 2570 that is in turn surrounded by an oven outer radiation shield 2580 containing an oven expansion zone 2585 and an oven vacuum sealing zone 2595. The oven vacuum sealing zone 2595 is used to form an oven vacuum space 2575 that provides a high degree of thermal insulation, making oven 2500 energy efficient. The open end of the oven body 2510 is attached to an oven flange 2540. An oven interconnect zone 2590 is located near the oven flange 2540. An oven hinge 2560 allows the blank flange 900 to be swung into positional relationship with an oven sealing assembly 2550 and oven flange 2540 to create a hermetic seal when a multi-function clamp (not shown) is applied. One or more small ports (not shown) may be supplied to oven 2500 to allow for expanding hot gases to exit and for controlled gas compositions to be introduced. The multi-function clamp (not shown) can be used to power the oven 2500 and control its internal temperature.

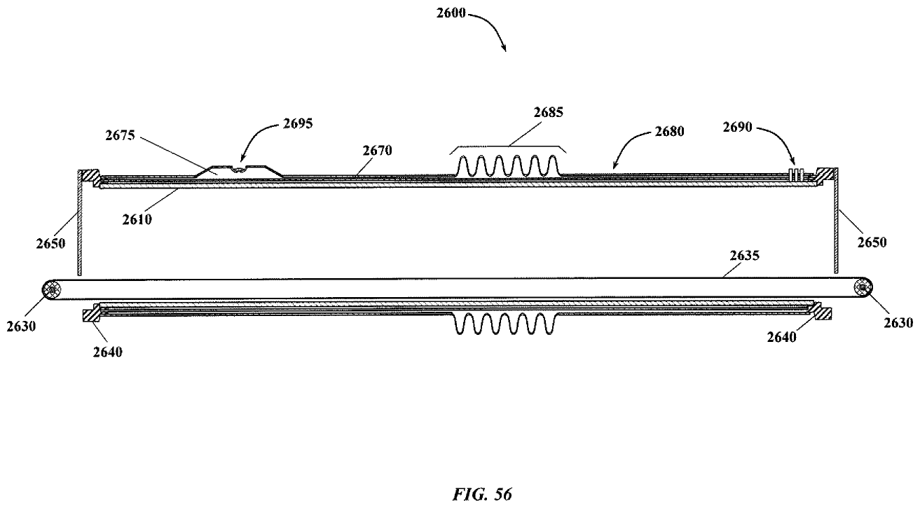

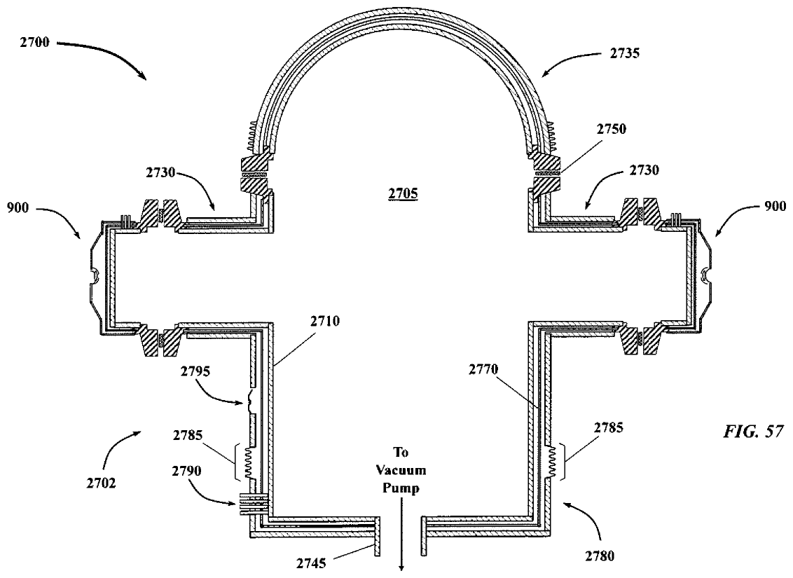

FIG. 56 illustrates a conveyor oven 2600 that employs the present technology. The conveyor oven 2600 is fabricated using a conveyor oven body 2610 having the form of a straight fluid conduit of the general form shown in FIGS. 5 and 6. The conveyor oven 2600 is surrounded by a conveyor oven inner radiation shield 2670 that is in turn surrounded by a conveyor oven outer radiation shield 2680 containing a conveyor oven expansion zone 2685 and a conveyor oven vacuum sealing zone 2695. The conveyor oven vacuum sealing zone 2695 is used to form a conveyor oven vacuum space 2675 that provides a high degree of thermal insulation, making conveyor oven 2600 energy efficient. Each open end of the conveyor oven body 2610 is attached to a conveyor oven flange 2640. A conveyor oven interconnect zone 2690 is located near one or both conveyor oven flanges 2640 (only one oven interconnect zone 2690 is depicted in the figure). A conveyor oven access door 2650 is mounted on each conveyor oven flange 2640. A conveyor oven belt 2635 is driven by a pair of conveyor oven drive rollers 2630. The conveyor oven belt 2635 is configured to accept objects to be baked and transport them through the conveyor oven 2600 at a speed profile suitable to achieve the intended thermal process. The conveyor oven access doors 2650 are configured to prevent heat loss while allowing free transport of objects through the conveyor oven 2600. One or more small ports (not shown) may be supplied to conveyor oven 2600 to allow for the introduction of controlled gas compositions. A multi-function clamp (not shown) can be used to power the conveyor oven 2600 and control its internal temperature.

Yet another aspect of the present technology is the construction of heated vessels. One embodiment of the present technology of a heated vessel is a vacuum system in which the entire interior structure of the vacuum system can be heated. It is well known that the operation of a vacuum system can be improved by episodic heating of the interior. For example, after a vacuum chamber has been exposed to ambient atmosphere and then pumped down, the interior surfaces of the vacuum chamber often contain adsorbed water and other chemical species. It is advantageous to heat all the interior surfaces while pumping to drive off any adsorbed contaminants. This results in a lower base pressure and a cleaner environment within which to perform the processing operations for which the vacuum system was designed. Current methods of desorbing contaminant species include internally mounted heaters, internally mounted sources of other forms of energy such as IR or UV lamps, and externally mounted heating panels. All these methods suffer from one or more problems including added equipment and cost, unwieldy assembly and disassembly processes, incomplete desorption of contaminants, and excessively long desorption times.

An improved vacuum system 2700 constructed using the present technology is shown in FIG. 57. Since the construction follows the many embodiments described thus far, the vacuum system 2700 is described in simplified form. The vacuum system 2700 includes a vacuum chamber 2702 and a chamber lid 2735 that are sealed together during operation with a main seal 2750 and a sealing clamp (not shown), creating a chamber interior 2705 within which useful processes can be performed at reduced pressure. The vacuum chamber 2702 contains a chamber body 2710 upon whose exterior surface is deposited a thick film layer stack (not shown) that contains suitable conductive and resistive traces to obtain a variety of functions including but not limited to heating, temperature sensing, and data signal transfer, by way of example. The vacuum chamber 2702 also contains a chamber inner radiation shield 2770 and a chamber outer radiation shield 2780 that includes a chamber expansion zone 2785 and a chamber vacuum sealing zone 2795. The chamber vacuum sealing zone 2795 is used to create a vacuum space in the volume between the exterior surface of the chamber body 2710 and the interior surface of the chamber outer radiation shield 2780. A chamber interconnect zone 2790 provides contact points through which electrical communication from the exterior of the vacuum system 2700 can be made with the thick film layer stack (not shown) disposed on the chamber body 2710. The chamber lid 2735 is fabricated in a manner like that of the vacuum chamber 2702 and its details of construction are omitted here for brevity. In general, vacuum systems include other ports and plumbing connections. As an example, to assist visualization, but not by way of limitation, vacuum system 2700 is depicted with a half nipple 2730 on either side of the vacuum chamber 2702. Each half nipple 2730 is shown with a blind flange 900 with which it forms a vacuum-tight connection when sealed with the application of multi-function champs (not shown). Note that power, temperature signals and control, and data can be transmitted through the multi-function clamps (not shown). Vacuum system 2700 is also shown with a pumping port 2745 that connects to a vacuum pump (not shown) suitable to provide the desired vacuum levels of pressure.

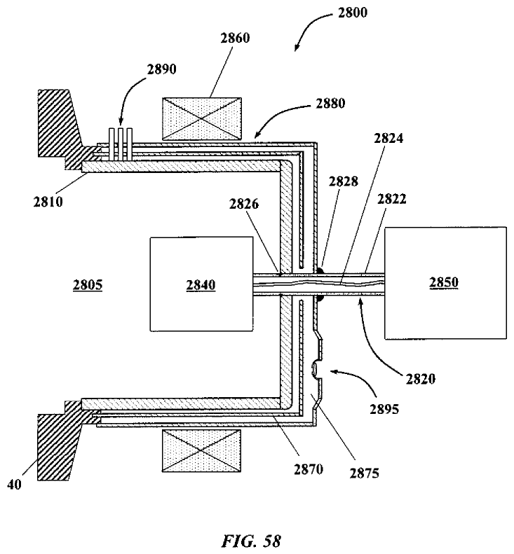

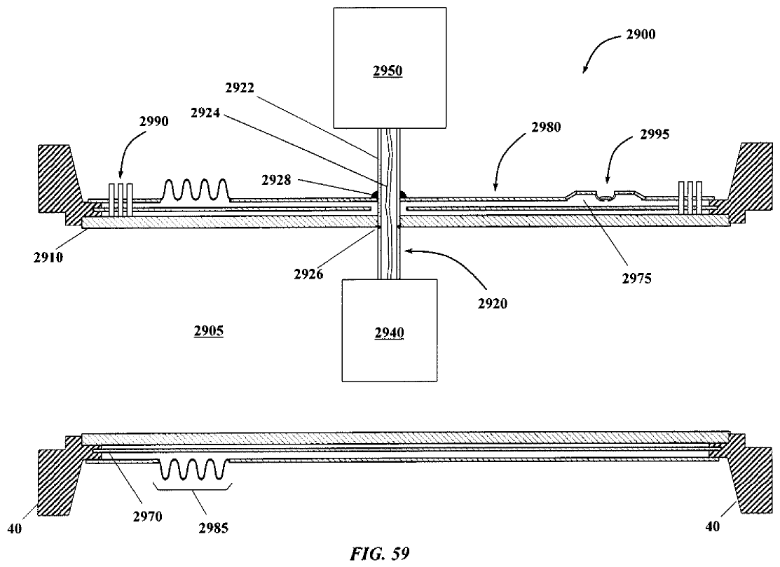

In many fluid transport systems, there is a need to sense a wide variety of physical properties and process variables in order to maintain system operation within desired limits. Many sensors have built-in electronics or other components, such as magnets, that are temperature sensitive, which limits the degree to which the sensor can be heated and still be operational. A condition may arise where the built-in electronics or other components must be disassembled and removed so that the active sensor components can be heated to a sufficiently high temperature to achieve some desirable effect. Without the electronics or other components in place, the sensor is inoperable and unable to provide useful information to the user. To advance the performance and safety of fluid transport systems, there is a need to provide sensors that can continue to operate even when they have been heated to elevated temperatures. Using the methods of the present technology, improved sensors that operate at higher temperatures can be fabricated. Two embodiments of the present technology, a blind sensor assembly 2800 and an in-line sensor assembly 2900, are herewith described with the aid of FIG. 58 and FIG. 59, respectively. Both embodiments are further examples of fluid conduit assemblies and use many of the general methods of construction discussed supra including the use of thick film layers, which are omitted from FIG. 58 and FIG. 59 for clarity.

With reference to FIG. 58, one embodiment of the blind sensor assembly 2800 is shown. The blind sensor assembly 2800 shares some general features with blind flange 900. Both can be used when there is no requirement for fluid flow through the device. Blind sensor assembly 2800 forms a portion of the boundary of an internal system volume 2805 and is constructed on a blind sensor assembly body 2810 which is attached to flange 40. The blind sensor assembly body 2810 can be substantially a flat plate or, in another embodiment as depicted in the figure, can be bowl-shape. The exterior of the blind sensor assembly body 2810 is surrounded by a blind sensor assembly inner radiation shield 2870 and a blind sensor assembly outer radiation shield 2880. The blind sensor assembly outer radiation shield 2880 contains a blind sensor assembly interconnect zone 2890 and a blind sensor assembly sealing zone 2895. The blind sensor assembly sealing zone 2895 is used to create a blind sensor assembly vacuum space 2875. Because of its compact form factor, the blind sensor assembly 2800 is depicted in FIG. 58 as not requiring a thermal stress relief mechanism, although one could be provided if necessary. The active component of blind sensor assembly 2800 is a blind sensor head 2840. The blind sensor head 2840 performs the sensing function and is connected to a blind sensor electronics module 2850 by means of a blind sensor assembly feedthrough 2820. The blind sensor assembly feedthrough 2820 includes a blind sensor assembly feedthrough tube 2822 that houses a blind sensor assembly feedthrough conductor cable 2824. The blind sensor assembly feedthrough conductor cable 2824 contains one or more individual electrical conductors (i.e., wires) connecting the blind sensor electronics module 2850 to the blind sensor head 2840. The blind sensor assembly feedthrough tube 2822 is attached to the blind sensor assembly outer radiation shield 2880 by a blind sensor assembly feedthrough air seal 2828 and is attached to the blind sensor assembly body 2810 by a blind sensor assembly feedthrough system seal 2826. The blind sensor head 2840, the blind sensor assembly feedthrough 2820, and the blind sensor electronics module 2850 are configured to maintain the hermetic integrity of the internal system volume 2805 and the blind sensor assembly vacuum space 2875. A blind sensor magnet 2860 may be incorporated in those embodiments where its magnetic field cooperates with the blind sensor head 2840 to improve sensing performance. It will be appreciated by those skilled in the art that the blind sensor head 2840 could contain a wide variety of detection mechanisms that could sense, by way of example and not limitation, pressure, temperature, viscosity, composition of matter, and/or electrical properties. It will be further appreciated by those skilled in the art that the configuration of blind sensor assembly 2800 allows the blind sensor head 2840 to operate at elevated temperature while the blind sensor electronics module 2850 and blind sensor magnet 2860 remain near the ambient temperature.

Using many of the elements of blind sensor assembly 2800 and the fluid conduit assembly 100, an in-line sensor assembly 2900 is particularly adapted to sense the flow properties of a fluid and is shown in FIG. 59. The in-line sensor assembly 2900 forms a portion of the boundary of an internal system volume 2905 and is constructed on an in-line sensor assembly body 2910 that is attached to flange 40. The exterior of the in-line sensor assembly body 2910 is surrounded by an in-line sensor assembly inner radiation shield 2970 and an in-line sensor assembly outer radiation shield 2980. The in-line sensor assembly outer radiation shield 2980 contains an in-line sensor assembly interconnect zone 2990, an in-line sensor assembly sealing zone 2995, and an in-line sensor assembly expansion zone 2985. The in-line sensor assembly sealing zone 2995 is used to create an in-line sensor assembly vacuum space 2975. The active component of in-line sensor assembly 2900 is an in-line sensor head 2940. The in-line sensor head 2940 is connected to an in-line sensor electronics module 2950 by means of an in-line sensor assembly feedthrough 2920. The in-line sensor assembly feedthrough 2920 consists of an in-line sensor assembly feedthrough tube 2922 which houses an in-line sensor assembly feedthrough conductor cable 2924 containing one or more individual electrical conductors (i.e., wires) connecting the in-line sensor electronics module 2950 to the in-line sensor head 2940. The in-line sensor assembly feedthrough tube 2922 is attached to the in-line sensor assembly outer radiation shield 2980 by an in-line sensor assembly feedthrough air seal 2928 and is attached to the in-line sensor assembly body 2910 by an in-line sensor assembly feedthrough system seal 2926. The in-line sensor head 2940, the in-line sensor assembly feedthrough 2920, and the in-line sensor electronics module 2950 are configured to maintain the hermetic integrity of the internal system volume 2905 and the in-line sensor assembly vacuum space 2975. It will be appreciated by those skilled in the art that the in-line sensor head 2940 could contain a wide variety of detection mechanisms that could sense, by way of example and not limitation, pressure, temperature, viscosity, fluid flow rate, composition of matter, and/or electrical properties. It will be further appreciated by those skilled in the art that the configuration of in-line sensor assembly 2900 allows the in-line sensor head 2940 to operate at elevated temperature while the in-line sensor electronics module 2950 remains near the ambient temperature.

The embodiments described by FIG. 58 and FIG. 59 are particularly adapted for sensing techniques that require electronic support. Those skilled in the art will recognize that other sensing techniques whose physical operations require the support of non-electronic modalities such as, for example, but without limitation, optics, acoustics, radiation, and mass transport will also benefit from the present technology when temperature sensitive components must be thermally isolated from the hot sensor head.

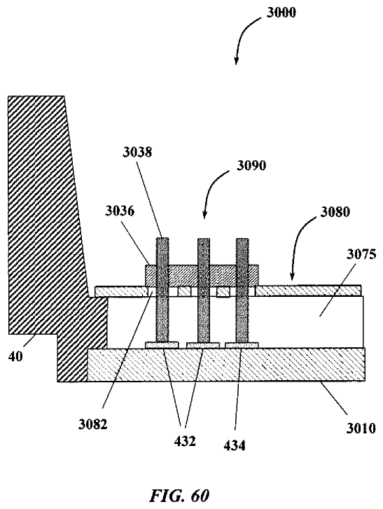

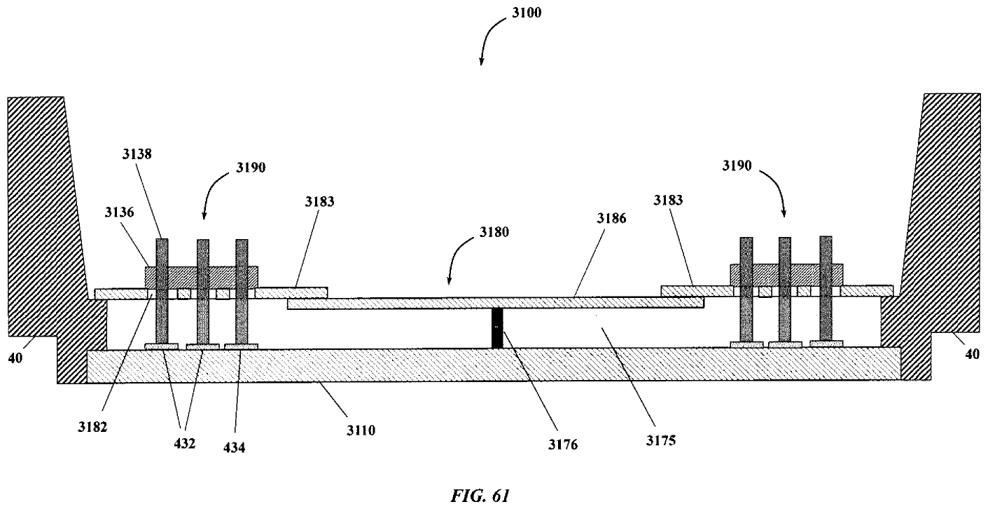

Many of the embodiments of the present technology described supra have used a vacuum space as an insulation means and a corrugated expansion zone as a stress relief means. Neither approach is a limitation of the present technology, and any appropriate insulation or stress relief means known in the art may be incorporated into the construction methods and reside within the scope of the present technology. By way of example, but not limitation, two exemplary embodiments are shown in FIGS. 60 and 61.

FIG. 60 illustrates a partial cross-section of a fluid conduit assembly 3000 that does not use a vacuum space as part of the insulation means. The fluid conduit assembly 3000 comprises a heater conduit 3010 attached to flange 40, an outer radiation shield 3080, and an interconnect zone 3090. The interconnect zone 3090 includes at least a contact pin 3038 (three contact pins are depicted in the figure) that passes through an outer via hole 3082 in the outer radiation shield 3080. For illustrative purposes, the contact pins 3038 are shown bonded and in electrical communication with contact pads 432 and 434 which are part of the thick film layer stack (not shown) disposed on the heater conduit 3010. A plug insulator 3036 supports the contact pins 3038 and electrically insulates them from the outer radiation shield 3080. The fluid conduit assembly 3000 does not require a vacuum sealing zone. The volume between the heater conduit 3010 and the outer radiation shield 3080 is filled with an insulation material 3075. The insulation material 3075 can be a pourable or injectable polymeric foam, a blanket-like insulator sheet (including, optionally, thin heat reflecting layers) wrapped around the heater conduit 3010 one or more times, a loose particulate insulative material, or any other appropriate insulative material known in the art. In one preferred embodiment the insulation material 3075 is a finely divided silica aerogel particulate such as Lumira® LA1000 from Cabot Corporation, Boston, Mass. The advantages of using a non-vacuum insulative means will be obvious to those skilled in the art as the labor and costs of forming and maintaining a hermetically sealed vacuum space are avoided. Although not shown in FIG. 60, an inner radiation shield or multiple, nested inner radiation shields could be included as part of the insulation material 3075.

A cross-section of a fluid conduit assembly 3100 that does not use a corrugated expansion zone as part of the stress relief means is shown in FIG. 61, which shares many common elements with FIG. 60 (like elements utilize like numerals). For ease of depiction, but without intending any limitation, the fluid conduit assembly 3100 is shown as being mirror symmetric, with a heater conduit 3110 attached to flanges 40 and an interconnect zone 3190 disposed near each end. An outer radiation shield 3180 is composed of exterior outer radiation shields 3183 that are each fixedly attached to one of the two flanges 40 and an interior outer radiation shield 3186 that is fixed to the heater conduit 3110 by means of a standoff 3176. The exterior outer radiation shields 3183 are close fitting with interior outer radiation shield 3186 but they may slip past each other without binding. Each interconnect zone 3190 includes at least a contact pin 3138 (three contact pins are depicted in the figure) which passes through an outer via hole 3182 in the exterior outer radiation shield 3183. For illustrative purposes, the contact pins 3138 are shown bonded and in electrical communication with contact pads 432 and 434 which are part of the thick film layer stack (not shown) disposed on the heater conduit 3110. A plug insulator 3136 supports the contact pins 3138 and electrically insulates them from the exterior outer radiation shield 3183. The fluid conduit assembly 3100 does not require a corrugated expansion zone. Instead, if the heater conduit 3110 grows in length due to thermal expansion, the exterior outer radiation shields 3183 slide over interior outer radiation shield 3186 without creating a mechanical stress. The volume between the heater conduit 3110 and the outer radiation shield 3180 is filled with an insulation material 3175. The selection of insulation material 3175 follows the specifications previously provided for insulation material 3075 with the additional condition that insulation material 3175 should not impede the ability of exterior outer radiation shields 3183 to slip past the interior outer radiation shield 3186. Although not shown in FIG. 61, an inner radiation shield or multiple, nested inner radiation shields could be included as part of the insulation material 3175 with allowance for the presence of the standoff 3176.

Although preferred embodiments have been depicted and described in detail herein, it will be apparent to those skilled in the relevant art that various modifications, additions, subtractions, and the like can be made without departing from the spirit of the invention and these are therefore considered to be within the scope of the invention as defined in the claims that follow.

What is claimed is:

1. A fluid conduit assembly comprising:
a fluid conduit comprising a tubular member extending between at least a first end and a second end, the tubular member having an inner surface configured to convey a fluid and an outer surface;
a heater trace deposited on the outer surface of the fluid conduit and configured, in use, to heat the fluid within the inner surface of the fluid conduit;
an insulation shell located over the heater trace and configured to suppress heat losses from the fluid conduit; and
an interconnect device located proximate to each of the first end and the second end on the fluid conduit, a portion of the interconnect device extending through the insulation shell to electrically connect the heater trace to one or more external devices.

2. The fluid conduit assembly of claim 1, wherein the heater is a thick film heater trace.

3. The fluid conduit assembly of claim 1, wherein the fluid conduit is one of a cylindrical fluid component, a u-shaped fluid component, a tee-shaped fluid component, or an elbow shaped fluid component.

4. The fluid conduit assembly of claim 1 further comprising:
a flange located at the first end and the second end configured to couple each of the first end and the second end of the fluid conduit to another fluid conduit.

5. The fluid conduit assembly of claim 4, wherein the flange comprises a ceramic insert configured to reduce heat flow in at least one area of the flange.

6. The fluid conduit assembly of claim 1, wherein the insulation shell comprises:
a first radiation shield located along the outer surface of the fluid conduit and substantially over the heater trace;
a second radiation shield located along the length of the first radiation shield; and
a vacuum space extending between the fluid conduit and the second radiation shield.

7. The fluid conduit assembly of claim 6, wherein the second radiation shield comprises an expansion element configured to expand based on stress on the second radiation shield from thermal expansion between the fluid conduit and the second radiation shield, during use.

8. The fluid conduit assembly of claim 7, wherein the expansion element comprises one or more corrugations in the second radiation shield configured to elongate in response to the stress on the second radiation shield.

9. The fluid conduit assembly of claim 6, wherein the second radiation shield comprises a vacuum sealing element for generating the vacuum space between the fluid conduit and the second radiation shield.

10. The fluid conduit assembly of claim 9, wherein the vacuum sealing element comprises:
an expanded portion of the second radiation shield having a shield dimple located therein; and
a vacuum port located within the shield dimple.

11. The fluid conduit assembly of claim 6, wherein the first radiation shield is located entirely within the vacuum space.

12. The fluid conduit assembly of claim 6, wherein the first radiation shield has highly reflective surfaces.

13. The fluid conduit assembly of claim 6, wherein the first radiation shield is not rigidly fixed.

14. The fluid conduit assembly of claim 6, wherein the first radiation shield is configured to allow regions located adjacent to an inner surface and an outer surface of the inner radiation shield to communicate fluidly with one another.

15. The fluid conduit assembly of claim 6, wherein the interconnect device comprises:
one or more contact pins configured to be in electrical communication with the heater trace and extending through the first radiation shield and the second radiation shield, the contact pins configured to be electrically coupled to the one or more external devices.

16. The fluid conduit assembly of claim 15, wherein the one or more contact pins extend through holes in the first radiation shield and the second radiation shield.

17. The fluid conduit assembly of claim 15, wherein the interconnect device further comprises an insulator sealed to the one or more contact pins and the second radiation shield.

18. The fluid conduit assembly of claim 17, wherein the insulator is hermetically sealed to the contact pins and the second radiation shield.

19. The fluid conduit assembly of claim 17, wherein the insulator is a ceramic donut-shaped insulator.

20. The fluid conduit assembly of claim 17, wherein the insulator is a plug insulator or a socket insulator.

21. The fluid conduit assembly of claim 15, wherein the interconnect device further comprises:
a first power bus and a second power bus deposited on the fluid conduit and configured to be electrically coupled to the one or more contact pins, wherein the first power bus and the second power bus extend longitudinally along the tubular member of the fluid conduit.

22. The fluid conduit assembly of claim 21, wherein the first power bus and the second power bus are located approximately 180 degrees apart from one another on the heater conduit.

23. The fluid conduit assembly of claim 22, wherein the heater trace has a helical configuration.

24. The fluid conduit assembly of claim 23, wherein the heater trace is a continuous helical heater trace such that the heater trace contacts the first power bus and the second power bus at a plurality of locations to form a plurality of resistive heater elements that form an array of electrically parallel circuits.

25. The fluid conduit assembly of claim 23, wherein the helical configuration has at least one non-uniform area with reduced pitch to increase heat flux at an area of the fluid conduit.

26. The fluid conduit assembly of claim 22, wherein the heater trace has a serpentine configuration.

27. The fluid conduit assembly of claim 26, wherein the heater trace comprises first and second serpentine traces extending between the first power bus the second power bus, wherein the first serpentine trace and the second serpentine trace are formed on separate hemi-cylinders of the fluid conduit to form electrically parallel circuits.

28. The fluid conduit assembly of claim 26, wherein the heater trace comprises first, second, third, and fourth serpentine traces extending between the first power bus the second power bus, wherein the first and second serpentine traces and the third and fourth serpentine traces are formed on separate hemi-cylinders of the fluid conduit, respectively, to form electrically parallel circuits.

29. The fluid conduit assembly of claim 22, wherein the heater trace has a substantially longitudinal configuration along the tubular member.

30. The fluid conduit assembly of claim 29, wherein the substantially longitudinal trace forms a separate trace in each hemi-cylinder of the fluid conduit.

31. The fluid conduit assembly of claim 21, wherein the first power bus and the second power bus are spaced in close proximity to one another on the fluid conduit.

32. The fluid conduit assembly of claim 31, wherein the heater trace is not located in a section of the tubular member between the first power bus and the second power bus.

33. The fluid conduit assembly of claim 21, wherein the first power bus and the second power bus are formed between a first ring electrode and a second ring electrode, respectively that encircle the fluid conduit.

34. The fluid conduit assembly of claim 21, wherein the heater trace comprises:
a dielectric layer deposited on the tubular member of the fluid conduit;
a patterned conductive layer deposited over the dielectric layer, wherein the conductive layer forms contact pads that communicate electrically with the one or more external devices and the first and second power buses; and
a patterned resistive layer deposited partially over the dielectric layer and partially over the conductive layer to provide heat generation during use, wherein the patterned resistive layer contacts the conductive layer in at least two locations.

35. The fluid conduit assembly of claim 34, wherein the heater trace further comprises an overcoat layer completely covering the resistive layer and partially covering the patterned conductive layer to expose the contact pads.

36. The fluid conduit assembly of claim 34, wherein the dielectric layer comprises multiple dielectric layers.

37. The fluid conduit assembly of claim 1 further comprising one or more thermal switches located along the heater trace.

38. The fluid conduit assembly of claim 1 further comprising a temperature sensor located along the heater trace.

39. A fluid transport system comprising:
at least two of the fluid conduit assemblies as recited in claim 1.

40. The fluid transport system of claim 39, wherein the at least two fluid conduit assemblies are welded together.

41. The fluid transport system of claim 39 further comprising a clamping device, wherein the at least two fluid conduit assemblies are coupled together by the clamping device, during use, the clamping device comprising:
a clamping member configured to contact the at least two fluid conduit assemblies to provide a sealing force between the at least two fluid conduit assemblies;
an outer member configured to extend between the at least two fluid conduit assemblies and to provide a space between the clamping member and the outer member; and
one or more wires, located in the space between the clamping member and the outer member, to connect the interconnect devices of the at least two fluid conduit assemblies.

42. The fluid transport system of claim 41, wherein the clamping device further comprises a heater located in the space between the clamping member and the outer member.

43. The fluid transport system of claim 41, wherein the clamping device further comprises a control module configured to electrically communicate with the at least two fluid conduit assemblies.
